(19) United States
(12) Patent Application Publication
(10) Pub. No.: US 2025/0383220 A1
(43) Pub. Date: Dec. 18, 2025

(54) VEHICLE-MOUNTING DEVICES AND METHODS FOR USE IN VEHICLE-BASED LOCATING SYSTEMS

(71) Applicant: SeeScan, Inc., San Diego, CA (US)

(72) Inventors: Mark S. Olsson, La Jolla, CA (US); Christopher Lum, San Diego, CA (US)

(21) Appl. No.: 19/234,473

(22) Filed: Jun. 11, 2025

Related U.S. Application Data
(60) Provisional application No. 63/659,722, filed on Jun. 13, 2024.

(51) Int. Cl. G01D 11/30; B60D 1/46; B60D 1/66; G01D 11/10

(52) U.S. Cl. CPC G01D 11/30; B60D 1/465; B60D 1/665; G01D 11/10

(57) ABSTRACT

The disclosure includes vehicle-mounting devices to mount one or more utility locator devices to a vehicle for use in locating and mapping buried utility lines. Such vehicle-mounting devices may improve over other vehicle-mounting devices known in the art by preventing damage to associated utility locator devices as well as the vehicle mounting device. Further, such devices may be included in vehicle-based locate systems as well as in a computer implemented method for utility line positions and characteristics using Artificial Intelligence (AI).

This application claims priority under 35 U.S.C. § 119 (e) to U.S. Provisional Patent Application Ser. No. 63/659,722 entitled VEHICLE-MOUNTING DEVICES AND METHODS FOR USE IN VEHICLE-BASED LOCATING SYSTEMS, filed Jun. 13, 2024, the content of which is incorporated by reference herein in its entirety for all purposes.

### FIELD

This disclosure relates generally to devices, systems, and methods used for locating and mapping utility lines. More specifically, but not exclusively, the disclosure relates to improved vehicle-mounting devices for mounting one or more utility locator devices to a vehicle for further use in utility locating and mapping systems and methods.

### BACKGROUND

Devices used for determining and mapping the positions of utility lines buried in the ground or otherwise obscured from sight are known in the art. Such devices, referred to as “utility locator devices,” “utility locators,” or simply “locators,” are generally hand-carried by a technician as moved about a locate environment. The utility locator device may measure magnetic fields emitted from hidden or buried utilities (e.g., underground utilities such as pipes, conduits, or cables) or other conductors at different positions in the environment, process the signals, and determine positions of utility lines and other conductors.

Such methods for locating utilities, referred to as “locate operations” or simply “locates,” that employ a hand-carried utility locator device moved about an environment, though useful, requires the labor of a technician to physically carry the locating device in an upright position above the ground for lengthy periods of time. Further, these methods are generally limited to locating utilities within small and/or confined geographical regions that are walkable by a technician. Likewise, in some locate operations such as those occurring in busy roads and highways, the locate operation may be restricted to be performed during night hours and generally requires approval from designated authorities before initiating such a manual locate operation. In either case, a locate operation occurring in busy roads and highways requires a technician to put their own wellbeing at risk in working by operating in such dangerous environments.

One solution known in the art relates to securing one or more utility locator devices to a vehicle and, as the vehicle traverses the targeted locate environment, measuring magnetic signals to determine utility line locations. Coupled with geospatial data, known vehicle-mounted utility locator devices and vehicle-based locating system may further map the locations and depths of utility lines. Such devices used for coupling one or more utility locator devices to a vehicle are referred to herein as a “vehicle-mounting device,” “utility locating hitch,” “locating hitch,” “hitch device,” or simply “hitch.”

Whereas vehicle-mounting devices known in the art may facilitate locating and mapping of utility lines across large geographical regions as well as in areas roads and highways that may be difficult to access on foot or otherwise dangerous for a technician to hand-carry a utility locator device, there are various aspects where known vehicle-mounting devices fail. For instance, there are various use scenarios where it is advantageous or necessary for the technician to adjust the height, hereafter referred to as “height setting,” and the angle orientation at which the utility locator devices are positioned in a vehicle-mounting device relative to an upright vertical orientation, referred to hereafter as “tilt angle,” on the fly. The repositioning of utility locator devices in known vehicle-mounting devices is limited and may be cumbersome, often requiring the use of tools. Further, in some uses the curvature or topography of the road or other ground surface may cause the utility locator device(s) to directly or indirectly contact the ground surface potentially resulting in damage to the vehicle-mounting device and/or the coupled utility locator device(s). Likewise, in known vehicle-mounting devices, associated utility locator devices are prone to damage from impacts from gravel and the like as the vehicle moves down the road. Even further, vehicle-mounting devices known in the art are prone to inducing vibrations and other unwanted movements at the utility locator devices which may negatively impact the ability of the utility locator device to accurately locate and map utility lines.

Accordingly, there is a need in the art to address the above-described as well as other problems.

### SUMMARY

The present disclosure relates generally to devices, systems, and methods used for locating and mapping utility lines. More specifically, but not exclusively, the disclosure relates to improved vehicle-mounting devices for mounting one or more utility locator devices to a vehicle for further use in utility locating and mapping systems and methods.

In one aspect, the disclosure relates to a vehicle-mounting device for use with utility locator devices. The vehicle-mounting device includes a vehicle mounting element for coupling a support assembly to a vehicle. The support assembly having a support arm and one or more masts coupled onto the support arm wherein each mast has a length that is substantially vertical in orientation. The vehicle-mounting device further includes one or more locator pod assemblies. Each locator pod assembly includes a shell element for housing a utility locator device. Further, each locator pod assembly includes one or more pod mounting holes dimensioned to secure a utility locator device onto one or more masts on the support assembly such that when a locator pod assembly contacts the ground surface the locator pod assembly slides up along the length of the masts.

In another aspect, the present disclosure includes a method for utility locating using one or more utility locator devices disposed in a vehicle-mounting device. The method including moving a vehicle having a coupled vehicle-mounting device with one or more utility locator devices each disposed in a locator pod assembly that are further installed on the masts of the vehicle-mounting device such that each locator pod assembly is permitted to move up along the length of the associated mast(s) based on force from the locator pod assembly contacting the ground surface. The method further includes measuring electromagnetic signals across a range of frequencies at each utility locator device and determining geolocation data describing positions in the world frame as the vehicle is moved. The method further includes determining and mapping positions of utility lines based on the measured electromagnetic signal data and geolocation.

In another aspect, the present disclosure includes another method for utility locating using one or more utility locator devices disposed in a vehicle-mounting device configured to automatically adjust height settings based on Topographical Data. The method including moving a vehicle having a coupled vehicle-mounting device with one or more utility locator devices each disposed on a vehicle-mounting device configured to automatically adjust the height of the utility locator device. The method further including determining Topographical Data describing the topography of the ground surface via one or more rangefinder devices, LiDAR, cameras, other sensors and like apparatus, and historically mapped Topographical Data. The method further includes adjusting the height of the locator pod assemblies relative to the ground surface based on the Topographical Data. The method further includes measuring electromagnetic signals across a range of frequencies at each utility locator device and determining geolocation data describing positions in the world frame as the vehicle is moved. The method further includes determining and mapping positions of utility lines based on the measured electromagnetic signal data and geolocation.

In another aspect, the present disclosure includes a computer implemented method for utility line positions and characteristics using Artificial Intelligence (AI). The method includes collecting Vehicle-Based Locating Data describing the positions and depths of utility lines in the ground from electromagnetic signals via one or more utility locator device disposed in a vehicle-mounting device and Predetermined Classifier Data (e.g., user input data or data from a pre-existing database relating to utility line positions, utility line types, depths in the ground, associated electromagnetic data, images of utility lines and surrounding environment, and the like). The method further includes assembling a Training Database that includes Vehicle-Based Locating Data and Predetermined Classifier Data. The method further includes using deep learning to train a Neural Network (Artificial Intelligence/AI) via the Training Database Data and using AI to generate predictions regarding the positions of utility lines and utility line characteristics. The method further includes outputting predictions regarding the positions of utility lines and other utility line characteristics.

Additional aspects, features, and functionality are further described below in conjunction with the appended drawings.

### BRIEF DESCRIPTION OF THE DRAWINGS

The present disclosure may be more fully appreciated in connection with the following detailed description taken in conjunction with the accompanying drawings, wherein:

FIG. 1A is an illustration of a prior art vehicle-mounting device for use in utility locating demonstrating potential for damage.

FIG. 1B is an illustration of a prior art vehicle-mounting device from FIG. 1A demonstrating a technician adjusting the height setting and vibration at the utility locator devices.

FIG. 1C is another illustration of a prior art vehicle-mounting device from FIG. 1A demonstrating other potential scenario for damage.

FIG. 1D is another illustration of a prior art vehicle-mounting device from FIG. 1A demonstrating other potential scenario for damage.

FIG. 2A is a side view of a vehicle-mounting device of the present invention mounting utility locator devices to a vehicle.

FIG. 2B is an isometric view of the vehicle-mounting device, utility locator devices, and vehicle from FIG. 2A.

FIG. 2C is a partially exploded isometric view of the vehicle-mounting device, utility locator devices, and vehicle from FIG. 2A.

FIG. 2D is a diagram of the vehicle-mounting device, utility locator devices, and vehicle from FIG. 2A showing shock isolation elements.

FIG. 3A is an exploded view of the mounting element of the vehicle-mounting device from FIG. 2A-2C for mounting the device to the vehicle.

FIG. 3B is a detailed side view of the mounting element securing the hitch drop plate to the vehicle.

FIG. 3C is a detailed rear view of the mounting element securing the hitch drop plate to the vehicle.

FIG. 4A-4C are illustrations of alternative mast shapes/configurations.

FIG. 5A is an isometric view of the locator pod assembly containing the utility locator device from the vehicle-mounting device of FIGS. 2A-2C.

FIG. 5B is a partially exploded isometric view of the locator pod assembly and the utility locator device from the vehicle-mounting device of FIGS. 2A-2C.

FIG. 6A is a side view of the vehicle-mounting device of FIGS. 2A-2C demonstrating the passage for sensors/camera on the utility locator devices.

FIG. 6B is a bottom-up view of the vehicle-mounting device of FIGS. 2A-2C demonstrating the passage for sensors/camera on the utility locator devices.

FIG. 7A is a side view of the vehicle-mounting device of FIGS. 2A-2C demonstrating the height setting.

FIG. 7B is another side view of the vehicle-mounting device of FIGS. 2A-2C demonstrating the height setting.

FIG. 8A is a side view of the vehicle-mounting device of FIGS. 2A-2C demonstrating the tilt angle of the locator pod assemblies and associated utility locator devices.

FIG. 8B is a detailed view of the masts from the vehicle-mounting device of FIGS. 2A-2C demonstrating the tilt angle.

FIG. 9 is an illustration of the vehicle-mounting device of FIGS. 2A-2C with the addition of a positioning system.

FIG. 10A is an illustration of a vehicle-based locating system.

FIG. 10B is a diagram of the vehicle-based locating system of FIG. 10A.

FIG. 11 is a method for utility locating via a vehicle-mounting device of the present invention.

FIG. 12A is an isometric view of another vehicle-mounting device of the present invention.

FIG. 12B is another isometric view of another vehicle-mounting device from FIG. 12A.

FIG. 13 is an exploded view of the mounting element of the vehicle-mounting device from FIGS. 12A and 12B for mounting the device to the vehicle.

FIG. 14 is a detailed view of a height setting mechanism included in the vehicle-mounting device from FIGS. 12A and 12B.

FIG. 15 a detailed isometric view of a tilt angle mechanism included in the vehicle-mounting device from FIGS. 12A and 12B.

FIG. 16A is an illustration of a vehicle-based locating system including the vehicle-mounting device from FIGS. 12A and 12B.

FIG. 16B is a diagram of the vehicle-based locating system from FIG. 16A.

FIG. 17A is an illustration of another vehicle-based locating system including the vehicle-mounting device from FIGS. 12A and 12B.

FIG. 17B is a diagram of the vehicle-based locating system from FIG. 17A.

FIG. 18 is a method for utility locating and adjusting height settings and tilt angles automatically via a vehicle-mounting device of the present invention.

FIG. 19A is a vehicle-mounting device and vehicle-based locating system including locate environment sensor elements for scanning the locate environment.

FIG. 19B is a diagram of the vehicle-mounting device and vehicle-based locating system including one or more locate environment sensor elements of FIG. 19A.

FIG. 20A is a top-down isometric view of a vehicle-mounting device embodiment with ground penetrating radars (GPRs).

FIG. 20B is a bottom-up isometric view of the vehicle-mounting device from FIG. 20A.

FIG. 21A is a vehicle-based locating system including GPRs.

FIG. 21B is a diagram of the vehicle-based locating system of FIG. 21A.

FIG. 22A is an isometric view of a vehicle-mounting device that includes a wheeled trailer.

FIG. 22B is a side view of the vehicle-mounting device of FIG. 22A.

FIG. 23 is a method for mapping utility lines via a vehicle-based locating system.

FIG. 24 is a method for providing Training Data to a Neural Network to use Deep Learning/artificial intelligence to recognize patterns and make predictions related to underground utilities via a vehicle-based locating system of the present invention.

FIG. 25 is a chart demonstrating various types of data, as an example, that may be used as Training Data for Deep Learning in a Neural Network that uses Artificial Intelligence (AI) in a vehicle-based locating system of the present invention.

FIG. 26A is an isometric view of another vehicle-mounting device of the present invention.

FIG. 26B is another isometric view of another vehicle-mounting device from FIG. 12A.

FIG. 27A is a detailed view of the locator pod assembly showing the pivot lid assembly.

FIG. 27B is a detailed view of the locator pod assembly showing the pivot lid assembly partially opened revealing the battery of the utility locator device.

FIG. 27C is a detailed view of the locator pod assembly showing the pivot lid assembly fully opened revealing the user input controls and display of the utility locator device.

FIG. 27D is a detailed view of the locator pod assembly showing the pivot lid assembly fully opened removing or installing the utility locator device from the locator pod assembly.

### DETAILED DESCRIPTION OF EMBODIMENTS

The present disclosure relates generally to devices, systems, and methods used for locating and mapping utility lines. More specifically, but not exclusively, the disclosure relates to improved vehicle-mounting devices for mounting one or more utility locator devices to a vehicle for further use in utility locating and mapping systems and methods.

In one aspect, the disclosure relates to a vehicle-mounting device for use with utility locator devices. The vehicle-mounting device includes a vehicle mounting element for coupling a support assembly to a vehicle. The support assembly includes a support arm having one or more masts coupled onto the support arm wherein each mast has a length that is substantially vertical in orientation. It should be noted that in some embodiments the vehicle mounting element may rigidly couple to the vehicle preventing unwanted movements of the vehicle-mounting device and disposed utility locator devices. Likewise, one or more shock isolation elements (e.g., rubber, polyurethane foam, or other cushioning materials and/or other shock isolation element such as shocks, springs, and the like to isolate shock and dampen vibrations) may be included in one or more locations throughout a vehicle-mounting device embodiment to dampen unwanted vibrations and other movements. The vehicle-mounting device further includes one or more locator pod assemblies. In some embodiments, the vehicle-mounting device may include two locator pod assemblies and two utility locator devices spaced apart along the width of the vehicle on the support assembly. Each locator pod assembly includes a shell element for housing a utility locator device. Further, each locator pod assembly includes one or more pod mounting holes dimensioned to secure a utility locator device onto one or more masts on the support assembly such that, when a locator pod assembly contacts the ground surface, the locator pod assembly slides up along the length of the masts. In some embodiments, each locator pod assembly may key onto one or more masts. Further, in some embodiments, a vehicle-mounting device may include one or more wheels along the bottom of the locator pod assembly such that when the locator pod assembly contacts the ground surface, the locator pod assembly may roll along the ground. In some embodiments, each mast may include a retaining element to prevent the locator pod assemblies from sliding off the top end. In some embodiments, the support assembly may include a wheeled trailer onto which the support arm and masts may be coupled to further seat one or more locator pod assemblies and associated utility locator devices.

In some embodiments, the shell assembly may include one or more openings permitting the sensors and other apparatus of the enclosed utility locator device to determine measurements or other functions outside the locator pod assembly. For instance, each utility locator device may include one or more cameras for generating images of the ground surface as the vehicle is moved and/or one or more rangefinder devices for generating distance measurements to one or more spots on the ground surface. Likewise, such openings may be used to allow other measurements or like functions by a utility locator device.

In some embodiments, the height settings and/or tilt angles of locator pod assemblies and utility locator devices may be manually adjusted. For instance, a technician may manually set the height setting of the locator pod assembly. Likewise, the technician may manually set the tilt angle of the one or more locator pod assemblies and associated utility locator devices. In other embodiments, the height settings and/or tilt angles of locator pod assemblies and utility locator devices may be automatically adjusted. For instance, a technician may activate an electromechanical, pneumatic, hydraulic, or like mechanism to set the height setting of the locator pod assembly and/or set the tilt angle of the locator pod assembly on the associated mast(s) and/or the tilt angle of the locator pod assembly or assemblies relative to the support arm and ground surface. In some such embodiments, the height settings and/or tile angles may be automatically set based on Topographical Data of the ground surface determined via one or more sensors and systems (e.g., one or more rangefinder devices, LiDAR, cameras, and historically mapped Topographical Data, and other sensors/apparatus and the like).

In some embodiments, the vehicle-mounting device may include one or more global navigation satellite systems (GNSS) sensors and antennas to provide, or aid in providing, geolocation data describing geolocation positions in the world frame. For instance, the GNSS sensors and antennas may be or include global positioning system (GPS), global navigation satellite system (GLONASS), BeiDou (BDS), Quasi-Zenith Satellite Systems (QZSS), and Galileo. The GNSS devices, systems, and methods described herein may operate on both the lower L-band and upper-L band that may include the L1, L2, and L5 bands. The GNSS devices and methods described herein may further include precise point positioning real time kinematics (PPP-RTK), state space representation (SSR), and/or other like corrections. Likewise, determination of such geolocation data may include the use of one or more inertial navigation systems (INS), ground tracking apparatus, rangefinders, and the like.

In some embodiments, the vehicle-mounting device may be included in a vehicle-based locating system that further includes a vehicle and one or more utility locator devices. In some embodiments, a vehicle-based locating system may include one or more sensors and apparatus for determining the topography of the ground surface. Furthermore, a vehicle-based locating system may include one or more remotely connected cloud servers, base stations, transmitter devices for coupling signal onto utility lines, hand-carried utility locators, mapping systems, and the like.

The vehicle-mounting devices and vehicle-based locating systems may further include one or more other sensors and sensors for generating data regarding the locate environment. In some embodiments, the vehicle-mounting devices and vehicle-based locating systems may include one or more LiDARs, cameras, rangefinders, and other sensors and apparatus for generating and mapping data related to images, positions, and identity of objects in the locate environment (e.g., poles, signs, fire hydrants, buildings, transformers, and other such objects and attributes). Such sensors and apparatus may be referred to herein as “locate environment sensor elements.” The data generated by such locate environment sensor elements regarding the generation and mapping data related to images, positions, and identity of objects in the locate environment may be referred to herein as “Locate Environment Data.” Further, some vehicle-mounting devices and vehicle-based locating systems may include one or more ground penetrating radars (GPRs). The term, “GPR Data,” may refer to data and information regarding images or other representations and mapping of the sub-surface of the locate environment as generated via one or more GPRs.

In another aspect, the present disclosure includes a method for utility locating using one or more utility locator devices disposed in a vehicle-mounting device. The method including moving a vehicle having a coupled vehicle-mounting device with one or more utility locator devices each disposed in a locator pod assembly that are further installed on the masts of the vehicle-mounting device such that each locator pod assembly is permitted to move up along the length of the associated mast(s) based on force from the locator pod assembly contacting the ground surface. The method further includes measuring electromagnetic signals across a range of frequencies at each utility locator device and determining geolocation data describing positions in the world frame as the vehicle is moved. Optionally, the method may include generating images of the ground at the utility locator devices via one or more cameras and/or rangefinder data from one or more rangefinder devices in the utility locator device measuring to points on the ground. Likewise, the method may also optionally include receiving data from one or more wirelessly connected devices in a vehicle-based locating system (e.g., data regarding the presence or absence of utility lines, geolocation information, images and mapping of the locate environment, device settings and status, and the like). Further still, the method may include Locate Environment Data and/or GPR Data. The method further includes determining and mapping positions of utility lines based on the measured electromagnetic signal data and geolocation. Optionally, the method may include displaying utility line positions/maps on one or more user interface.

In another aspect, the present disclosure includes another method for utility locating using one or more utility locator devices disposed in a vehicle-mounting device configured to automatically adjust height settings based on Topographical Data. The method includes moving a vehicle having a coupled vehicle-mounting device with one or more utility locator devices configured to automatically adjust the height setting and tilt angle of the utility locator device. The method includes ‘determining Topographical Data describing the topography of the ground surface via one or more rangefinder devices, LiDAR, cameras, other sensors and like apparatus, and historically mapped Topographical Data. The method further includes measuring electromagnetic signals across a range of frequencies at each utility locator device and determining geolocation data describing positions in the world frame as the vehicle is moved. Optionally, the method may include generating images of the ground at the utility locator devices via one or more cameras and/or rangefinder data from one or more rangefinder devices in the utility locator device measuring to points on the ground. Likewise, the method may also optionally include receiving data from one or more wirelessly connected devices in a vehicle-based locating system (e.g., data regarding the presence or absence of utility lines, geolocation information, images and mapping of the locate environment, device settings and status, and the like). Further still, the method may optionally include Locate Environment Data and/or GPR Data. The method further includes adjusting the height of the locator pod assemblies relative to the ground surface based on the Topographical Data. The method further includes determining and mapping positions of utility lines based on the measured electromagnetic signal data and geolocation. Optionally, the method may include displaying utility line positions/maps on one or more user interface.

In another aspect, the present disclosure includes a computer implemented method for utility line positions and characteristics using Artificial Intelligence (AI). The method includes collecting Vehicle-Based Locating Data describing the positions and depths of utility lines in the ground from electromagnetic signals via one or more utility locator device disposed in a vehicle-mounting device and Predetermined Classifier Data. For instance, the Vehicle-Based Locating Data may include, but should not be limited to Electromagnetic Data emitted by utility lines, pipe Sonde, marker device, and tracer wire, measurements of the depth of the utility lines, geospatial data regarding the location/positions and orientations/pose relating to utility locator devices and utility lines, Rangefinder Data from one or more rangefinders, user input data, Image Data of utility line(s) and associated environment, Topographical Data relating to the contours, slope, changes in elevations, potholes, bumps, and like information regarding the ground surface, Locate Environment Data, GPR Data, and other data. The method further including assembling a Training Database that includes Vehicle-Based Locating Data and Predetermined Classifier Data (e.g., user input data or data from a pre-existing database relating to utility line positions, utility line types, depths in the ground, associated electromagnetic data, images of utility lines and surrounding environment, and the like). The method further includes using deep learning to train a Neural Network (Artificial Intelligence/AI) via the Training Database Data and using AI to generate predictions regarding the positions of utility lines and utility line characteristics. The method further includes outputting predictions regarding the positions of utility lines and other utility line characteristics.

In some embodiments, the method may include generating Verification Data comparing the predictions regarding utility line positions and characteristics with real world, verified data. Further, the method may include adding verified data from the Verification Data back into the Training Database. Likewise, some method embodiments may include generating Correction Data from the differences between the real world, verified data and the AI generated predictions regarding utility line positions and characteristics. The method may further include adding verified data from the Verification Data back into the Training Database.

Details of example devices, systems, and methods that may be combined with the geographic map updating system and method embodiments herein, as well as additional components, methods, and configurations that may be used in conjunction with the embodiments described herein, are disclosed in co-assigned patents and patent applications including: U.S. Pat. No. 5,808,239, issued Aug. 17, 1999, entitled VIDEO PUSH-CABLE; U.S. Pat. No. 6,545,704, issued Jul. 7, 1999, entitled VIDEO PIPE INSPECTION DISTANCE MEASURING SYSTEM; U.S. Pat. No. 6,831,679, issued Dec. 14, 2004, entitled VIDEO CAMERA HEAD WITH THERMAL FEEDBACK LIGHTING CONTROL; U.S. Pat. No. 6,958,767, issued Oct. 25, 2005, entitled VIDEO PIPE INSPECTION SYSTEM EMPLOYING NON-ROTATING CABLE STORAGE DRUM; U.S. Pat. No. 6,862,945, issued Mar. 8, 2005, entitled CAMERA GUIDE FOR VIDEO PIPE INSPECTION SYSTEM; U.S. Pat. No. 7,009,399, issued Mar. 7, 2006, entitled OMNIDIRECTIONAL SONDE AND LINE LOCATOR; U.S. Pat. No. 7,136,765, issued Nov. 14, 2006, entitled A BURIED OBJECT LOCATING AND TRACING METHOD AND SYSTEM EMPLOYING PRINCIPAL COMPONENTS ANALYSIS FOR BLIND SIGNAL DETECTION; U.S. Pat. No. 7,221,136, issued May 22, 2007, entitled SONDES FOR LOCATING UNDERGROUND PIPES AND CONDUITS; U.S. Pat. No. 7,276,910, issued Oct. 2, 2007, entitled A COMPACT SELF-TUNED ELECTRICAL RESONATOR FOR BURIED OBJECT LOCATOR APPLICATIONS; U.S. Pat. No. 7,288,929, issued Oct. 30, 2007, entitled INDUCTIVE CLAMP FOR APPLYING SIGNAL TO BURIED UTILITIES; U.S. Pat. No. 7,298,126, issued Nov. 20, 2007, entitled SONDES FOR LOCATING UNDERGROUND PIPES AND CONDUITS; U.S. Pat. No. 7,332,901, issued Feb. 19, 2008, entitled LOCATOR WITH APPARENT DEPTH INDICATION; U.S. Pat. No. 7,336,078, issued Feb. 26, 2008, entitled MULTI-SENSOR MAPPING OMNIDIRECTIONAL SONDE AND LINE LOCATOR; U.S. Pat. No. 7,498,797, issued Mar. 3, 2009, entitled LOCATOR WITH CURRENT-MEASURING CAPABILITY; U.S. Pat. No. 7,498,816, issued Mar. 3, 2009, entitled OMNIDIRECTIONAL SONDE AND LINE LOCATOR; U.S. Pat. No. 7,518,374, issued Apr. 14, 2009, entitled RECONFIGURABLE PORTABLE LOCATOR EMPLOYING MULTIPLE SENSOR ARRAYS HAVING FLEXIBLE NESTED ORTHOGONAL ANTENNAS; U.S. Pat. No. 7,557,559, issued Jul. 7, 2009, entitled COMPACT LINE ILLUMINATOR FOR BURIED PIPES AND CABLES; U.S. Pat. No. 7,619,516, issued Nov. 17, 2009, entitled SINGLE AND MULTI-TRACE OMNIDIRECTIONAL SONDE AND LINE LOCATORS AND TRANSMITTER USED THEREWITH; U.S. Pat. No. 7,619,516, issued Nov. 17, 2009, entitled SINGLE AND MULTI-TRACE OMNIDIRECTIONAL SONDE AND LINE LOCATORS AND TRANSMITTER USED THEREWITH; U.S. Pat. No. 7,733,077, issued Jun. 8, 2010, entitled MULTI-SENSOR MAPPING OMNIDIRECTIONAL SONDE AND LINE LOCATORS AND TRANSMITTER USED THEREWITH; U.S. Pat. No. 7,741,848, issued Jun. 22, 2010, entitled ADAPTIVE MULTICHANNEL LOCATOR SYSTEM FOR MULTIPLE PROXIMITY DETECTION; U.S. Pat. No. 7,755,360, issued Jul. 13, 2010, entitled PORTABLE LOCATOR SYSTEM WITH JAMMING REDUCTION; U.S. Pat. No. 7,825,647, issued Nov. 2, 2010, entitled METHOD FOR LOCATING BURIED PIPES AND CABLES; U.S. Pat. No. 7,830,149, issued Nov. 9, 2010, entitled AN UNDERGROUND UTILITY LOCATOR WITH A TRANSMITTER, A PAIR OF UPWARDLY OPENING POCKET AND HELICAL COIL TYPE ELECTRICAL CORDS; U.S. Pat. No. 7,864,980, issued January 4,2011, entitled SONDES FOR LOCATING UNDERGROUND PIPES AND CONDUITS; U.S. Pat. No. 7,948,236, issued May 24, 2011, entitled ADAPTIVE MULTICHANNEL LOCATOR SYSTEM FOR MULTIPLE PROXIMITY DETECTION; U.S. Pat. No. 7,969,151, issued Jun. 28, 2011, entitled PRE-AMPLIFIER AND MIXER CIRCUITRY FOR A LOCATOR ANTENNA; U.S. Pat. No. 7,990,151, issued Aug. 2, 2011, entitled TRI-POD BURIED LOCATOR SYSTEM; U.S. Pat. No. 8,013,610, issued Sep. 6, 2011, entitled HIGH Q SELF-TUNING LOCATING TRANSMITTER; U.S. Pat. No. 8,035,390, issued Oct. 11, 2011, entitled OMNIDIRECTIONAL SONDE AND LINE LOCATOR; U.S. Pat. No. 8,106,660, issued Jan. 31, 2012, entitled SONDE ARRAY FOR USE WITH BURIED LINE LOCATOR; U.S. Pat. No. 8,203,343, issued Jun. 19, 2012, entitled RECONFIGURABLE PORTABLE LOCATOR EMPLOYING MULTIPLE SENSOR ARRAYS HAVING FLEXIBLE NESTED ORTHOGONAL ANTENNAS; U.S. Pat. No. 8,248,056, issued Aug. 21, 2012, entitled A BURIED OBJECT LOCATOR SYSTEM EMPLOYING AUTOMATED VIRTUAL DEPTH EVENT DETECTION AND SIGNALING; U.S. Pat. No. 8,264,226, issued Sep. 11, 2012, entitled SYSTEM AND METHOD FOR LOCATING BURIED PIPES AND CABLES WITH A MAN PORTABLE LOCATOR AND A TRANSMITTER IN A MESH NETWORK; U.S. Pat. No. 8,289,385, issued Oct. 16, 2012, entitled PUSH-CABLE FOR PIPE INSPECTION SYSTEM; U.S. patent application Ser. No. 13/769,202, filed Feb. 15, 2013, entitled SMART PAINT STICK DEVICES AND METHODS; U.S. patent application Ser. No. 13/793,168, filed Mar. 11, 2013, entitled BURIED OBJECT LOCATORS WITH CONDUCTIVE ANTENNA BOBBINS; U.S. Pat. No. 8,395,661, issued Mar. 12, 2013, entitled PIPE INSPECTION SYSTEM WITH SELECTIVE IMAGE CAPTURE; U.S. Pat. No. 8,400,154, issued Mar. 19, 2013, entitled LOCATOR ANTENNA WITH CONDUCTIVE BOBBIN; U.S. patent application Ser. No. 14/027,027, filed Sep. 13, 2013, entitled SONDE DEVICES INCLUDING A SECTIONAL FERRITE CORE STRUCTURE; U.S. patent application Ser. No. 14/033,349, filed Sep. 20, 2013, entitled AN UNDERGROUND UTILITY LOCATOR WITH A TRANSMITTER, A PAIR OF UPWARDLY OPENING POCKET AND HELICAL COIL TYPE ELECTRICAL CORDS; U.S. Pat. No. 8,547,428, issued Oct. 1, 2013, entitled PIPE MAPPING SYSTEM; U.S. Pat. No. 8,564,295, issued Oct. 22, 2013, entitled METHOD FOR SIMULTANEOUSLY DETERMINING A PLURALITY OF DIFFERENT LOCATIONS OF THE BURIED OBJECTS AND SIMULTANEOUSLY INDICATING THE DIFFERENT LOCATIONS TO A USER; U.S. Pat. No. 8,587,648, issued Nov. 19, 2013, entitled SELF-LEVELING CAMERA HEAD; U.S. patent application Ser. No. 14/148,649, filed Jan. 6, 2014, entitled MAPPING LOCATING SYSTEMS & METHODS; U.S. Pat. No. 8,635,043, issued Jan. 21, 2014, entitled LOCATOR AND TRANSMITTER CALIBRATION SYSTEM; U.S. Pat. No. 8,717,028, issued May 6, 2014, entitled SPRING CLIPS FOR USE WITH LOCATING TRANSMITTERS; U.S. Pat. No. 8,773,133, issued Jul. 8, 2014, entitled ADAPTIVE MULTICHANNEL LOCATOR SYSTEM FOR MULTIPLE PROXIMITY DETECTION; U.S. Pat. No. 8,841,912, issued Sep. 23, 2014, entitled PRE-AMPLIFIER AND MIXER CIRCUITRY FOR A LOCATOR ANTENNA; U.S. Pat. No. 8,908,027, issued Dec. 9, 2014, entitled ASYMMETRIC DRAG FORCE BEARING FOR USE WITH A PUSH-CABLE STORAGE DRUM; U.S. Pat. No. 8,970,211, issued Mar. 3, 2015, entitled PIPE INSPECTION CABLE COUNTER AND OVERLAY MANAGEMENT SYSTEM; U.S. Pat. No. 8,984,698, issued Mar. 24, 2015, entitled LIGHT WEIGHT SEWER CABLE; U.S. Pat. No. 9,041,794, issued May 26, 2015, entitled PIPE MAPPING SYSTEMS AND METHODS; U.S. Pat. No. 9,057,754, issued Jun. 16, 2015, entitled ECONOMICAL MAGNETIC LOCATOR APPARATUS AND METHOD; U.S. Pat. No. 9,066,446, issued Jun. 23, 2015, entitled THERMAL EXTRACTION ARCHITECTURE FOR CAMERA HEADS, INSPECTION SYSTEMS, AND OTHER DEVICES AND SYSTEMS; U.S. Pat. No. 9,081,109, issued Jul. 14, 2015, entitled GROUND-TRACKING DEVICES FOR USE WITH A MAPPING LOCATOR; U.S. Pat. No. 9,080,992, issued Jul. 14, 2015, entitled ADJUSTABLE VARIABLE RESOLUTION INSPECTION SYSTEMS AND METHODS; U.S. Pat. No. 9,082,269, issued Jul. 14, 2015, entitled HAPTIC DIRECTIONAL FEEDBACK HANDLES FOR LOCATION DEVICES; U.S. Pat. No. 9,085,007, issued Jul. 21, 2015, entitled MARKING PAINT APPLICATOR FOR PORTABLE LOCATOR; U.S. Pat. No. 9,207,350, issued Dec. 8, 2015, entitled BURIED OBJECT LOCATOR APPARATUS WITH SAFETY LIGHTING ARRAY; U.S. Pat. No. 9,222,809, issued Dec. 29, 2015, entitled PORTABLE PIPE INSPECTION SYSTEMS AND APPARATUS; U.S. Pat. No. 9,341,740, issued May 17, 2016, entitled OPTICAL GROUND TRACKING APPARATUS, SYSTEMS, AND METHODS; U.S. Pat. No. 9,372,117, issued Jun. 21, 2016, entitled OPTICAL GROUND TRACKING APPARATUS, SYSTEMS, AND METHODS; U.S. patent application Ser. No. 15/187,785, filed Jun. 21, 2016, entitled BURIED UTILITY LOCATOR GROUND TRACKING APPARATUS, SYSTEMS, AND METHODS; U.S. Pat. No. 9,411,066, issued Aug. 9, 2016, entitled SONDES & METHODS FOR USE WITH BURIED LINE LOCATOR SYSTEMS; U.S. Pat. No. 9,411,067, issued Aug. 9, 2016, entitled GROUND-TRACKING SYSTEMS AND APPARATUS; U.S. Pat. No. 9,435,907, issued Sep. 6, 2016, entitled PHASE SYNCHRONIZED BURIED OBJECT LOCATOR APPARATUS, SYSTEMS, AND METHODS; U.S. Pat. No. 9,448,376, issued Sep. 20, 2016, entitled HIGH BANDWIDTH PUSH-CABLES FOR VIDEO PIPE INSPECTION SYSTEMS; U.S. Pat. No. 9,465,129, issued Oct. 11, 2016, entitled IMAGE-BASED MAPPING LOCATING SYSTEM; U.S. Pat. No. 9,468,954, issued October 18,2016, entitled PIPE INSPECTION SYSTEM WITH JETTER PUSH-CABLE; U.S. Pat. No. 9,477,147, issued Oct. 25, 2016, entitled SPRING ASSEMBLIES WITH VARIABLE FLEXIBILITY FOR USE WITH PUSH-CABLES AND PIPE INSPECTION SYSTEMS; U.S. Pat. No. 9,488,747, issued Nov. 8, 2016, entitled GRADIENT ANTENNA COILS AND ARRAYS FOR USE IN LOCATING SYSTEM; U.S. Pat. No. 9,494,706, issued Nov. 15, 2016, entitled OMNI-INDUCER TRANSMITTING DEVICES AND METHODS; U.S. Pat. No. 9,521,303, issued Dec. 13, 2016, entitled CABLE STORAGE DRUM WITH MOVABLE CCU DOCKING APPARATUS; U.S. patent application Ser. No. 15/846,102, filed December 16,2016, entitled SYSTEMS AND METHODS FOR ELECTRONICALLY MARKING, LOCATING AND VIRTUALLY DISPLAYING BURIED UTILITIES; U.S. patent application Ser. No. 15/866,360, filed Jan. 9, 2017, entitled TRACKABLE DISTANCE MEASURING DEVICES, SYSTEMS, AND METHODS; U.S. Pat. No. 9,927,368, issued Mar. 27, 2021, entitled SELF-LEVELING INSPECTION SYSTEMS AND METHODS; U.S. Pat. No. 9,571,326, issued Feb. 14, 2017, entitled METHOD AND APPARATUS FOR HIGH-SPEED DATA TRANSFER EMPLOYING SELF-SYNCHRONIZING QUADRATURE AMPLITUDE MODULATION (QAM); U.S. Pat. No. 9,599,449, issued Mar. 21, 2017, entitled SYSTEMS AND METHODS FOR LOCATING BURIED OR HIDDEN OBJECTS USING SHEET CURRENT FLOW MODELS; U.S. Pat. No. 9,599,740, issued Mar. 21, 2017, entitled USER INTERFACES FOR UTILITY LOCATORS; U.S. Pat. No. 9,625,602, issued Apr. 18, 2017, entitled SMART PERSONAL COMMUNICATION DEVICES AS USER INTERFACES; U.S. Pat. No. 9,632,202, issued Apr. 25, 2017, entitled ECONOMICAL MAGNETIC LOCATOR APPARATUS AND METHODS; U.S. Pat. No. 9,634,878, issued Apr. 25, 2017, entitled SYSTEMS AND METHODS FOR DATA TRANSFER USING SELF-SYNCHRONIZING QUADRATURE AMPLITUDE MODULATION (QAM); United States patent application, filed Apr. 25, 2017, entitled SYSTEMS AND METHODS FOR LOCATING AND/OR MAPPING BURIED UTILITIES USING VEHICLE-MOUNTED LOCATING DEVICES; U.S. Pat. No. 9,638,824, issued May 2, 2017, entitled QUAD-GRADIENT COILS FOR USE IN LOCATING SYSTEMS; United States patent application, filed May 9, 2017, entitled BORING INSPECTION SYSTEMS AND METHODS; U.S. Pat. No. 9,651,711, issued May 16, 2017, entitled HORIZONTAL BORING INSPECTION DEVICE AND METHODS; U.S. Pat. No. 9,684,090, issued Jun. 20, 2017, entitled NULLED-SIGNAL LOCATING DEVICES, SYSTEMS, AND METHODS; U.S. Pat. No. 9,696,447, issued Jul. 4, 2017, entitled BURIED OBJECT LOCATING METHODS AND APPARATUS USING MULTIPLE ELECTROMAGNETIC SIGNALS; U.S. Pat. No. 9,696,448, issued Jul. 4, 2017, entitled GROUND-TRACKING DEVICES AND METHODS FOR USE WITH A UTILITY LOCATOR; U.S. Pat. No. 9,703,002, issued Jun. 11, 2017, entitled UTILITY LOCATOR SYSTEMS & METHODS; U.S. patent application Ser. No. 15/670,845, filed Aug. 7, 2016, entitled HIGH FREQUENCY AC-POWERED DRAIN CLEANING AND INSPECTION APPARATUS & METHODS; U.S. patent application Ser. No. 15/681,250, filed Aug. 18, 2017, entitled ELECTRONIC MARKER DEVICES AND SYSTEMS; U.S. patent application Ser. No. 15/681,409, filed Aug. 20, 2017, entitled WIRELESS BURIED PIPE & CABLE LOCATING SYSTEMS; U.S. Pat. No. 9,746,572, issued Aug. 29, 2017, entitled ELECTRONIC MARKER DEVICES AND SYSTEMS; U.S. Pat. No. 9,746,573, issued Aug. 29, 2017, entitled WIRELESS BURIED PIPE AND CABLE LOCATING SYSTEMS; U.S. Pat. No. 9,769,366, issued Sep. 29, 2017, entitled SELF-GROUNDING TRANSMITTER PORTABLE CAMERA CONTROLLER FOR USE WITH PIPE INSPECTION SYSTEMS; U.S. Pat. No. 9,784,837, issued Oct. 10, 2017, entitled OPTICAL GROUND TRACKING APPARATUS, SYSTEMS & METHODS; U.S. Pat. No. 9,798,033, issued Oct. 24, 2017, entitled SONDE DEVICES INCLUDING A SECTIONAL FERRITE CORE; U.S. patent application Ser. No. 15/811,361, filed Nov. 13, 2017, entitled OPTICAL GROUND-TRACKING APPARATUS, SYSTEMS, AND METHODS; U.S. Pat. No. 9,835,564, issued Dec. 5, 2017, entitled MULTI-CAMERA PIPE INSPECTION APPARATUS, SYSTEMS, AND METHODS; U.S. Pat. No. 9,841,503, issued Dec. 12, 2017, entitled OPTICAL GROUND-TRACKING APPARATUS, SYSTEMS, AND METHODS; U.S. patent application Ser. No. 15/846,102, filed Dec. 18, 2017, entitled SYSTEMS AND METHOD FOR ELECTRONICALLY MARKING, LOCATING AND VIRTUALLY DISPLAYING BURIED UTILITIES; U.S. patent application Ser. No. 15/866,360, filed Jan. 9, 2018, entitled TRACKED DISTANCE MEASURING DEVICES, SYSTEMS, AND METHODS; U.S. patent application Ser. No. 16/255,524, filed Jan. 23, 2018, entitled RECHARGEABLE BATTERY PACK ONBOARD CHARGE STATE INDICATION METHODS AND APPARATUS; U.S. Pat. No. 9,891,337, issued Feb. 13, 2018, entitled UTILITY LOCATOR TRANSMITTER DEVICES, SYSTEMS, and METHODS WITH DOCKABLE APPARATUS; U.S. Pat. No. 9,914,157, issued Mar. 13, 2018, entitled METHODS AND APPARATUS FOR CLEARING OBSTRUCTIONS WITH A JETTER PUSH-CABLE APPARATUS; U.S. patent application Ser. No. 15/925,643, issued Mar. 19, 2018, entitled PHASE-SYNCHRONIZED BURIED OBJECT TRANSMITTER AND LOCATOR METHODS AND APPARATUS; U.S. patent application Ser. No. 15/925,671, issued Mar. 19, 2018, entitled MULTI-FREQUENCY LOCATING SYSTEMS AND METHODS; U.S. patent application Ser. No. 15/936,250, filed Mar. 26, 2018, entitled GROUND TRACKING APPARATUS, SYSTEMS, AND METHODS; U.S. Pat. No. 9,927,545, issued Mar. 27, 2018, entitled MULTI-FREQUENCY LOCATING SYSTEMS & METHODS; U.S. Pat. No. 9,928,613, issued Mar. 27, 2018, entitled GROUND TRACKING APPARATUS, SYSTEMS, AND METHODS; U.S. patent application Ser. No. 15/250,666, filed Mar. 27, 2018, entitled PHASE-SYNCHRONIZED BURIED OBJECT TRANSMITTER AND LOCATOR METHODS AND APPARATUS; U.S. Pat. No. 9,880,309, issued Mar. 28, 2018, entitled UTILITY LOCATOR TRANSMITTER APPARATUS & METHODS; U.S. patent application Ser. No. 16/382,136, filed Apr. 11, 2018, entitled GEOGRAPHIC MAP UPDATING METHODS AND SYSTEMS; U.S. patent application Ser. No. 15/954,486, filed Apr. 16, 2018, entitled UTILITY LOCATOR APPARATUS, SYSTEMS, AND METHODS; U.S. Pat. No. 9,945,976, issued Apr. 17, 2018, entitled UTILITY LOCATOR APPARATUS, SYSTEMS, AND METHODS; U.S. Pat. No. 9,959,641, issued May 1, 2018, entitled METHODS AND SYSTEMS FOR SEAMLESS TRANSITIONING IN INTERACTIVE MAPPING SYSTEMS; U.S. Pat. No. 9,989,662, issued Jun. 5, 2018, entitled BURIED OBJECT LOCATING DEVICE WITH A PLURALITY OF SPHERICAL SENSOR BALLS THAT INCLUDE A PLURALITY OF ORTHOGONAL ANTENNAE; U.S. patent application Ser. No. 16/443,789, filed Jun. 18, 2018, entitled MULTI-DIELECTRIC COAXIAL PUSH-CABLES AND ASSOCIATED APPARATUS; U.S. Pat. No. 10,001,425, issued Jun. 19, 2018, entitled PORTABLE CAMERA CONTROLLER PLATFORM FOR USE WITH PIPE INSPECTION SYSTEM; U.S. Pat. No. 10,009,582, issued Jun. 26, 2018, entitled PIPE INSPECTION SYSTEM WITH REPLACEABLE CABLE STORAGE DRUM; U.S. patent application Ser. No. 16/036,713, issued Jul. 16, 2018, entitled UTILITY LOCATOR APPARATUS AND SYSTEMS; U.S. Pat. No. 10,027,526, issued Jul. 17, 2018, entitled METHOD AND APPARATUS FOR HIGH-SPEED DATA TRANSFER EMPLOYING SELF-SYNCHRONIZING QUADRATURE AMPLITUDE MODULATION; U.S. Pat. No. 10,024,994, issued Jul. 17, 2018, entitled WEARABLE MAGNETIC FIELD UTILITY LOCATOR SYSTEM WITH SOUND FIELD GENERATION; U.S. Pat. No. 10,031,253, issued Jul. 24, 2018, entitled GRADIENT ANTENNA COILS AND ARRAYS FOR USE IN LOCATING SYSTEMS; U.S. Pat. No. 10,042,072, issued Aug. 7, 2018, entitled OMNI-INDUCER TRANSMITTING DEVICES AND METHODS; U.S. Pat. No. 10,059,504, issued Aug. 28, 2018, entitled MARKING PAINT APPLICATOR FOR USE WITH PORTABLE UTILITY LOCATOR; U.S. patent application Ser. No. 16/049,699, filed Jul. 30, 2018, entitled OMNI-INDUCER TRANSMITTING DEVICES AND METHODS; U.S. Pat. No. 10,069,667, issued Sep. 4, 2018, entitled SYSTEMS AND METHODS FOR DATA TRANSFER USING SELF-SYNCHRONIZING QUADRATURE AMPLITUDE MODULATION (QAM); U.S. patent application Ser. No. 16/121,379, filed Sep. 4, 2018, entitled KEYED CURRENT SIGNAL UTILITY LOCATING SYSTEMS AND METHODS; U.S. patent application Ser. No. 16/125,768, filed Sep. 10, 2018, entitled BURIED OBJECT LOCATOR APPARATUS AND METHODS; U.S. Pat. No. 10,073,186, issued Sep. 11, 2018, entitled KEYED CURRENT SIGNAL UTILITY LOCATING SYSTEMS AND METHODS; U.S. patent application Ser. No. 16/133,642, issued Sep. 17, 2018, entitled MAGNETIC UTILITY LOCATOR DEVICES AND METHODS; U.S. Pat. No. 10,078,149, issued Sep. 18, 2018, entitled BURIED OBJECT LOCATORS WITH DODECAHEDRAL ANTENNA NODES; U.S. Pat. No. 10,082,591, issued Sep. 25, 2018, entitled MAGNETIC UTILITY LOCATOR DEVICES & METHODS; U.S. Pat. No. 10,082,599, issued Sep. 25, 2018, entitled MAGNETIC SENSING BURIED OBJECT LOCATOR INCLUDING A CAMERA; U.S. Pat. No. 10,090,498, issued Oct. 2, 2018, entitled MODULAR BATTERY PACK APPARATUS, SYSTEMS, AND METHODS INCLUDING VIRAL DATA AND/OR CODE TRANSFER; U.S. patent application Ser. No. 16/160,874, filed Oct. 15, 2018, entitled TRACKABLE DIPOLE DEVICES, METHODS, AND SYSTEMS FOR USE WITH MARKING PAINT STICKS; U.S. Pat. No. 10,100,507, issued October 16,2018, entitled PIPE CLEARING CABLES AND APPARATUS; U.S. Pat. No. 10,105,723, issued Oct. 23, 2018, entitled TRACKABLE DIPOLE DEVICES, METHODS, AND SYSTEMS FOR USE WITH MARKING PAINT STICKS; U.S. patent application Ser. No. 16/222,994, filed Dec. 17, 2018, entitled UTILITY LOCATORS WITH RETRACTABLE SUPPORT STRUCTURES AND APPLICATIONS THEREOF; U.S. Pat. No. 10,105,723, issued Oct. 23, 2018, entitled TRACKABLE DIPOLE DEVICES, METHODS, AND SYSTEMS FOR USE WITH MARKING PAINT STICKS; U.S. Pat. No. 10,162,074, issued Dec. 25, 2018, entitled UTILITY LOCATORS WITH RETRACTABLE SUPPORT STRUCTURES AND APPLICATIONS THEREOF; U.S. patent application Ser. No. 16/241,864, filed Jan. 7, 2019, entitled TRACKED DISTANCE MEASURING DEVICES, SYSTEMS, AND METHODS; U.S. patent application Ser. No. 16/255,524, filed Jan. 23, 2019, entitled RECHARGEABLE BATTERY PACK ONBOARD CHARGE STATE INDICATION METHODS AND APPARATUS; U.S. patent application Ser. No. 16/810,788, filed Mar. 5, 2019, entitled MAGNETICALLY RETAINED DEVICE HANDLES; U.S. Pat. No. 10,247,845, issued Apr. 2, 2019, entitled UTILITY LOCATOR TRANSMITTER APPARATUS AND METHODS; U.S. patent application Ser. No. 16/382,136, filed Apr. 11, 2019, entitled GEOGRAPHIC MAP UPDATING METHODS AND SYSTEMS; U.S. Pat. No. 10,274,632, issued Apr. 20, 2019, entitled UTILITY LOCATING SYSTEMS WITH MOBILE BASE STATION; U.S. patent application Ser. No. 16/390,967, filed Apr. 22, 2019, entitled UTILITY LOCATING SYSTEMS WITH MOBILE BASE STATION; U.S. Pat. No. 10,288,997, issued May 14, 2019, entitled ROTATING CONTACT ASSEMBLIES FOR SELF-LEVELING CAMERA HEADS; U.S. patent application Ser. No. 29/692,937, filed May 29, 2019, entitled BURIED OBJECT LOCATOR; U.S. patent application Ser. No. 16/436,903, filed Jun. 10, 2019, entitled OPTICAL GROUND TRACKING APPARATUS, SYSTEMS, AND METHODS FOR USE WITH BURIED UTILITY LOCATORS; U.S. Pat. No. 10,317,559, issued Jun. 11, 2019, entitled GROUND-TRACKING DEVICES AND METHODS FOR USE WITH A UTILITY LOCATOR; U.S. patent application Ser. No. 16/449,187, filed Jun. 21, 2019, entitled ELECTROMAGNETIC MARKER DEVICES FOR BURIED OR HIDDEN USE; U.S. patent application Ser. No. 16/455,491, filed Jun. 27, 2019, entitled SELF-STANDING MULTI-LEG ATTACHMENT DEVICES FOR USE WITH UTILITY LOCATORS; U.S. Pat. No. 10,353,103, issued Jul. 16, 2019, entitled SELF-STANDING MULTI-LEG ATTACHMENT DEVICES FOR USE WITH UTILITY LOCATORS; U.S. Pat. No. 10,371,305, issued Aug. 6, 2019, entitled DOCKABLE TRIPODAL CAMERA CONTROL UNIT; U.S. patent application Ser. No. 16/551,653, filed Aug. 26, 2019, entitled BURIED UTILITY MARKER DEVICES, SYSTEMS, AND METHODS; U.S. Pat. No. 10,401,526, issued Sep. 3, 2019, entitled BURIED UTILITY MARKER DEVICES, SYSTEMS, AND METHODS; U.S. Pat. No. 10,324,188, issued Oct. 9, 2019, entitled OPTICAL GROUND TRACKING APPARATUS, SYSTEMS, AND METHODS FOR USE WITH BURIED UTILITY LOCATORS; U.S. patent application Ser. No. 16/446,456, filed Jun. 19, 2019, entitled DOCKABLE TRIPODAL CAMERA CONTROL UNIT; U.S. patent application Ser. No. 16/520,248, filed Jul. 23, 2019, entitled MODULAR BATTERY PACK APPARATUS, SYSTEMS, AND METHODS; U.S. Pat. No. 10,371,305, issued Aug. 6, 2019, entitled DOCKABLE TRIPODAL CAMERA CONTROL UNIT; U.S. patent application Ser. No. 16/559,576, filed Sep. 3, 2019, entitled VIDEO PIPE INSPECTION SYSTEMS WITH VIDEO INTEGRATED WITH ADDITIONAL SENSOR DATA; U.S. patent application Ser. No. 16/588,834, filed Sep. 30, 2019, entitled VIDEO INSPECTION SYSTEM WITH WIRELESS ENABLED CABLE STORAGE DRUM; U.S. Pat. No. 10,440,332, issued Oct. 8, 2019, entitled INSPECTION CAMERA DEVICES AND METHODS WITH SELECTIVELY ILLUMINATED MULTISENSOR IMAGING; U.S. patent application Ser. No. 16/676,292, filed Nov. 6, 2019, entitled ROBUST IMPEDANCE CONTROLLED SLIP RINGS; U.S. Pat. No. 10,490,908, issued Nov. 26, 2019, entitled DUAL ANTENNA SYSTEMS WITH VARIABLE POLARIZATION; U.S. patent application Ser. No. 16/701,085, filed Dec. 2, 2019, entitled MAP GENERATION BASED ON UTILITY LINE POSITION AND ORIENTATION ESTIMATES; U.S. Pat. No. 10,534,105, issued Jan. 14, 2020, entitled UTILITY LOCATING TRANSMITTER APPARATUS AND METHODS; U.S. patent application Ser. No. 16/773,952, filed Jan. 27, 2020, entitled MAGNETIC FIELD CANCELING AUDIO DEVICES; U.S. patent application Ser. No. 16/780,813, filed Feb. 3, 2020, entitled RESILIENTLY DEFORMABLE MAGNETIC FIELD CORE APPARATUS AND APPLICATIONS; U.S. Pat. No. 10,555,086, issued Feb. 4, 2020, entitled MAGNETIC FIELD CANCELING AUDIO SPEAKERS FOR USE WITH BURIED UTILITY LOCATORS OR OTHER DEVICES; U.S. patent application Ser. No. 16/786,935, filed Feb. 10, 2020, entitled SYSTEMS AND METHODS FOR UNIQUELY IDENTIFYING BURIED UTILITIES IN A MULTI-UTILITY ENVIRONMENT; U.S. Pat. No. 10,557,824, issued Feb. 11, 2020, entitled RESILIENTLY DEFORMABLE MAGNETIC FIELD TRANSMITTER CORES FOR USE WITH UTILITY LOCATING DEVICES AND SYSTEMS; U.S. patent application Ser. No. 16/791,979, issued Feb. 14, 2020, entitled MARKING PAINT APPLICATOR APPARATUS; U.S. patent application Ser. No. 16/792,047, filed Feb. 14, 2020, entitled SATELLITE AND MAGNETIC FIELD SONDE APPARATUS AND METHODS; U.S. Pat. No. 10,564,309, issued Feb. 18, 2020, entitled SYSTEMS AND METHODS FOR UNIQUELY IDENTIFYING BURIED UTILITIES IN A MULTI-UTILITY ENVIRONMENT; U.S. Pat. No. 10,571,594, issued Feb. 25, 2020, entitled UTILITY LOCATOR DEVICES, SYSTEMS, AND METHODS WITH SATELLITE AND MAGNETIC FIELD SONDE ANTENNA SYSTEMS; U.S. Pat. No. 10,569,952, issued Feb. 25, 2020, entitled MARKING PAINT APPLICATOR FOR USE WITH PORTABLE UTILITY LOCATOR; U.S. patent application Ser. No. 16/827,672, filed Mar. 23, 2020, entitled DUAL ANTENNA SYSTEMS WITH VARIABLE POLARIZATION; U.S. patent application Ser. No. 16/833,426, filed Mar. 27, 2020, entitled LOW COST, HIGH PERFORMANCE SIGNAL PROCESSING IN A MAGNETIC-FIELD SENSING BURIED UTILITY LOCATOR SYSTEM; U.S. Pat. No. 10,608,348, issued Mar. 31, 2020, entitled DUAL ANTENNA SYSTEMS WITH VARIABLE POLARIZATION; U.S. patent application Ser. No. 16/837,923, filed Apr. 1, 2020, entitled MODULAR BATTERY PACK APPARATUS, SYSTEMS, AND METHODS INCLUDING VIRAL DATA AND/OR CODE TRANSFER; U.S. patent application Ser. No. 17/235,507, filed Apr. 20, 2021, entitled UTILITY LOCATING DEVICES EMPLOYING MULTIPLE SPACED APART GNSS ANTENNAS; U.S. patent application Ser. No. 16/872,362, filed May 11, 2020, entitled BURIED LOCATOR SYSTEMS AND METHODS; U.S. patent application Ser. No. 16/882,719, filed May 25, 2020, entitled UTILITY LOCATING SYSTEMS, DEVICES, AND METHODS USING RADIO BROADCAST SIGNALS; U.S. Pat. No. 10,670,766, issued Jun. 2, 2020, entitled UTILITY LOCATING SYSTEMS, DEVICES, AND METHODS USING RADIO BROADCAST SIGNALS; U.S. Pat. No. 10,677,820, issued Jun. 9, 2020, entitled BURIED LOCATOR SYSTEMS AND METHODS; U.S. patent application Ser. No. 16/902,245, filed Jun. 15, 2020, entitled LOCATING DEVICES, SYSTEMS, AND METHODS USING FREQUENCY SUITES FOR UTILITY DETECTION; U.S. patent application Ser. No. 16/902,249, filed Jun. 15, 2020, entitled USER INTERFACES FOR UTILITY LOCATORS; U.S. patent application Ser. No. 16/908,625, filed Jun. 22, 2020, entitled ELECTROMAGNETIC MARKER DEVICES WITH SEPARATE RECEIVE AND TRANSMIT ANTENNA ELEMENTS; U.S. Pat. No. 10,690,795, issued Jun. 23, 2020, entitled LOCATING DEVICES, SYSTEMS, AND METHODS USING FREQUENCY SUITES FOR UTILITY DETECTION; U.S. Pat. No. 10,690,796, issued Jun. 23, 2020, entitled USER INTERFACES FOR UTILITY LOCATORS; U.S. patent application Ser. No. 16/921,775, filed Jul. 6, 2020, entitled AUTO-TUNING CIRCUIT APPARATUS AND METHODS; U.S. patent application Ser. No. 17/397,940, filed Aug. 9, 2021, entitled INSPECTION SYSTEM PUSH-CABLE GUIDE APPARATUS; U.S. patent application Ser. No. 16/995,801, filed Aug. 17, 2020, entitled UTILITY LOCATOR TRANSMITTER DEVICES, SYSTEMS, AND METHODS; U.S. patent application Ser. No. 17/001,200, filed Aug. 24, 2020, entitled MAGNETIC SENSING BURIED UTILITY LOCATOR INCLUDING A CAMERA; U.S. patent Ser. No. 16/995,793, filed Aug. 17, 2020, entitled UTILITY LOCATOR APPARATUS AND METHODS; U.S. Pat. No. 10,753,722, issued Aug. 25, 2020, entitled SYSTEMS AND METHODS FOR LOCATING BURIED OR HIDDEN OBJECTS USING SHEET CURRENT FLOW MODELS; U.S. Pat. No. 10,754,053, issued Aug. 25, 2020, entitled UTILITY LOCATOR TRANSMITTER DEVICES, SYSTEMS, AND METHODS WITH DOCKABLE APPARATUS; U.S. Pat. No. 10,761,233, issued Sep. 1, 2020, entitled SONDES AND METHODS FOR USE WITH BURIED LINE LOCATOR SYSTEMS; U.S. Pat. No. 10,761,239, issued Sep. 1, 2020, entitled MAGNETIC SENSING BURIED UTILITY LOCATOR INCLUDING A CAMERA; U.S. Pat. No. 10,764,541, issued Sep. 1, 2020, entitled COAXIAL VIDEO PUSH-CABLES FOR USE IN INSPECTION SYSTEMS; U.S. patent application Ser. No. 17/013,831, filed Sep. 7, 2020, entitled MULTIFUNCTION BURIED UTILITY LOCATING CLIPS; U.S. patent application Ser. No. 17/014,646, filed Sep. 8, 2020, entitled INTEGRATED FLEX-SHAFT CAMERA SYSTEM AND HAND CONTROL; U.S. Pat. No. 10,777,919, issued Sep. 15, 2020, entitled MULTIFUNCTION BURIED UTILITY LOCATING CLIPS; U.S. patent application Ser. No. 17/020,487, filed Sep. 14, 2020, entitled ANTENNA SYSTEMS FOR CIRCULARLY POLARIZED RADIO SIGNALS; U.S. patent application Ser. No. 17/068,156, filed Oct. 12, 2020, entitled DUAL SENSED LOCATING SYSTEMS AND METHODS; U.S. Pat. No. 10,809,408, issued Oct. 20, 2020, entitled DUAL SENSED LOCATING SYSTEMS AND METHODS; U.S. Pat. No. 10,845,497, issued Nov. 24, 2020, entitled PHASE-SYNCHRONIZED BURIED OBJECT TRANSMITTER AND LOCATOR METHODS AND APPARATUS; U.S. Pat. No. 10,848,655, issued Nov. 24, 2020, entitled HEAT EXTRACTION ARCHITECTURE FOR COMPACT VIDEO CAMERA HEADS; U.S. patent application Ser. No. 17/110,273, filed Dec. 2, 2020, entitled INTEGRAL DUAL CLEANER CAMERA DRUM SYSTEMS AND METHODS; U.S. Pat. No. 10,859,727, issued Dec. 8, 2020, entitled ELECTRONIC MARKER DEVICES AND SYSTEMS; U.S. Pat. No. 10,908,311, issued Feb. 2, 2021, entitled SELF-STANDING MULTI-LEG ATTACHMENT DEVICES FOR USE WITH UTILITY LOCATORS; U.S. Pat. No. 10,928,538, issued Feb. 23, 2021, entitled KEYED CURRENT SIGNAL LOCATING SYSTEMS AND METHODS; U.S. Pat. No. 10,935,686, issued Mar. 2, 2021, entitled UTILITY LOCATING SYSTEM WITH MOBILE BASE STATION; U.S. patent application Ser. No. 17/190,400, filed Mar. 3, 2021, entitled DOCKABLE CAMERA REEL AND CCU SYSTEM; U.S. Pat. No. 10,955,583, issued Mar. 23, 2021, entitled BORING INSPECTION SYSTEMS AND METHODS; U.S. Pat. No. 9,927,368, issued Mar. 27, 2021, entitled SELF-LEVELING INSPECTION SYSTEMS AND METHODS; U.S. Pat. No. 10,976,462, issued Apr. 13, 2021, entitled VIDEO INSPECTION SYSTEMS WITH PERSONAL COMMUNICATION DEVICE USER INTERFACES; U.S. patent application Ser. No. 17/501,670, filed Oct. 14, 2021, entitled ELECTRONIC MARKER-BASED NAVIGATION SYSTEMS AND METHODS FOR USE IN GNSS-DEPRIVED ENVIRONMENTS; U.S. patent application Ser. No. 17/528,956, filed Nov. 17, 2021, entitled VIDEO INSPECTION SYSTEM, APPARATUS, AND METHODS WITH RELAY MODULES AND CONNECTION PORT; U.S. patent application Ser. No. 17/541,057, filed Dec. 2, 2021, entitled COLOR-INDEPENDENT MARKER DEVICE APPARATUS, METHODS, AND SYSTEMS; U.S. patent application Ser. No. 17/541,057, filed Dec. 2, 2021, entitled VIDEO INSPECTION SYSTEM, APPARATUS, AND METHODS WITH RELAY MODULES AND CONNECTION PORTCOLOR-INDEPENDENT MARKER DEVICE APPARATUS, METHODS, AND SYSTEMS; U.S. Pat. No. 11,193,767, issued Dec. 7, 2021, entitled SMART PAINT STICK DEVICES AND METHODS; U.S. Pat. No. 11,199,510, issued Dec. 14, 2021, entitled PIPE INSPECTION AND CLEANING APPARATUS AND SYSTEMS; U.S. Pat. No. 11,209,115, issued Dec. 28, 2021, entitled PIPE INSPECTION AND/OR MAPPING CAMERA HEADS, SYSTEMS, AND METHODS; U.S. patent application Ser. No. 17/563,049, filed Dec. 28, 2021, entitled SONDE DEVICES WITH A SECTIONAL FERRITE CORE; U.S. patent application Ser. No. 17/687,538, filed Mar. 4, 2022, entitled ANTENNAS, MULTI-ANTENNA APPARATUS, AND ANTENNA HOUSINGS; U.S. Pat. No. 11,280,934, issued Mar. 22, 2022, entitled ELECTROMAGNETIC MARKER DEVICES FOR BURIED OR HIDDEN USE; U.S. Pat. No. 11,300,597, issued Apr. 12, 2022, entitled SYSTEMS AND METHODS FOR LOCATING AND/OR MAPPING BURIED UTILITIES USING VEHICLE-MOUNTED LOCATING DEVICES; U.S. patent application Ser. No. 17/845,290, filed Jun. 21, 2022, entitled DAYLIGHT VISIBLE AND MULTI-SPECTRAL LASER RANGEFINDERS AND ASSOCIATED SYSTEMS AND METHODS AND UTILITY LOCATOR DEVICES; MODULAR BATTERY SYSTEMS INCLUDING INTERCHANGEABLE BATTERY INTERFACE APPARATUS; U.S. patent application Ser. No. 18/162,663, filed Jan. 31, 2023, entitled UTILITY LOCATING SYSTEMS AND METHODS WITH FILTER TUNING FOR POWER GRID FLUCTUATIONS; U.S. Pat. No. 11,614,613, issued Mar. 28, 2023, entitled DOCKABLE CAMERA REEL AND CCU SYSTEM; U.S. Pat. No. 11,649,917, issued May 16, 2023, entitled INTEGRATED FLEX-SHAFT CAMERA SYSTEM WITH HAND CONTROL; U.S. Pat. No. 11,665,321, issued May 30, 2023, entitled PIPE INSPECTION SYSTEM WITH REPLACEABLE CABLE STORAGE DRUM; U.S. Pat. No. 11,674,906, issued Jun. 13, 2023, entitled SELF-LEVELING INSPECTION SYSTEMS AND METHODS; U.S. Provisional Patent Application 63/510,014, filed Jun. 23, 2023, entitled INNER DRUM MODULE WITH PUSH-CABLE INTERFACE FOR PIPE INSPECTION; U.S. Pat. No. 11,686,878, issued Jun. 27, 2023, entitled ELECTRONIC MARKER DEVICES FOR BURIED OR HIDDEN USE; U.S. Provisional Patent Application 63/524,698, filed Jul. 2, 2023, entitled FILTERING METHODS AND ASSOCIATED UTILITY LOCATOR DEVICES FOR LOCATING AND MAPPING BURIED UTILITY LINES; U.S. Provisional Patent Application 63/514,090, filed Jul. 17, 2023, entitled SMARTPHONE MAPPING APPARATUS FOR ASSET TAGGING AS USED WITH UTILITY LOCATOR DEVICES; U.S. Pat. No. 11,709,289, issued Jul. 25, 2023, entitled SONDE DEVICES WITH A SECTIONAL FERRITE CORE; U.S. patent application Ser. No. 18/365,225, filed Aug. 3, 2023, entitled SYSTEMS AND METHODS FOR INSPECTION ANIMATION; U.S. Pat. No. 11,719,376, issued Aug. 8, 2023, entitled DOCKABLE TRIPODAL CAMERA CONTROL UNIT; U.S. Pat. No. 11,719,646, issued Aug. 8, 2023, entitled PIPE MAPPING SYSTEMS AND METHODS; U.S. Pat. No. 11,719,846, issued Aug. 8, 2023, entitled BURIED UTILITY LOCATING SYSTEMS WITH WIRELESS DATA COMMUNICATION INCLUDING DETERMINATION OF CROSS COUPLING TO ADJACENT UTILITIES; U.S. patent application Ser. No. 18/233,285, filed Aug. 11, 2023, entitled BURIED OBJECT LOCATOR; U.S. patent application Ser. No. 18/236,786, filed Aug. 22, 2023, entitled MAGNETIC UTILITY LOCATOR DEVICES AND METHODS; U.S. Pat. No. 11,747,505, issued Sep. 5, 2023, entitled MAGNETIC UTILITY LOCATOR DEVICES AND METHODS; U.S. patent application Ser. No. 18/368,510, filed Sep. 14, 2023, entitled MULTIFUNCTION BURIED UTILITY LOCATING CLIPS; U.S. patent application Ser. No. 18/365,203, filed Sep. 14, 2023, entitled SYSTEMS AND METHODS FOR ELECTRONICALLY MARKING, LOCATING AND VIRTUALLY DISPLAYING BURIED UTILITIES; U.S. Pat. No. 11,768,308, issued Sep. 26, 2023, entitled SYSTEMS AND METHODS FOR ELECTRONICALLY MARKING, LOCATING AND VIRTUALLY DISPLAYING BURIED UTILITIES; U.S. Pat. No. 11,769,956, issued Sep. 26, 2023, entitled MULTIFUNCTION BURIED UTILITY LOCATING CLIPS; U.S. Pat. No. 11,782,179, issued Oct. 10, 2023, entitled BURIED OBJECT LOCATOR WITH DODECAHEDRAL ANTENNA CONFIGURATION APPARATUS AND METHODS; U.S. Pat. No. 11,789,093, issued Oct. 17, 2023, entitled THREE-AXIS MEASUREMENT MODULES AND SENSING METHODS; U.S. Provisional patent application Ser. No. 18/490,763, filed Oct. 20, 2023, entitled LINKED CABLE-HANDLING AND CABLE-STORAGE DRUM DEVICES AND SYSTEMS FOR COORDINATED MOVEMENT OF PUSH-CABLE; U.S. Pat. No. 11,796,707, issued Oct. 24, 2023, entitled USER INTERFACES FOR UTILITY LOCATORS; U.S. patent application Ser. No. 18/544,042, filed Dec. 18, 2023, entitled SYSTEMS, APPARATUS, AND METHODS FOR DOCUMENTING UTILITY POTHOLES AND ASSOCIATED UTILITY LINES; U.S. Pat. No. 11,876,283, issued Jan. 16, 2024, entitled COMBINED SATELLITE NAVIGATION AND RADIO TRANSCEIVER ANTENNA DEVICES; U.S. Pat. No. 11,894,707, issued Feb. 6, 2024, entitled RECHARGEABLE BATTERY PACK ONBOARD CHARGE STATE INDICATION METHODS AND APPARATUS; U.S. Pat. No. 11,909,104, issued Feb. 20, 2024, entitled ANTENNAS, MULTI-ANTENNA APPARATUS, AND ANTENNA HOUSINGS; U.S. Provisional Patent Application 63/558,098, filed Feb. 26, 2024, entitled SYSTEMS, DEVICES, AND METHODS FOR DOCUMENTING GROUND ASSETS AND ASSOCIATED UTILITY LINES; U.S. Pat. No. 11,921,225, issued Mar. 5, 2024, entitled ANTENNA SYSTEMS FOR CIRCULARLY POLARIZED RADIO SIGNALS; U.S. patent application Ser. No. 18/611,449, filed Mar. 20, 2024, entitled VIDEO INSPECTION AND CAMERA HEAD TRACKING SYSTEMS AND METHODS; U.S. Pat. No. 11,953,643, issued Apr. 9, 2024, entitled MAP GENERATION BASED ON UTILITY LINE POSITION AND ORIENTATION ESTIMATES; U.S. Pat. No. 11,988,755, issued May 21, 2024, entitled UTILITY LOCATING DEVICES EMPLOYING MULTIPLE SPACED APART GNSS ANTENNAS; U.S. Provisional Patent 63/659,722, filed Jun. 13, 2024, entitled VEHICLE-MOUNTING DEVICES AND METHODS FOR USE IN VEHICLE-BASED LOCATING SYSTEMS; U.S. Provisional application Ser. No. 18/758,937, filed Jun. 28, 2024, entitled FILTERING METHODS AND ASSOCIATED UTILITY LOCATOR DEVICES FOR LOCATING AND MAPPING BURIED UTILITY LINES; U.S. patent application Ser. No. 18/774,758, filed Jul. 16, 2024, entitled SMARTPHONE MOUNTING APPARATUS AND IMAGING METHODS FOR ASSET TAGGING AND UTILITY MAPPING AS USED WITH UTILITY LOCATING DEVICES; U.S. Provisional Patent 63/692,642, issued Sep. 9, 2024, entitled ELECTRONIC MODULES AND ASSOCIATED SYSTEMS; U.S. Provisional Patent 63/694,102, issued Sep. 12, 2024, entitled METHODS AND APPARATUS FOR BATTERY SWAPPING IN UTILITY LOCATOR DEVICES AND OTHER COMPLEX BOOTABLE ELECTRONIC DEVICES; U.S. patent application Ser. No. 19/059,288, filed Feb. 21, 2025, entitled SYSTEMS, DEVICES, AND METHODS FOR DOCUMENTING GROUND ASSETS AND ASSOCIATED UTILITY LINES; U.S. Provisional Patent 63/770,287, filed Mar. 11, 2025, entitled WORLD FRAME/LOCAL FRAME MAPPING AND RE-MAPPING IN A UTILITY LOCATION SYSTEM; U.S. Pat. No. 12,253,382, issued Mar. 18, 2025, entitled VEHICLE-BASED UTILITY LOCATING USING PRINCIPAL COMPONENTS; and United States patent application, filed May 5, 2025, entitled SYSTEMS AND METHODS FOR LOCATING AND MAPPING BURIED UTILITY OBJECTS USING ARTIFICIAL INTELLIGENCE WITH LOCAL OR REMOTE PROCESSING. The content of each of the above-described patents and applications is incorporated by reference herein in its entirety. The above applications may be collectively denoted herein as the “co-assigned applications” or “incorporated applications.”

The following exemplary embodiments are provided for the purpose of illustrating examples of various aspects, details, and functions of apparatus and systems; however, the described embodiments are not intended to be in any way limiting. It will be apparent to one of ordinary skill in the art that various aspects may be implemented in other embodiments within the spirit and scope of the present disclosure.

It is noted that as used herein, the term, “exemplary” means “serving as an example, instance, or illustration.” Any aspect, detail, function, implementation, and/or embodiment described herein as “exemplary” is not necessarily to be construed as preferred or advantageous over other aspects and/or embodiments.

### Terminology

The terms “electromagnetic signals” and “signals” as used herein may refer to the radiation of electromagnetic energy, and in particular to the associated magnetic field vectors. Such electromagnetic signals may be from current coupled to a conductive utility line, current inherently flowing through a utility line (e.g., power line), the re-radiation of electromagnetic energy (e.g., broadcast radio signals or the like), and other radiation of electromagnetic energy from other sources that may be measured via antenna coils and associated receiver circuitry of one or more utility locator devices that may be disposed on vehicle-mounting device as moved by connected vehicle. Likewise, the measurement of electromagnetic signals may include, but is not limited to, measurements of frequencies, measurements of phase, signal strength, signal shape, current direction, changes in such measurements over time, and the like. Data relating to electromagnetic signals generated via one or more utility locator devices may be referred to herein as “Electromagnetic Data.”

The term “locate environment” or “environment” as used herein may refer to the area scanned via utility locator devices and/or other measuring devices included in the vehicle-mounting devices and vehicle-based locating systems herein.

The “utility locator devices” of the present disclosure may, for instance, be moved about an environment (generally via a vehicle-mounting device as moved by connected vehicle), to measure magnetic signals to further determine the positions of and map utility lines which may generally be buried underground. In various embodiments, a plurality of utility locator devices may measure electromagnetic signals simultaneously spaced apart on a vehicle-mounting device as moved about by a connected vehicle. The utility locator devices may include a plurality of antennas and associated receiver circuitry as found in the various incorporated patents and patent applications referenced herein.

The term “topographical” as used herein may refer to contours, dips, bumps, or other geometry of the ground surface. “Topographical Data” may, in some embodiments, be determined relating to the ongoing, changing geometry or topography of the ground surface through which a vehicle having an attached vehicle-mounting device and one or more utility locator devices may be moved.

The term “locate environment sensor element” may refer to one or more sensors and apparatus for generating and mapping data related to images, positions, and the identity of objects in the locate environment (e.g., poles, signs, fire hydrants, buildings, transformers, and other such objects and attributes). The data generated by such locate environment sensor elements may be referred to herein as “Locate Environment Data.”

The term, “GPR Data,” may refer to data and information regarding images or other representations and mapping of the sub-surface of the locate environment as generated via one or more GPRs included in the vehicle-mounting devices and vehicle-based locating systems herein.

The term “locator pod assembly,” “locator pod,” or simply “pod” may refer to a protective receptacle for containing a utility locator device while disposed on a vehicle-mounting device of the present disclosure.

The term “length,” when used in reference to the masts of the present invention, may refer to the elongated, substantially vertical distance of a mast on which pods containing utility locator devices may slide along when the pods may inadvertently scrape or contact the ground surface (e.g., when the attached vehicle drives through terrain having contours, dips, bumps, or other topography/geometry causing the pods to come in contact with the ground surface).

The term “height setting” may refer to the distance a pod containing a utility locator device may be positioned from the ground surface in a normal flat environment. In various embodiments, the height setting may be adjustable. Likewise, in some embodiments, height setting adjustments may be automatic either by user control or as determined through analysis of the topography of the approaching ground surface through which a vehicle having an attached vehicle-mounting device and one or more utility locator devices may be moved.

The term “tilt angle” may refer to the angle from a normal upright vertical orientation a pod containing a utility locator device may be positioned. In some embodiments, tilt angle adjustments may be automatic either by user control or as determined through analysis of the topography of the approaching ground surface through which a vehicle having an attached vehicle-mounting device and one or more utility locator devices may be moved.

### Example Vehicle-Mounting Device and Method and Vehicle-Based Locating System Embodiments

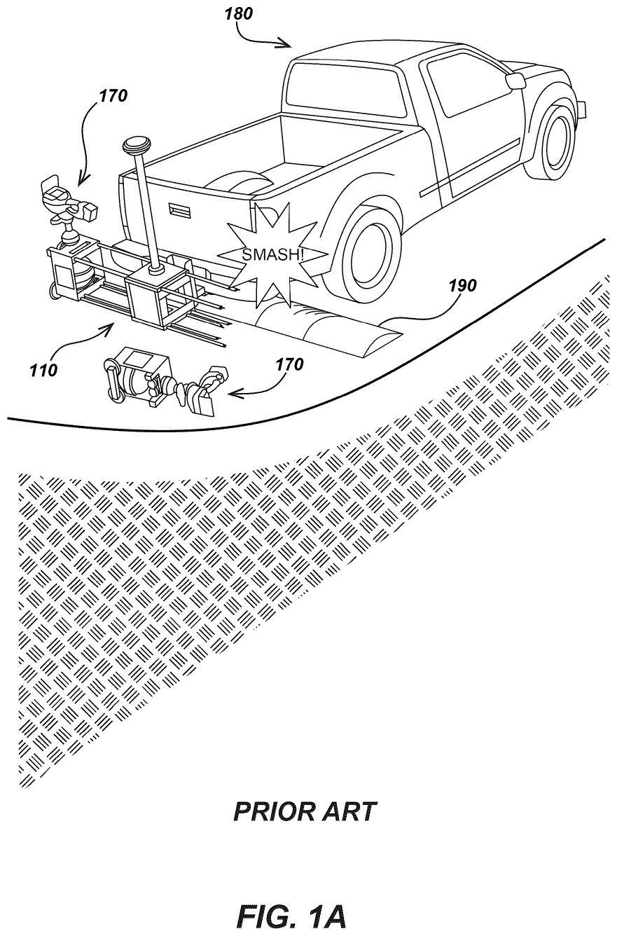

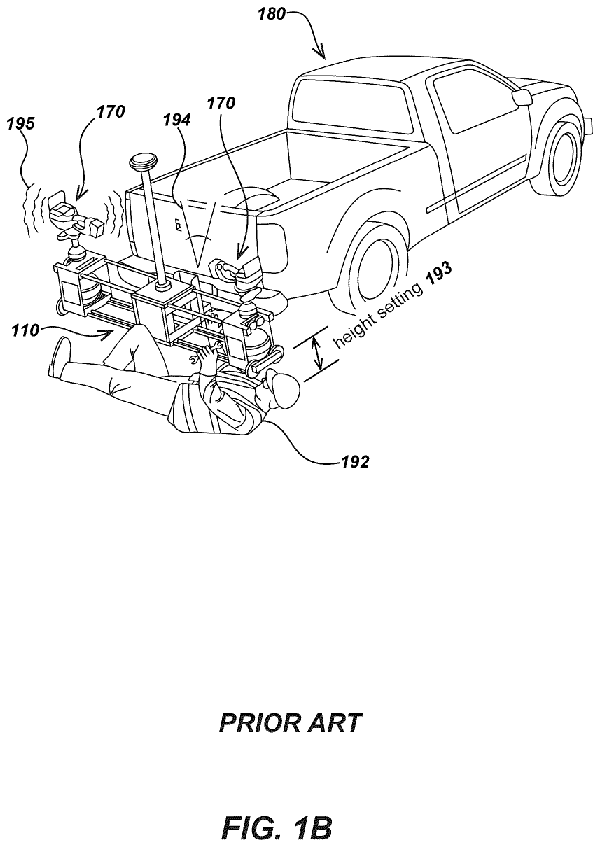

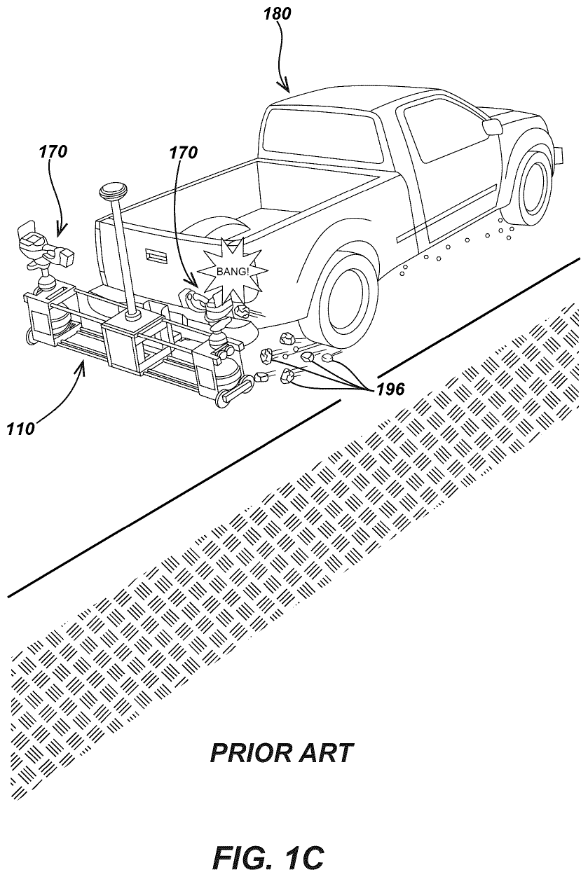

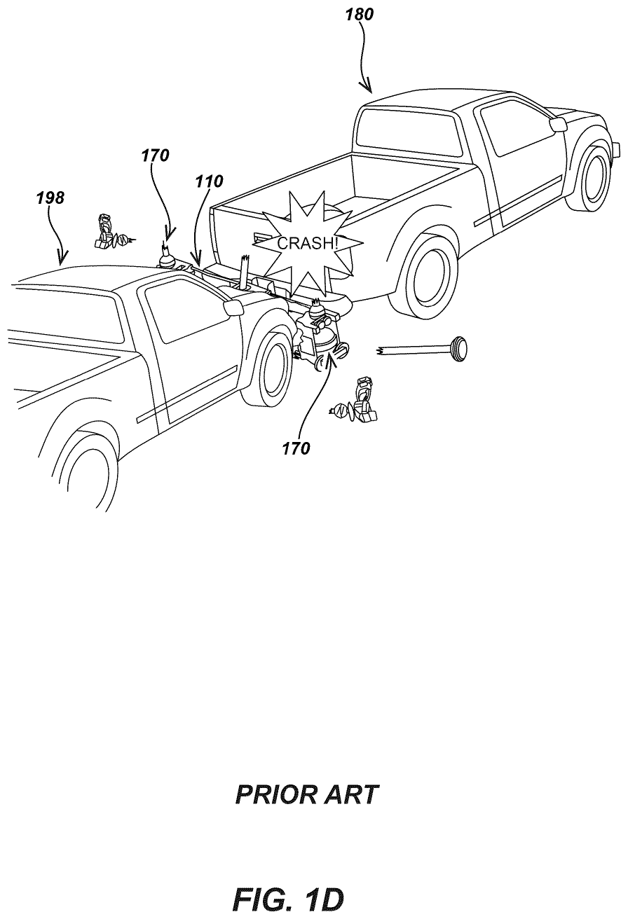

Referring to FIGS. 1A-1D, a prior art vehicle-mounting device 110 is illustrated mounting a plurality of utility locator devices 170 mounted to a vehicle 180 in various use scenarios. The prior art vehicle-mounting device 110 may have a plurality of utility locator devices 170 to measure electromagnetic signals across a range in frequencies and determine and map the positions and depths of utility lines. For instance, the vehicle-mounting device 110 and methods to determine and map utility lines may be or share aspects with the devices and methods disclosed in U.S. patent application Ser. No. 17/382,040, filed Jul. 21, 2021, entitled VEHICLE-BASED UTILITY LOCATING USING PRINCIPAL COMPONENTS; U.S. Pat. No. 11,300,597, issued Apr. 12, 2022, entitled SYSTEMS AND METHODS FOR LOCATING AND/OR MAPPING BURIED UTILITIES USING VEHICLE-MOUNTED LOCATING DEVICES; U.S. Pat. No. 11,630,142, issued Apr. 18, 2023, entitled SYSTEMS AND METHODS FOR LOCATING AND/OR MAPPING BURIED UTILITIES USING VEHICLE-MOUNTED LOCATING DEVICES; and other devices, systems, and methods of the incorporated patents and applications.

Various issues that a technician may experience with the prior art vehicle-mounting device 110 are illustrated in FIGS. 1A-1D. For instance, there are many use scenarios where bumps, dips, or other ground surface topography, such as a speedbump 190 of FIG. 1A, that could result in impact and costly damage to the utility locator devices 170 and/or the vehicle-mounting device 110.

Further illustrated in FIG. 1B, to raise or lower the height at which the utility locator devices 170 sit in prior art vehicle-mounting devices 110 above the ground surface, further referred to herein as “height setting” (e.g. a height setting 193), a technician 192 must manually adjust the vehicle-mounting device 110. Likewise, in order to adjust as the angle of the utility locator devices 170 relative to an upright vertical position further referred to herein as “tilt angle” (e.g., a tilt angle 194), technician 192 must manually adjust the vehicle-mounting device 110. As the topography of a road or other ground surface generally changes, the height setting 193 and/or tilt angle 194 may be tedious if not impossible for a technician 192 to continually manually adjust. It should be noted that vehicle-mounting devices known in the art fail to provide a rigid mounting element to the vehicle (e.g. the vehicle 180) and thus results in unnecessary and potential damaging vibrations 195 at the utility locator devices 170 and other elements of the vehicle-mounting devices 110.

Further illustrated in FIGS. 1C and 1D, the utility locator devices 170 secured in the prior art vehicle-mounting device 110 may be unprotected from impact damage. For instance, the lack of housing or other shell element to protect the utility locator devices 170 in the prior art vehicle-mounting device 110 may unnecessarily result in damage to the utility locator devices 170 from the impact of objects such as the gravel 196 as illustrated in FIG. 1C and/or the impact from other vehicles 198 as illustrated in FIG. 1D.

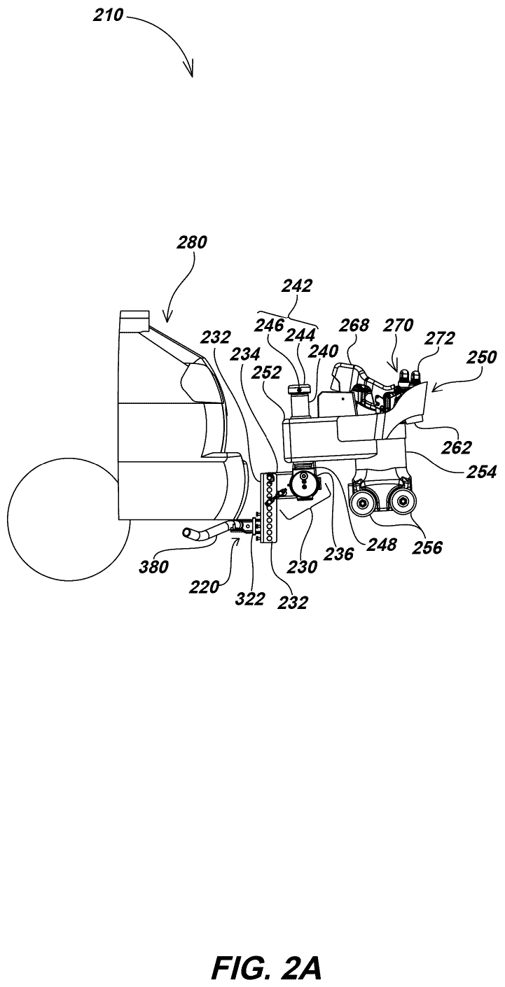

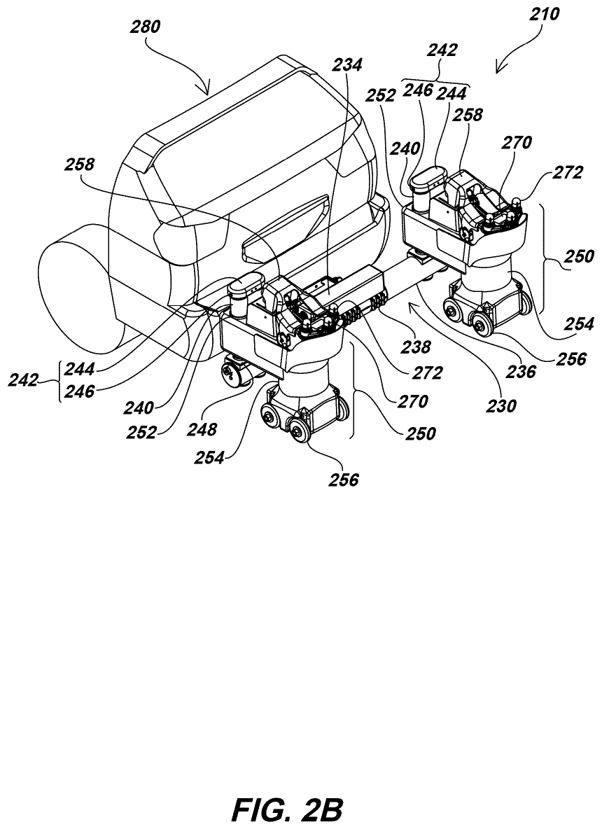

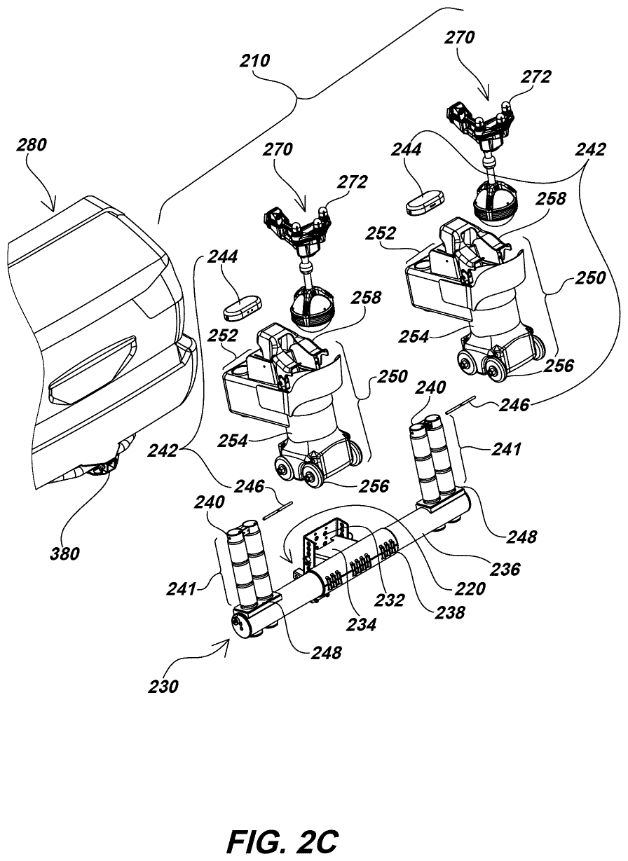

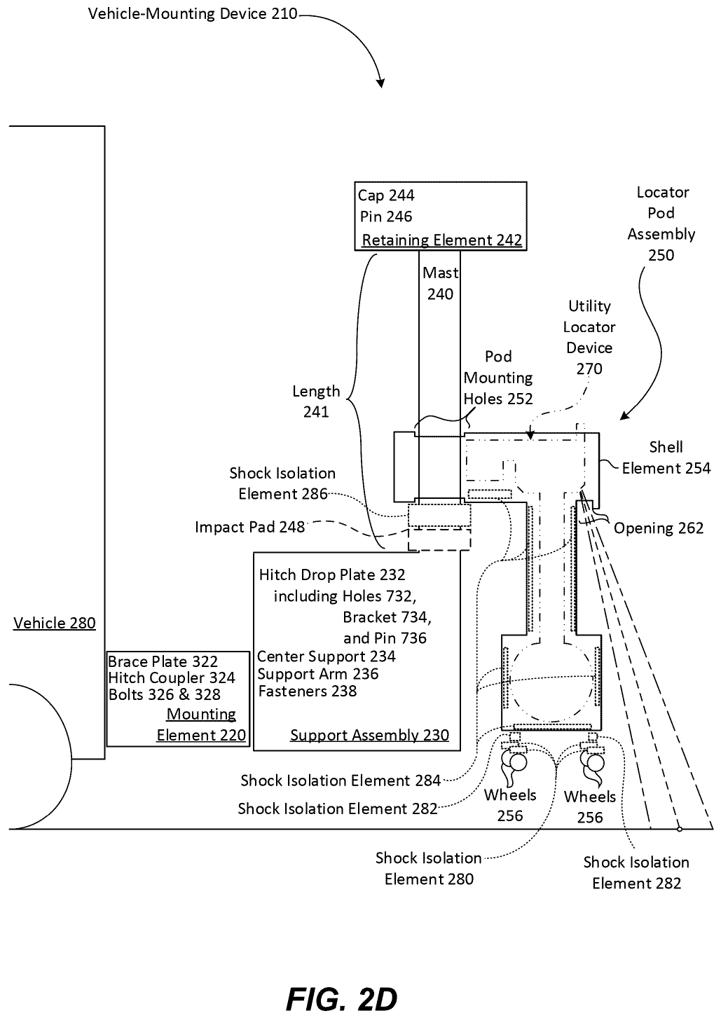

Turning to FIGS. 2A, 2B, and 2C, a vehicle-mounting device 210 for use mounting one or more utility locator devices 270 to a vehicle 280 (partially obscured) is illustrated which may solve many of the issues associated with prior art vehicle-mounting devices such as the vehicle-mounting device 110 of FIGS. 1A-1D. The vehicle-mounting device 210 may have a mounting element 220 (obscured in FIG. 2B) for coupling to the vehicle 280.

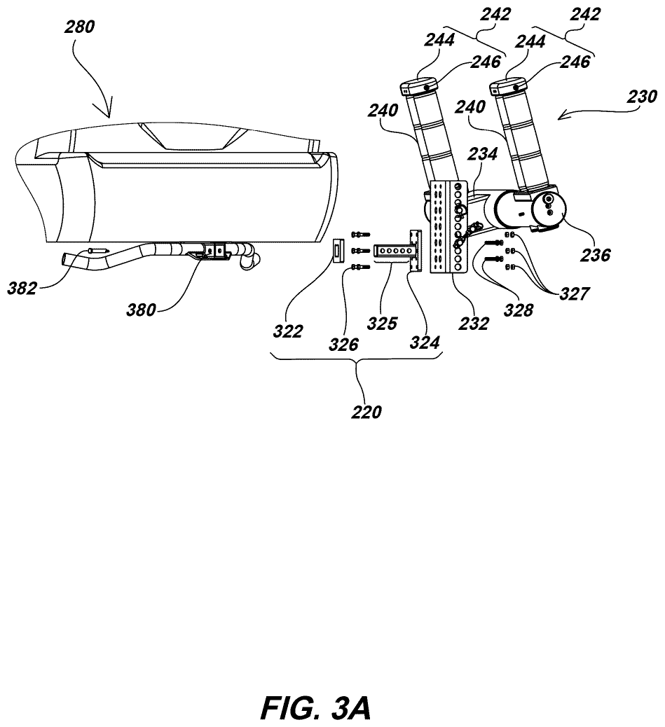

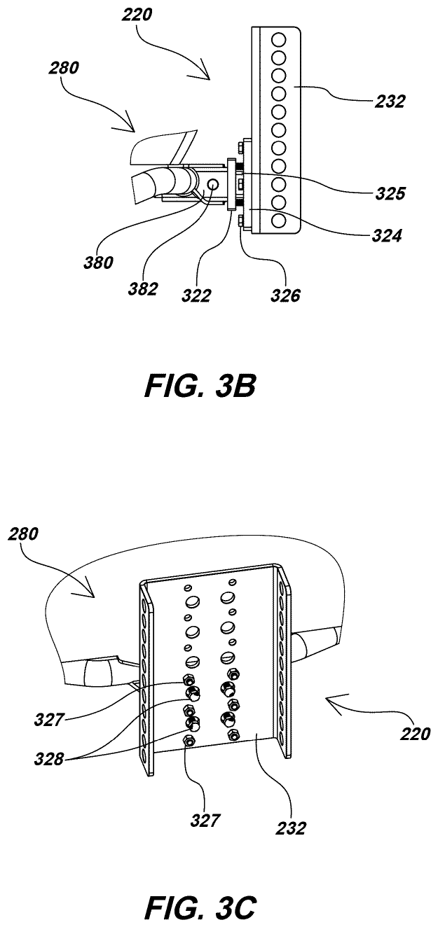

As illustrated in greater detail in FIGS. 3A, 3B, and 3C, the mounting element 220 may include a brace plate 322 (FIGS. 3A and 3B) and a hitch coupler 324 (FIGS. 3A and 3B) for coupling to a standard, commercially available hitch receiver 380 (FIGS. 3A and 3B) pre-installed on the vehicle 280. The hitch coupler 324 (FIGS. 3A and 3B) may mount to a hitch drop plate 232 on a support assembly 230 via one or more bolts 326 (FIGS. 3A and 3B) coupling with a series of nuts 327 (FIGS. 3A and 3C). Further, the brace plate 322 (FIGS. 3A and 3B) may couple to the hitch drop plate 232 via one or more bolts 328 (FIGS. 3A and 3C) with the hitch coupler 324 (FIGS. 3A and 3B) wedged between the brace plate 322 (FIGS. 3A and 3B) and the hitch drop plate 232. A forward portion 325 (FIGS. 3A and 3B) of the hitch coupler 324 (FIGS. 3A and 3B) may fit through an opening through the brace plate 322 (FIGS. 3A and 3B), fit into the hitch receiver 380 (FIGS. 3A and 3B), and couple thereto via a pin 382 (FIG. 3A). It should be noted, the pin 382 (FIG. 3A) may optionally include a lock (not illustrated) to prevent theft as well as a cover (not illustrated) to prevent the ingress of water or contaminants into such a lock. In assembly, the bolts 328 (FIGS. 3A and 3C) may pass through the hitch drop plate 232 and further screw through the hitch coupler 324 (FIGS. 3A and 3B) and against the brace plate 322 (FIGS. 3A and 3B). In tightening the bolts 328 (FIGS. 3A and 3C), vibrations or like undesirable movements may be eliminated or dampened from the mounting element 220 and may rigidly couple to the vehicle 280 and the vehicle-mounting device 210 (FIGS. 2A-2D). Likewise, one or more shock isolation elements (e.g., rubber, polyurethane foam, or other cushioning materials and/or other shock isolation element such as shocks, springs, and the like to isolate shock and dampen vibrations) may be included in one or more locations throughout a vehicle-mounting device embodiment to dampen unwanted vibrations and other movements (e.g., the dampening pad 248 of FIGS. 2A, 2B, and 2C and the shock isolation elements 282, 284, 286, and 288 of FIG. 2D). In other embodiments in keeping with the disclosure, a mounting element of a vehicle-mounting device may couple to a vehicle in various ways. For instance, in other vehicle-mounting device embodiments the mounting element may instead couple to a ball hitch, secure to a tailgate or trunk door, and/or other mounting apparatus or technique for coupling a vehicle-mounting device to a vehicle.

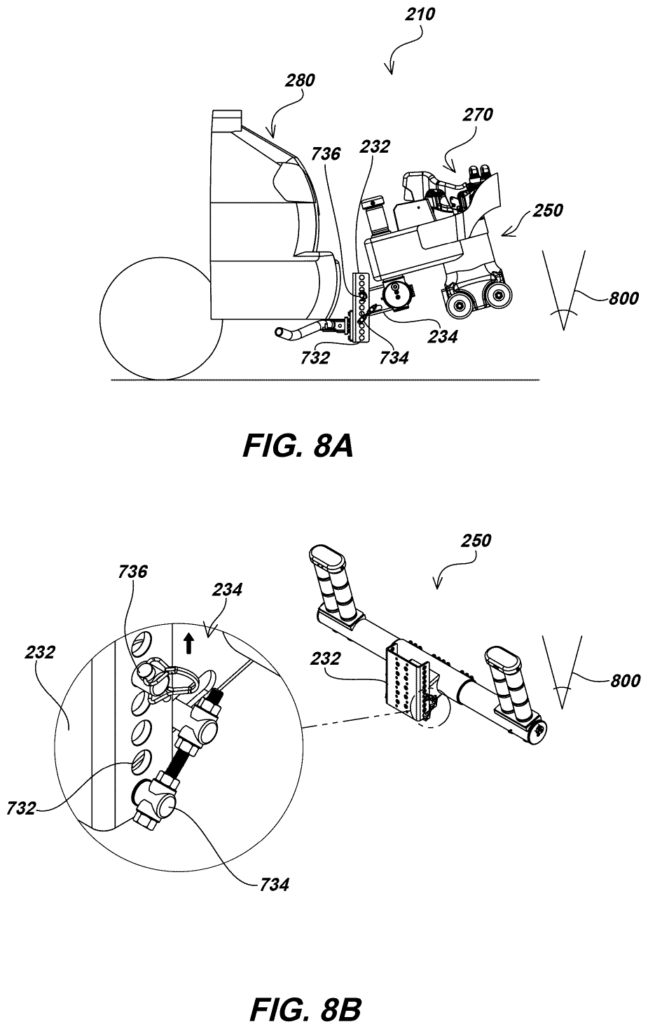

Referring again to FIGS. 2A, 2B, and 2C, the vehicle-mounting device 210 may further include a support assembly 230 including the hitch drop plate 232 (FIGS. 2A and 2B) that may secure onto the brace plate 322 (FIG. 3A) of the mounting element 220 (obscured from view in FIG. 2B). The support assembly 230 may further include a center support 234 that may couple with the hitch drop plate 232 (FIGS. 2A and 2B) and position a support arm 236 out away from the vehicle 280. As illustrated in FIGS. 2A and 2B, the support arm 236 may be horizontal in orientation coupled to the center support 234 via one or more fasteners 238 (FIGS. 2B and 2C). The support arm 236 may have a pair of masts 240 spaced apart along the width of the vehicle 280. Each of the masts 240 may have a length 241 (FIG. 2C) that is substantially vertical in orientation. It should be noted that the masts 240, though substantially vertical in orientation, may be made to tilt at a tilt angle (e.g., the tilt angle 800 of FIGS. 8A and 8B) defined as the angle relative to an upright vertical position.

The vehicle-mounting device 210 may further include one or more locator pod assemblies 250 that each may hold a utility locator device 270. The utility locator devices 270 may be or share aspects with the devices disclosed in U.S. Pat. No. 7,332,901, issued Feb. 19, 2008, entitled LOCATOR WITH APPARENT DEPTH INDICATION; U.S. Pat. No. 8,264,226, issued Sep. 11, 2012, entitled SYSTEM AND METHOD FOR LOCATING BURIED PIPES AND CABLES WITH A MAN PORTABLE LOCATOR AND A TRANSMITTER IN A MESH NETWORK; U.S. Pat. No. 9,057,754, issued Jun. 16, 2015, entitled ECONOMICAL MAGNETIC LOCATOR APPARATUS AND METHOD; U.S. Pat. No. 9,435,907, issued Sep. 6, 2016, entitled PHASE SYNCHRONIZED BURIED OBJECT LOCATOR APPARATUS, SYSTEMS, AND METHODS; U.S. patent application Ser. No. 15/250,666, filed Mar. 27, 2018, entitled PHASE-SYNCHRONIZED BURIED OBJECT TRANSMITTER AND LOCATOR METHODS AND APPARATUS; U.S. Pat. No. 10,162,074, issued Dec. 25, 2018, entitled UTILITY LOCATORS WITH RETRACTABLE SUPPORT STRUCTURES AND APPLICATIONS THEREOF; U.S. patent application Ser. No. 16/833,426, filed Mar. 27, 2020, entitled LOW COST, HIGH PERFORMANCE SIGNAL PROCESSING IN A MAGNETIC-FIELD SENSING BURIED UTILITY LOCATOR SYSTEM; U.S. Pat. No. 10,670,766, issued Jun. 2, 2020, entitled UTILITY LOCATING SYSTEMS, DEVICES, AND METHODS USING RADIO BROADCAST SIGNALS; U.S. Pat. No. 10,690,795, issued Jun. 23, 2020, entitled LOCATING DEVICES, SYSTEMS, AND METHODS USING FREQUENCY SUITES FOR UTILITY DETECTION; and U.S. Pat. No. 10,809,408, issued Oct. 20, 2020, entitled DUAL SENSED LOCATING SYSTEMS AND METHODS; U.S. Pat. No. D922,885, issued Jun. 22, 2021, entitled BURIED OBJECT LOCATOR; and/or others disclosed in the incorporated patents and applications. The content of each of these applications is incorporated by reference herein in its entirety.

In assembly, each of the locator pod assemblies 250 includes a series of pod mounting holes 252 dimensioned to key onto a pair of masts 240 such that when a locator pod assembly 250, holding a utility locator device 270, contacts the ground surface during use, the locator pod assembly 250 may slide up along the length 241 (FIG. 2C) of the associated masts 240.

The support assembly 230 may further include a retaining element 242 that may seat and secure to the top of the masts 240 to prevent the locator pod assemblies 250 from sliding off the top end. The retaining element 242 may include a cap 244 that seats on top of a pair of masts 240 and may be secured thereto via a pin 246. A dampening pad 248 may seat at the bottom the masts 240 cushioning the locator pod assembly 250 against the points of contact on the support arm 236. For instance, the impact of the locator pod assembly 250 may be dampened when the locator pod assembly 250 returns to sit along the bottom of the masts 240 via gravity after being pushed upward along the length 241 (FIG. 2C) of the masts 240. The dampening pad 248 may, for instance, be or include rubber, polyurethane foam, or other cushioning materials or shock isolation element. Such a shock isolation element may further include, but should not be limited to shocks, springs, and the like to isolate shock and dampen vibrations to various elements as a vehicle, such as the vehicle 280, moves a vehicle-mounting device and one or more utility locator devices, such as the vehicle-mounting device 210 and the utility locator devices 270, about the locate environment.

In various embodiments, such shock isolation elements may be included in a variety of locations throughout a vehicle-mounting device of the present invention such as the vehicle-mounting device 210. As illustrated in FIG. 2D, the vehicle-mounting device 210 may include a shock isolation element 282 on the wheels 256 of the locator pod assembly 250, a shock isolation element 284 on the axel of the wheels 256 of the locator pod assembly 250, a plurality of shock isolation element 286 in the locator pod assembly 250 cushioning the utility locator device 270 disposed inside, an additional shock isolation element 288 (e.g., shock absorbers, springs, and/or other materials or the like) seated at 4 the bottom the masts 240 cushioning the locator pod assembly 250 against the points of contact on the support arm 236 (e.g., shock, springs, additional shock isolating/dampening materials, and/or the like). It should be noted that such shock isolation elements may be disposed in various other locations throughout a vehicle-mounting device of the present disclosure.

In other embodiments, a vehicle-mounting device may include a different number of masts to accommodate a different number of locator pod assemblies and utility locator devices. In some embodiments, each locator pod assembly may key onto a single mast that may have a different shape. It should also be noted that there are various other mast configurations and designs that may be used to key a locator pod assembly onto a mast of other vehicle-mounting device embodiments.

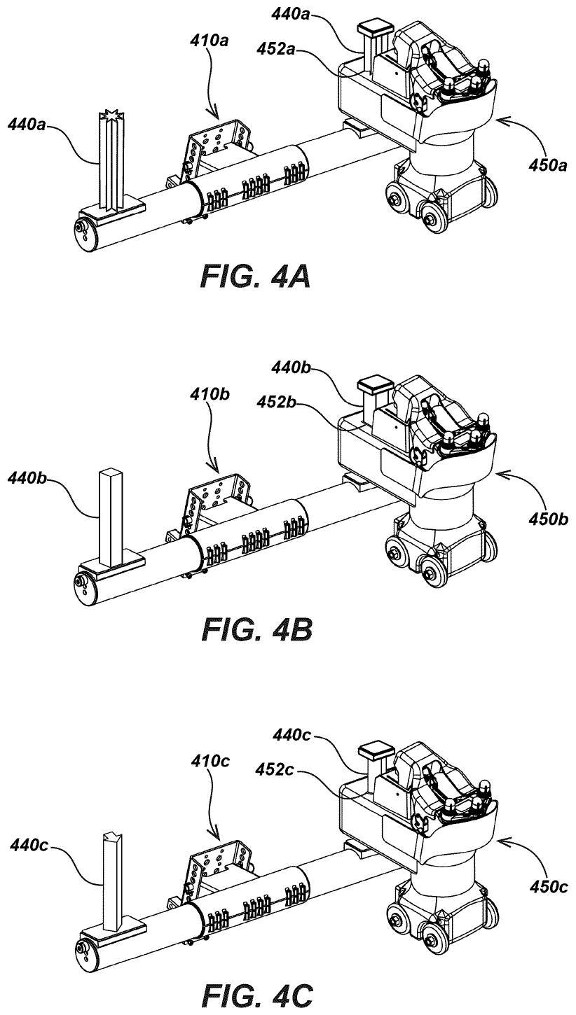

As illustrated in FIG. 4A-4C, a series of vehicle-mounting devices 410a, 410b, and 410c which may be the same as the vehicle-mounting devices 210 of FIGS. 2A, 2B, and 2C except having alternatively configured masts 440a, 440b, and 440c which may be used in a vehicle-mounting device of the present disclosure. It should be noted, there are myriad other mast designs/configurations that may be used in other vehicle-mounting devices embodiments.

As illustrated in FIG. 4A, one or more masts 440a disposed on the vehicle-mounting device 410a may have a star-shaped cross-section which may accommodate a similar include a like star-shaped pod mounting holes 452a on a locator pod assembly 450a. The locator pod assembly 450a may be or share aspects with the locator pod assembly 250 of FIGS. 2A, 2B, and 2C but with star-shaped pod mounting holes 452a to accommodate the star-shape of the masts 440a. Having a singular mast 440a with a star-shaped cross-section per locator pod assembly 450a may allow the locator pod assembly 450a to mount at different orientations on the vehicle-mounting device 410a while still sliding upwards along the mast 440a when contacting the ground.

As illustrated in FIG. 4B, one or more masts 440b disposed on the vehicle-mounting device 410b may have a diamond-shaped cross-section which may accommodate a similar include a like diamond-shaped pod mounting holes 452b on a locator pod assembly 450b. The locator pod assembly 450b may be or share aspects with the locator pod assembly 250 of FIGS. 2A, 2B, and 2C but with diamond-shaped pod mounting holes 452b to accommodate the diamond-shape of the masts 440b. Having a singular mast 440b per locator pod assembly 450b may allow the locator pod assembly 450b to mount at different multiple orientations on the vehicle-mounting device 410b while still sliding upwards along the mast 440b when contacting the ground but fewer than the locator pod assembly 450a on masts 440a of the vehicle-mounting device 410a.

As illustrated in FIG. 4C, the one or more masts 440c disposed on the vehicle-mounting device 410c may have an arrow-shaped cross-section which may accommodate a similarly arrow-shaped pod mounting holes 452c on a locator pod assembly 450c. The locator pod assembly 450c may be or share aspects with the locator pod assembly 250 of FIGS. 2A, 2B, and 2C but with arrow-shaped pod mounting holes 452c to accommodate the arrow-shape of the masts 440c. Having a uniquely arrow-shaped mast 440c and pod mounting holes 452c may restrict the locator pod assembly 450c to mount in one predetermined orientation. The locator pod assembly 450c of the vehicle-mounting device 410c may still be permitted to slide upwards along the mast 440c when the locator pod assembly 450 contacts the ground. Various other mast configuration may be readily apparent to one familiar with the art allowing a locator pod assembly and associated utility locator device of the present invention to be mounted in various orientations or limited their possible mounting orientations.

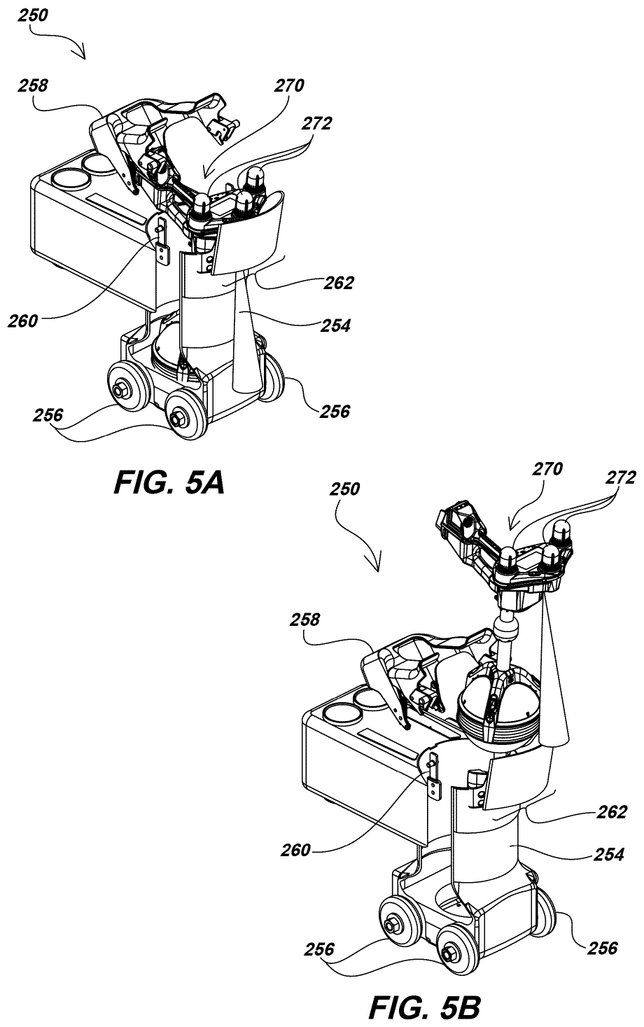

Turning to FIGS. 5A and 5B, a technician (not illustrated) may place the utility locator device 270 inside the shell element 254 of the locator pod assembly 250. The locator pod assembly 250 may include one or more wheels 256 such that the locator pod assembly 250 may glide along the ground surface when coming in contact. A lid 258 may be closed and be secured closed via latch 260 holding the utility locator device 270 inside the locator pod assembly. It should be noted that the lid 258 when closed does not obstruct GNSS antennas 272 on the utility locator device 270.

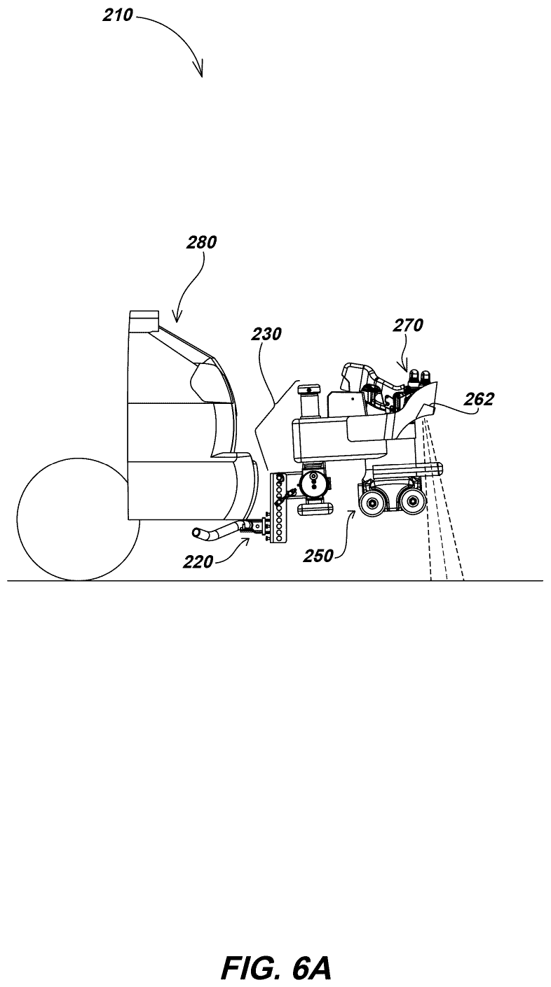

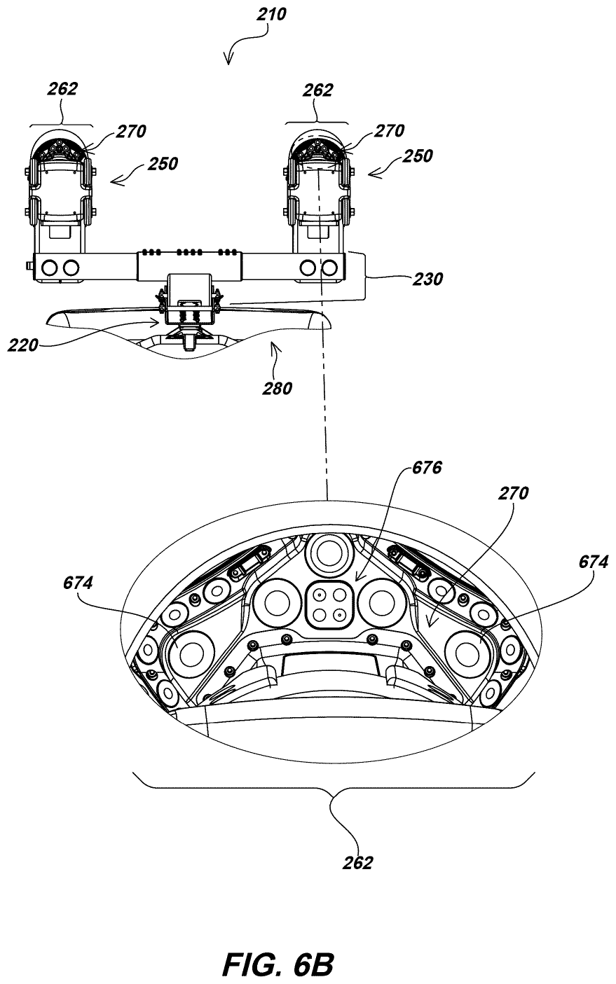

Further in FIGS. 6A and 6B, an opening 262 may permit sensors and apparatus to measure outside the locator pod assembly 250. The opening 262 may permit sensors and other apparatus of the enclosed utility locator device 270 to determine measurements or other functions outside the locator pod assembly 250. For instance, each utility locator device 270 may include one or more cameras 674 (FIG. 6B) for generating images of the ground surface as the vehicle is moved and/or one or more rangefinder devices 676 (FIG. 6B) for generating distance measurements to one or more spots on the ground surface. In other embodiments, such openings may be used to allow other measurements or like functions by other sensors and apparatus in a utility locator device. The rangefinder devices 676 (FIG. 6B) may be or share aspects with those disclosed in U.S. patent application Ser. No. 15/866,360, filed Jan. 9, 2018, entitled TRACKED DISTANCE MEASURING DEVICES, SYSTEMS, AND METHODS; U.S. patent application Ser. No. 16/241,864, filed Jan. 7, 2019, entitled TRACKED DISTANCE MEASURING DEVICES, SYSTEMS, AND METHODS; U.S. patent application Ser. No. 17/845,290, filed Jun. 21, 2022, entitled DAYLIGHT VISIBLE AND MULTI-SPECTRAL LASER RANGEFINDERS AND ASSOCIATED SYSTEMS AND METHODS AND UTILITY LOCATOR DEVICES; and/or like devices of the incorporated patents and applications.

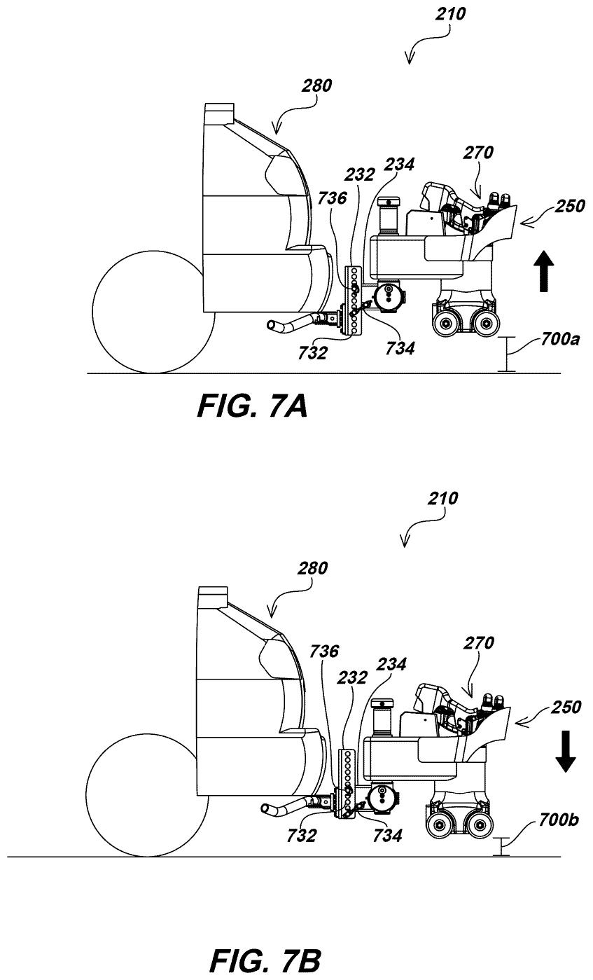

Turning to FIGS. 7A and 7B, the height settings 700a and 700b of the locator pod assemblies 250 and utility locator devices 270 in the vehicle-mounting device 210 may be manually adjusted by a technician (not illustrated). For instance, the positioning of a bracket 734 and a pin 736 coupling the center support 234 with a series of holes 732 formed along the hitch drop plate 232 may be adjusted to raise the height settings 700a (FIG. 7A) or lower the height settings 700b (FIG. 7B). Likewise, the height setting (e.g., the height setting 700a of FIG. 7A and the height setting 700b of FIG. 7B) may be changed by adjusting the position of the bolts 326 (FIG. 3A) of the hitch coupler 324 (FIG. 3A) relative to the hitch drop plate 232. In other embodiments, the height setting of the locator pod assemblies and utility locator devices in the vehicle-mounting device may be controlled through pneumatic, hydraulic, or electromagnetic mechanism. In some such embodiments, such as that disclosed with the method 1800 FIG. 18, the height setting may be determined and automatically set based on the topography of the approaching ground surface as the vehicle 280 is moved (e.g., as determined via LiDAR, rangefinders, other sensors, and/or mapped Topographical Data).

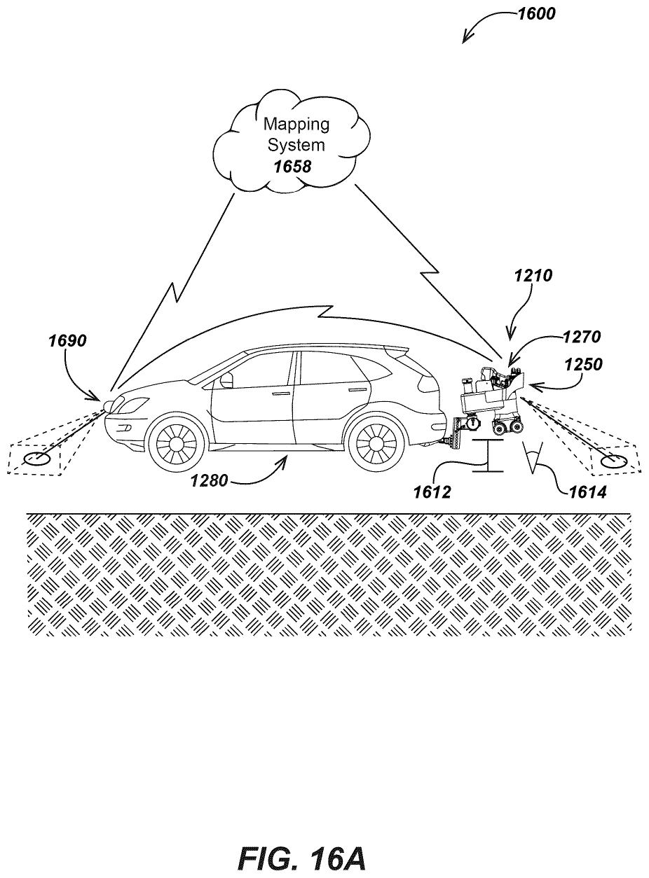

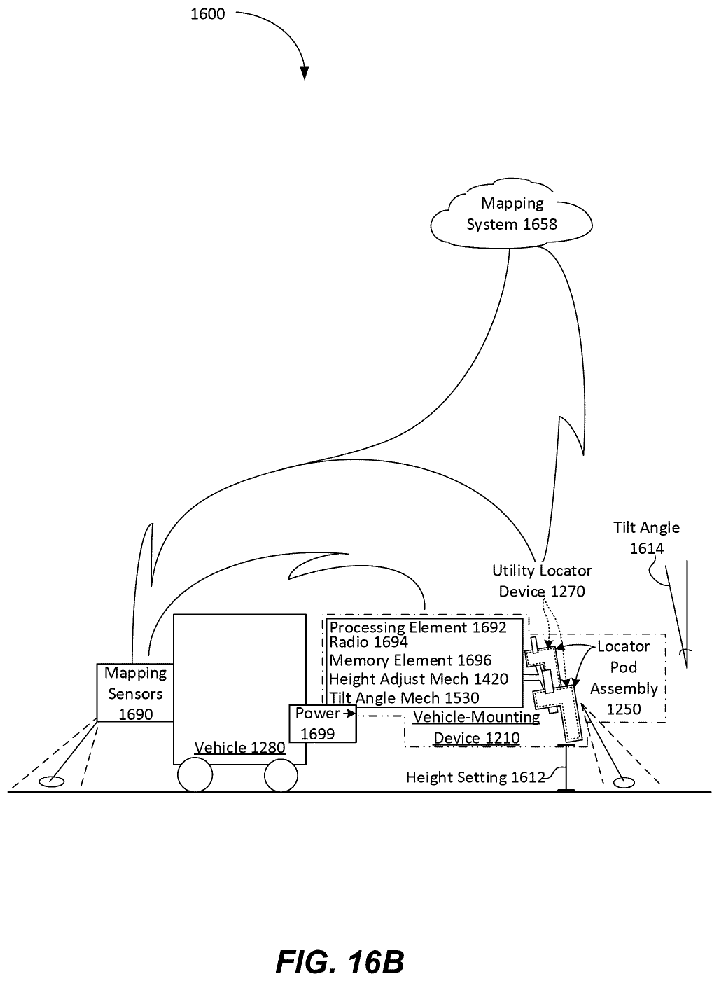

Turning to FIGS. 8A and 8B, a tilt angle 800 of the locator pod assemblies 250 (FIG. 8A) and utility locator devices 270 (FIG. 8A) in the vehicle-mounting device 210 (FIG. 8A) relative to a normal vertical orientation may also be manually adjusted by a technician. For instance, the pin 736 may be removed and reinserted in holes 732 higher in the hitch drop plate 232 relative to the bracket 734 allowing the center support 234 and indirectly connected locator pod assemblies 250 (FIG. 8A) and utility locator devices 270 (FIG. 8A) to tilt at the tilt angle 800. In other embodiments, the tilt angle of the locator pod assemblies and utility locator devices in the vehicle-mounting device may be controlled through pneumatic, hydraulic, or electromagnetic mechanism. In some such embodiments, such as that disclosed with the FIGS. 16A and 16B, the tilt angle may be determined based on the slope or other topography of the ground surface (e.g., as determined via LiDAR, rangefinders, other sensors, and/or mapped Topographical Data).

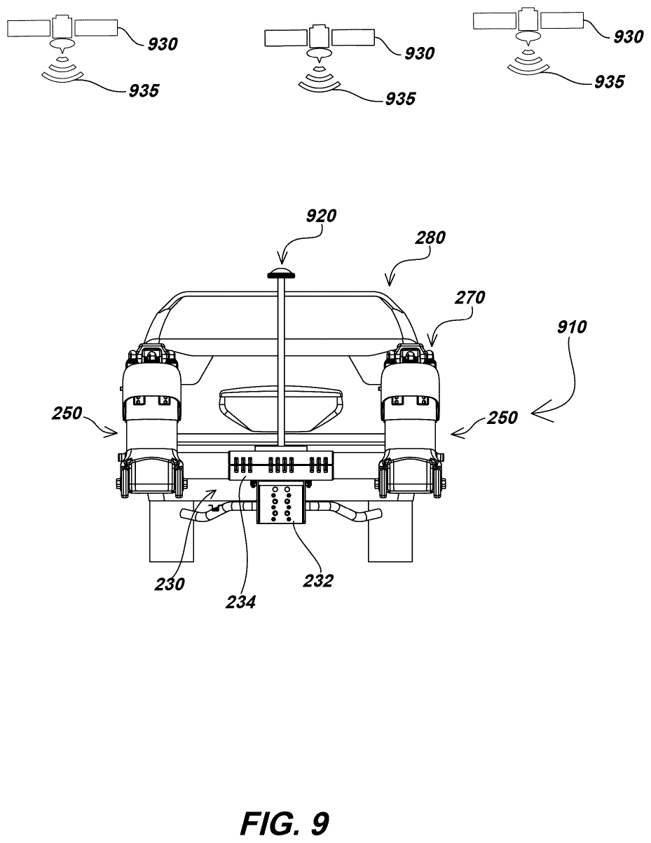

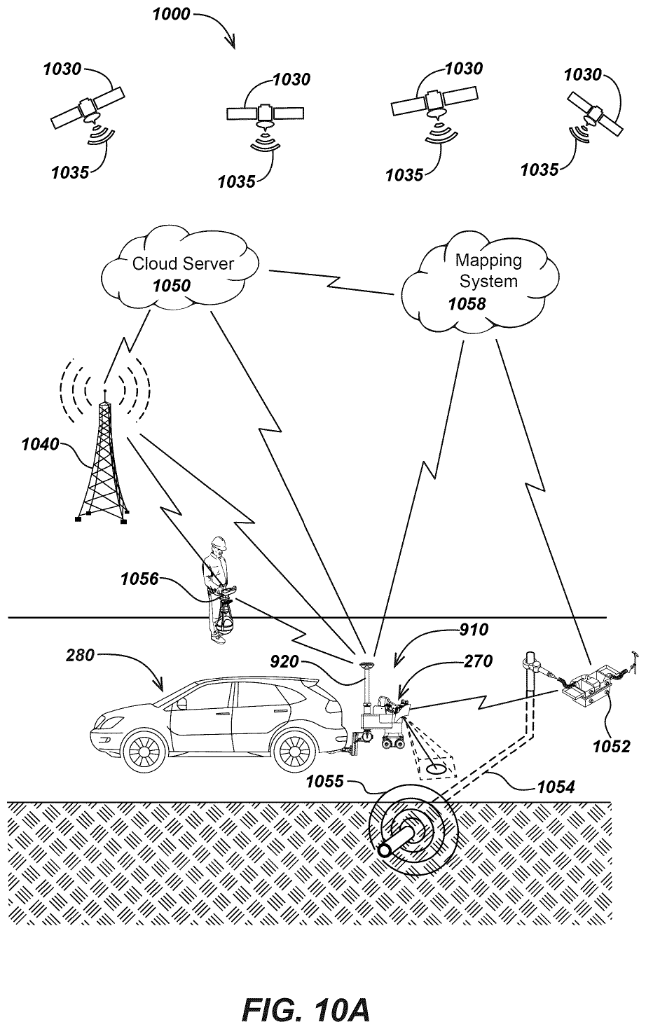

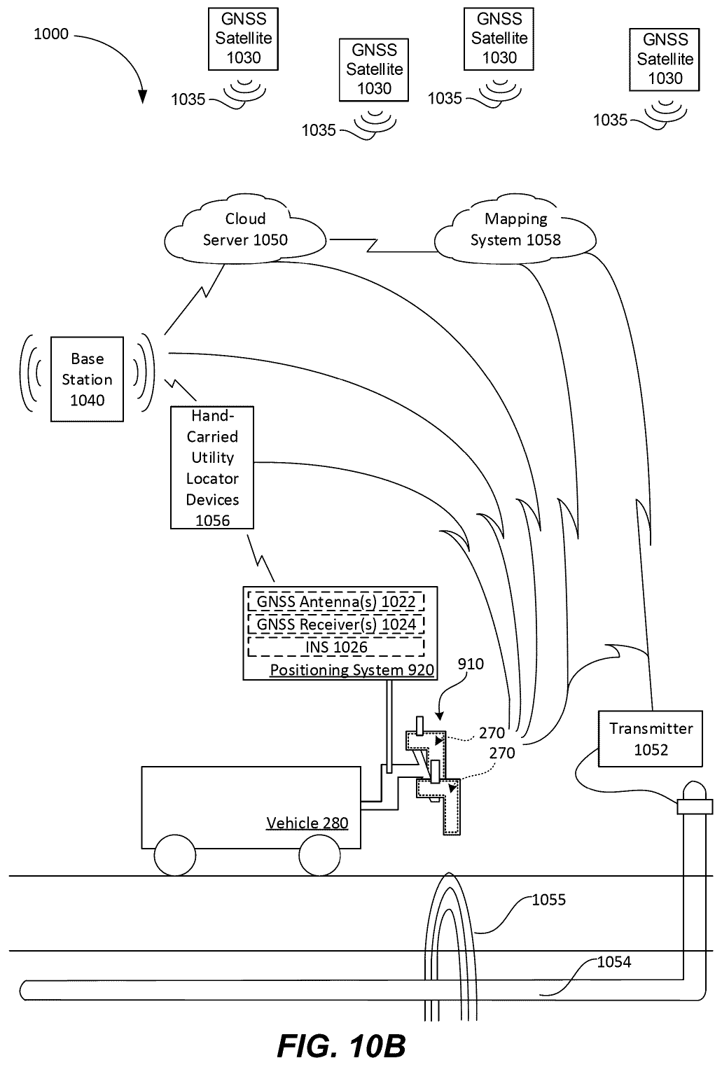

Turning to FIG. 9, a vehicle-mounting device 910 is illustrated which is the same as the vehicle-mounting device 210 of FIGS. 2A, 2B, and 2C with the addition of a positioning system 920. The positioning system 920 may include one or more sensors and apparatus for determining position in the world frame. For instance, the positioning system 920 may include one or more global navigation satellite systems (GNSS) antennas and receivers (e.g., the GNSS antennas 1022 and GNSS receivers 1024 of FIG. 10B) to provide, or aid in providing, geolocation data describing geolocation positions in the world frame via signals 935 from a plurality of a navigation satellites 930 and, optionally, terrestrial base stations (e.g., the base station 1044 of FIGS. 10A and 10B). Such GNSS sensors and antennas may be or include global positioning system (GPS), global navigation satellite system (GLONASS), BeiDou (BDS), Quasi-Zenith Satellite Systems (QZSS), and Galileo and further include precise point positioning real time kinematics (PPP-RTK), state space representation (SSR), and/or other like corrections. Likewise, determination of such geolocation data may include the use of one or more inertial navigation systems (INS) (e.g., the INS 1026 of FIG. 10B), ground tracking apparatus, rangefinders, and the like (not illustrated). In some embodiments, geolocation positions may be determined instead or additionally via GNSS and other positions sensors disposed in attached utility locator devices. In other embodiments, other positioning systems may include various other systems and sensors for determining position in the world frame.

A vehicle-mounting device of the present invention may be used in a vehicle-based locating system. Turning to FIGS. 10A and 10B, a vehicle-based locating system 1000 is illustrated that includes the vehicle-mounting device 910 of FIG. 9 mounting the utility locator devices 270 to the vehicle 280. Optionally, vehicle-based locating system 1000 may further include the positioning system 920. The positioning system 920 may include one or more sensors and apparatus for determining position in the world frame. For instance, the positioning system 920 may include one or more GNSS antennas 1022 (FIG. 10B) and GNSS receivers 1024 (FIG. 10B) to provide, or aid in providing, geolocation data describing geolocation positions in the world frame via signals 1035 from a plurality of a navigation satellites 1030 and, optionally, a terrestrial base stations 1040. Such GNSS sensors and antennas may be or include global positioning system (GPS), global navigation satellite system (GLONASS), BeiDou (BDS), Quasi-Zenith Satellite Systems (QZSS), and Galileo and further include precise point positioning real time kinematics (PPP-RTK), state space representation (SSR), and/or other like corrections. Likewise, determination of such geolocation data may include data generated via an INS 1026 (FIG. 10B), ground tracking apparatus, rangefinders, and the like (not illustrated). In some embodiments, geolocation positions may be determined instead or additionally via GNSS and other positions sensors disposed in attached utility locator devices 270.

The utility locator devices 270 mounted in the vehicle-mounting device 910 may include one or more antennas and associated receiver circuitry to measure electromagnetic signals 1055 emitted from one or more utility lines, such as a utility line 1054, to determine locations and depths. The electromagnetic signals 1055 may include both passive and active signals measured across a range of frequencies, measurements of phase, signal strength, signal shape, current direction, changes in such measurements over time, and the like. The determined utility line location and depths, such as the utility line 1054, may be correlated with geolocations in world frame, such as those determined via positioning system 920 and/or positioning sensors/systems in the utility locator devices 270, to map utility lines. For instance, the utility locator devices 270 may determine gradients from tensor derivatives of magnetic field vectors of the magnetic signals 1055 at various intervals as the vehicle 280 moves along the path of the utility line 1054 or a plurality of utility lines in some scenarios. The presence or absence of utility lines, such as the utility line 1054, as well as the positions, orientations, and depths of utility lines may be determined via the gradient tensors and/or tensor components thereof. Additional details regarding methods used to determine utility line positions from electromagnetic signals may be include those methods disclosed in U.S. Pat. No. 7,332,901, issued Feb. 19, 2008, entitled LOCATOR WITH APPARENT DEPTH INDICATION; U.S. Pat. No. 8,264,226, issued Sep. 11, 2012, entitled SYSTEM AND METHOD FOR LOCATING BURIED PIPES AND CABLES WITH A MAN PORTABLE LOCATOR AND A TRANSMITTER IN A MESH NETWORK; U.S. Pat. No. 9,057,754, issued Jun. 16, 2015, entitled ECONOMICAL MAGNETIC LOCATOR APPARATUS AND METHOD; U.S. Pat. No. 9,435,907, issued Sep. 6, 2016, entitled PHASE SYNCHRONIZED BURIED OBJECT LOCATOR APPARATUS, SYSTEMS, AND METHODS; U.S. patent application Ser. No. 15/250,666, filed Mar. 27, 2018, entitled PHASE-SYNCHRONIZED BURIED OBJECT TRANSMITTER AND LOCATOR METHODS AND APPARATUS; U.S. Pat. No. 10,162,074, issued Dec. 25, 2018, entitled UTILITY LOCATORS WITH RETRACTABLE SUPPORT STRUCTURES AND APPLICATIONS THEREOF; U.S. patent application Ser. No. 16/833,426, filed Mar. 27, 2020, entitled LOW COST, HIGH PERFORMANCE SIGNAL PROCESSING IN A MAGNETIC-FIELD SENSING BURIED UTILITY LOCATOR SYSTEM; U.S. Pat. No. 10,670,766, issued Jun. 2, 2020, entitled UTILITY LOCATING SYSTEMS, DEVICES, AND METHODS USING RADIO BROADCAST SIGNALS; U.S. Pat. No. 10,690,795, issued Jun. 23, 2020, entitled LOCATING DEVICES, SYSTEMS, AND METHODS USING FREQUENCY SUITES FOR UTILITY DETECTION; and U.S. Pat. No. 10,809,408, issued Oct. 20, 2020, entitled DUAL SENSED LOCATING SYSTEMS AND METHODS; U.S. Pat. No. D922,885, issued Jun. 22, 2021, entitled BURIED OBJECT LOCATOR; and/or others disclosed in the incorporated patents and applications. The content of each of these applications is incorporated by reference herein in its entirety.

The vehicle-based locating system 1000 may further include one or more remotely connected cloud servers 1050, base stations 1040 for sharing other data, transmitter devices 1052 for coupling signal onto utility lines 1054, hand-carried utility locators 1056, mapping systems 1058, and the like. As illustrated, the various devices of the vehicle-based locating system 1000 may be wirelessly connected for exchanging data (e.g., via one or more radios or the like). The transmitter 1052 may be or share aspects with those disclosed in U.S. Pat. No. 9,891,337, issued Feb. 13, 2018, entitled UTILITY LOCATOR TRANSMITTER DEVICES, SYSTEMS, AND METHODS WITH DOCKABLE APPARATUS; U.S. Pat. No. 9,927,546, issued Mar. 27, 2018, entitled PHASE-SYNCHRONIZED BURIED OBJECT TRANSMITTER AND LOCATOR METHODS AND APPARATUS; U.S. patent application Ser. No. 17/528,956, filed Nov. 17, 2021, entitled SIGNAL TRANSMITTER CONNECTION PORT FOR WIRELESS INSPECTION AND LOCATING SYSTEM; and/or like devices of the incorporated patents and applications.

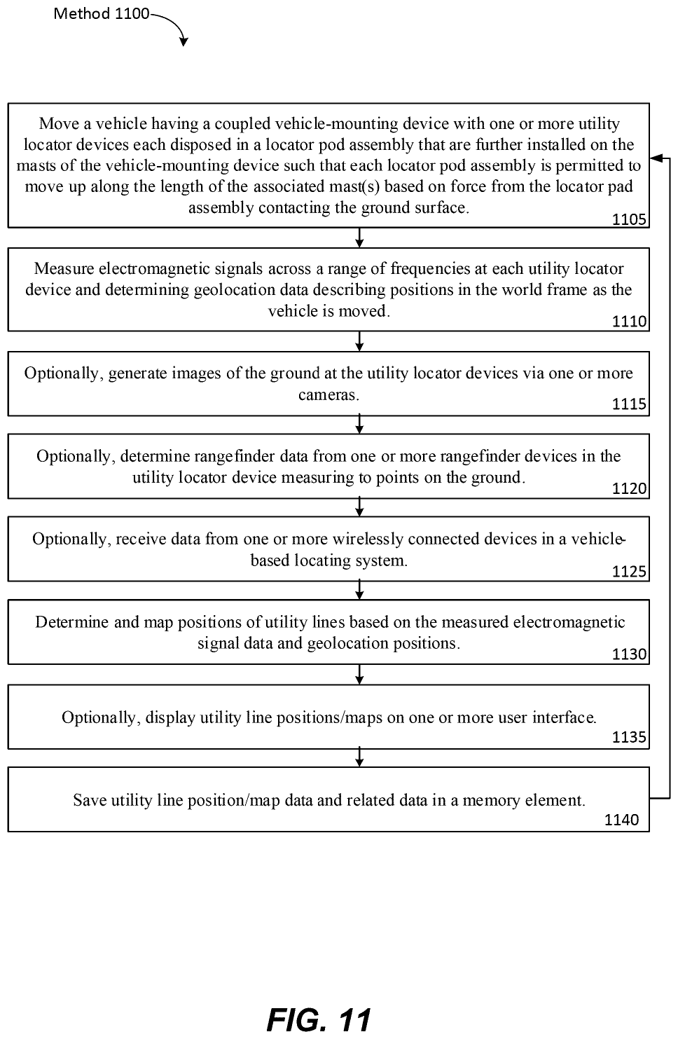

Turning to FIG. 11, a method 1100 for utility locating using one or more utility locator devices disposed in a vehicle-mounting device is disclosed. In a step 1105, the method 1100 may include moving a vehicle having a coupled vehicle-mounting device with one or more utility locator devices each disposed in a locator pod assembly that are further installed on the masts of the vehicle-mounting device such that each locator pod assembly is permitted to move up along the length of the associated mast(s) based on force from the locator pod assembly contacting the ground surface. The method 1100 may further include a step 1110 measuring electromagnetic signals across a range of frequencies at each utility locator device and determining geolocation data describing positions in the world frame as the vehicle is moved. In an optional step 1115, the method may include capturing images of the ground at the utility locator devices. In another optional step 1120, the method 1100 may include determining rangefinder data from one or more rangefinder devices in the utility locator devices. In another optional step 1125, the method 1100 may include receiving data from one or more wirelessly connected devices in a vehicle-based locating system (e.g., the various devices of the vehicle-based locating system 1000 in FIG. 10). The method 1100 may further include a step 1130 determining and mapping positions of utility lines based on the measured electromagnetic signal data and geolocation positions. For instance, gradients of tensor derivatives of magnetic field vectors of the measured magnetic signals at various intervals as the vehicle moves in the environment relative to the one or more utility lines may be calculated. Coupled the corresponding geospatial data regarding the location of the utility locator devices in the world frame with the gradients of tensor derivates and/or the tensor components thereof may be used to map utility line positions. Calculations and methods used to determine utility line positions from electromagnetic data may be or include those methods disclosed in U.S. Pat. No. 7,332,901, issued Feb. 19, 2008, entitled LOCATOR WITH APPARENT DEPTH INDICATION; U.S. Pat. No. 8,264,226, issued Sep. 11, 2012, entitled SYSTEM AND METHOD FOR LOCATING BURIED PIPES AND CABLES WITH A MAN PORTABLE LOCATOR AND A TRANSMITTER IN A MESH NETWORK; U.S. Pat. No. 9,057,754, issued Jun. 16, 2015, entitled ECONOMICAL MAGNETIC LOCATOR APPARATUS AND METHOD; U.S. Pat. No. 9,435,907, issued Sep. 6, 2016, entitled PHASE SYNCHRONIZED BURIED OBJECT LOCATOR APPARATUS, SYSTEMS, AND METHODS; U.S. patent application Ser. No. 15/250,666, filed Mar. 27, 2018, entitled PHASE-SYNCHRONIZED BURIED OBJECT TRANSMITTER AND LOCATOR METHODS AND APPARATUS; U.S. Pat. No. 10,162,074, issued Dec. 25, 2018, entitled UTILITY LOCATORS WITH RETRACTABLE SUPPORT STRUCTURES AND APPLICATIONS THEREOF; U.S. patent application Ser. No. 16/833,426, filed Mar. 27, 2020, entitled LOW COST, HIGH PERFORMANCE SIGNAL PROCESSING IN A MAGNETIC-FIELD SENSING BURIED UTILITY LOCATOR SYSTEM; U.S. Pat. No. 10,670,766, issued Jun. 2, 2020, entitled UTILITY LOCATING SYSTEMS, DEVICES, AND METHODS USING RADIO BROADCAST SIGNALS; U.S. Pat. No. 10,690,795, issued Jun. 23, 2020, entitled LOCATING DEVICES, SYSTEMS, AND METHODS USING FREQUENCY SUITES FOR UTILITY DETECTION; and U.S. Pat. No. 10,809,408, issued Oct. 20, 2020, entitled DUAL SENSED LOCATING SYSTEMS AND METHODS; U.S. Pat. No. D922,885, issued Jun. 22, 2021, entitled BURIED OBJECT LOCATOR; and/or others disclosed in the incorporated patents and applications. The content of each of these applications is incorporated by reference herein in its entirety.

In a step 1135, the method 1100 may include displaying utility line positions/maps and related data to one or more user interfaces. For instance, utility maps, system and device settings, controls for devices, and the like may be communicated to a user interface display on a vehicle (e.g., the vehicle 280 of FIGS. 2A, 2B, and 2C), user interface devices (e.g., the user interface device 270 of FIGS. 2A, 2B, and 2C or the hand-carried user interface device 1056 of FIG. 10A), one or more laptops, smartphones, and other computing devices, and the like. In a step 1140, the method 1100 may include storing utility line positions/maps and related data to a memory element having one or more non-transitory memories. Such a memory element may be disposed in the utility locator devices (e.g., the user interface device 270 of FIGS. 2A, 2B, and 2C) and/or one or more wirelessly connected devices (e.g., the cloud server 1050 of FIGS. 10A and 10B, the mapping system 1058 of FIGS. 10A and 10B, the base station 1040 of FIGS. 10A and 10B, the hand-carried utility locator device 1056 or transmitter 1052 of FIGS. 10A and 10B, and the like). Likewise, such a memory element may be disposed in one or more laptops, smartphones, and other computing devices, and the like.

In some embodiments, the height setting and/or tilt angles of locator pod assemblies and utility locator devices may be automatically adjusted. For instance, a technician may activate an electromechanical, pneumatic, hydraulic, or like mechanism to set the height setting of the locator pod assembly and/or set the tilt angle of the locator pod assemblies and associated utility locator devices relative to the ground surface. In some such embodiments, the height settings and/or tilt angles may be automatically set based on Topographical Data of the ground surface determined via one or more sensors and systems (e.g., one or more rangefinder devices, LiDAR, cameras, and historically mapped Topographical Data, and other sensors/apparatus and the like).

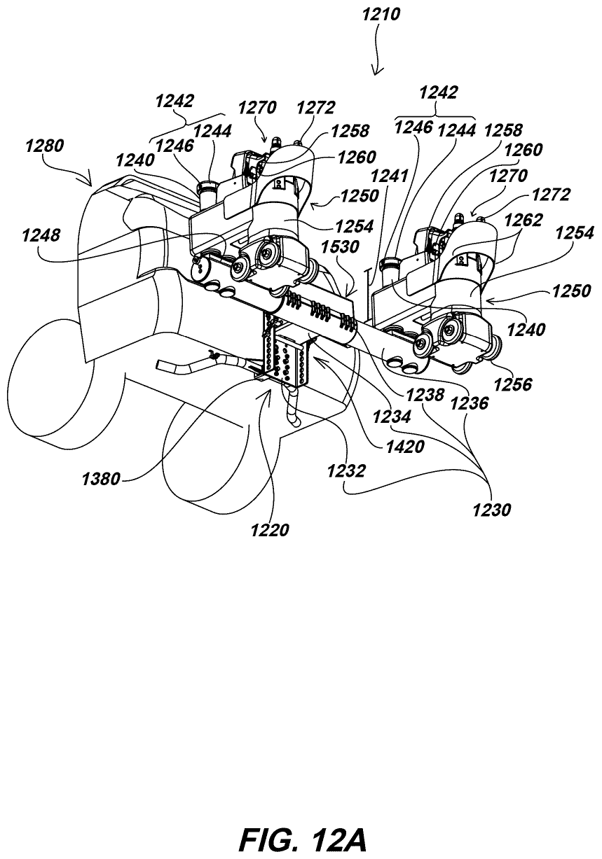

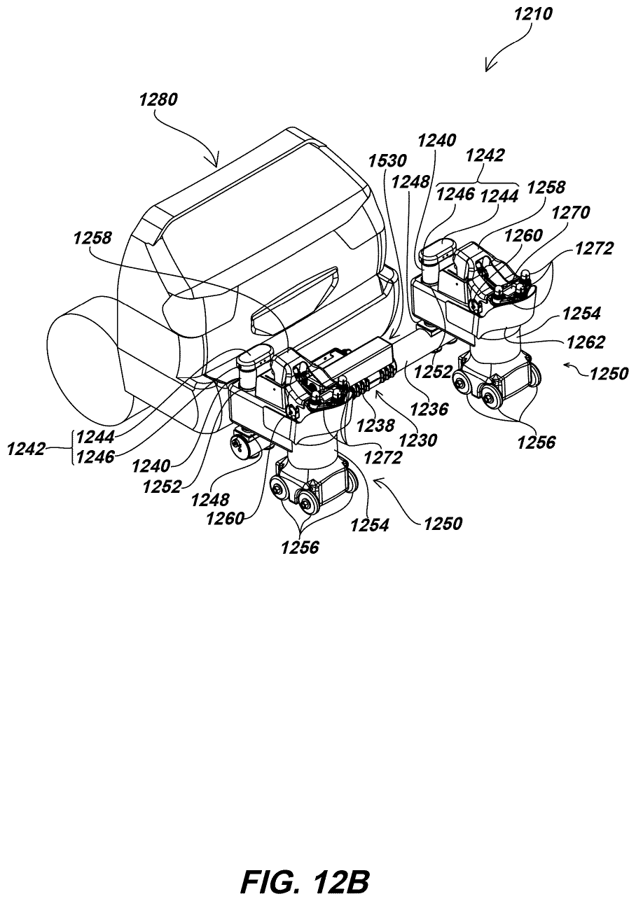

Turning to FIGS. 12A and 12B, a vehicle-mounting device 1210 for mounting one or more utility locator devices 1270 to a vehicle 1210 is illustrated which may include mechanisms for automatically adjusting height settings and/or setting the tilt angle of one or more locator pod assemblies 1250 and associated utility locator devices 1270 relative to an upright vertical position.

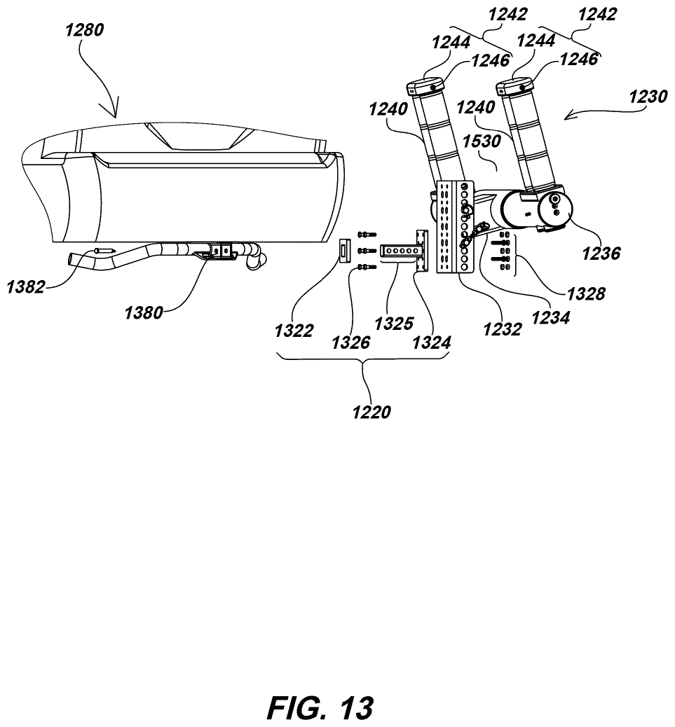

Turning to FIG. 13, a mounting element 1220 may include a brace plate 1322 and a hitch coupler 1324 for coupling to a standard, commercially available hitch receiver 1380 pre-installed on the vehicle 1280. The hitch coupler 1324 may mount to a hitch drop plate 1232 on a support assembly 1230 via one or more bolts 1326. Further, the brace plate 1322 may couple to the hitch drop plate 1232 via one or more bolts 1328 with the hitch coupler 1324 wedged between the brace plate 1322 and the hitch drop plate 1232. A forward portion 1325 of the hitch coupler 1324 may fit through an opening through the brace plate 1322, fit into the hitch receiver 1380, and couple thereto via a pin 1382. In other embodiments in keeping with the disclosure, a mounting element of a vehicle-mounting device may couple to a vehicle in various different ways. For instance, in other vehicle-mounting device embodiments the mounting element may instead couple to a ball hitch, secure to a tailgate or trunk door, and/or other mounting apparatus or technique for coupling a vehicle-mounting device to a vehicle.

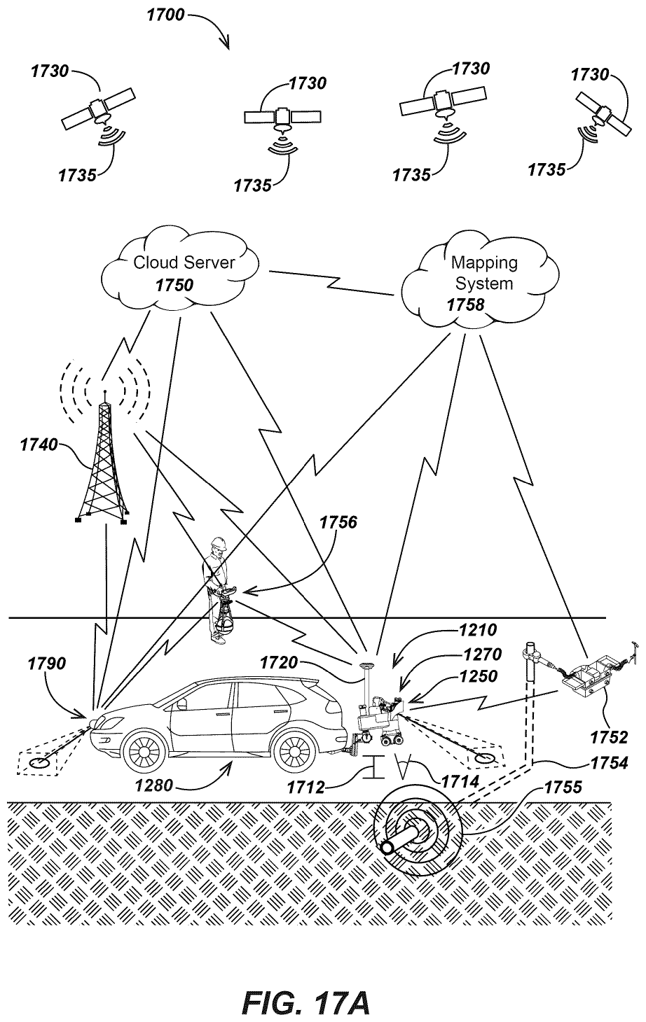

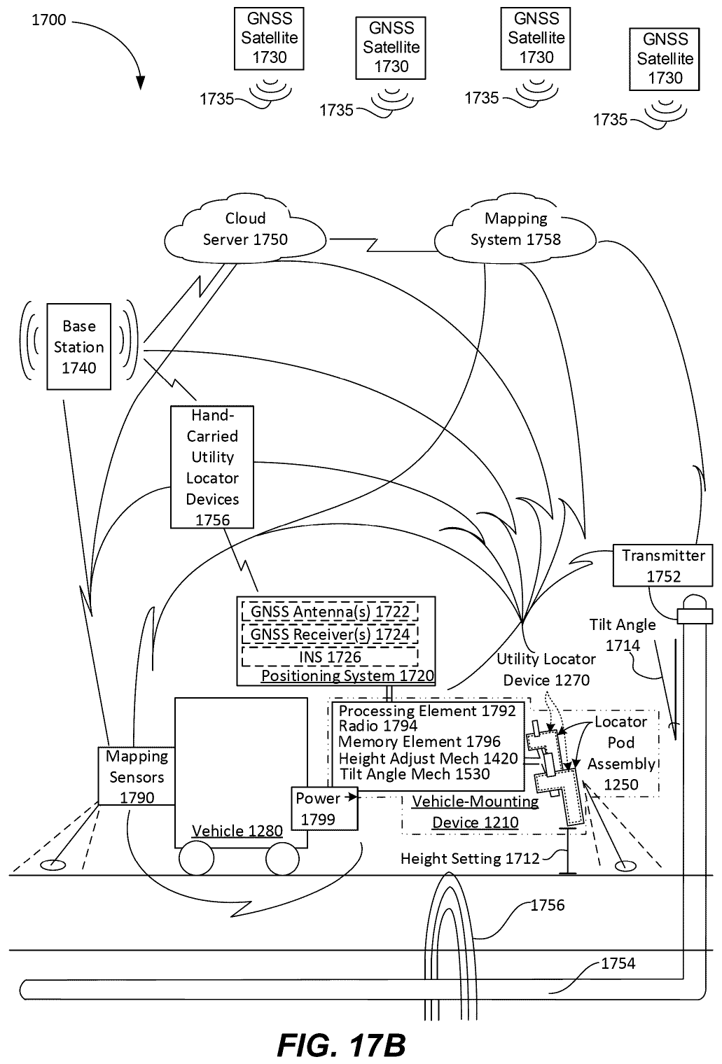

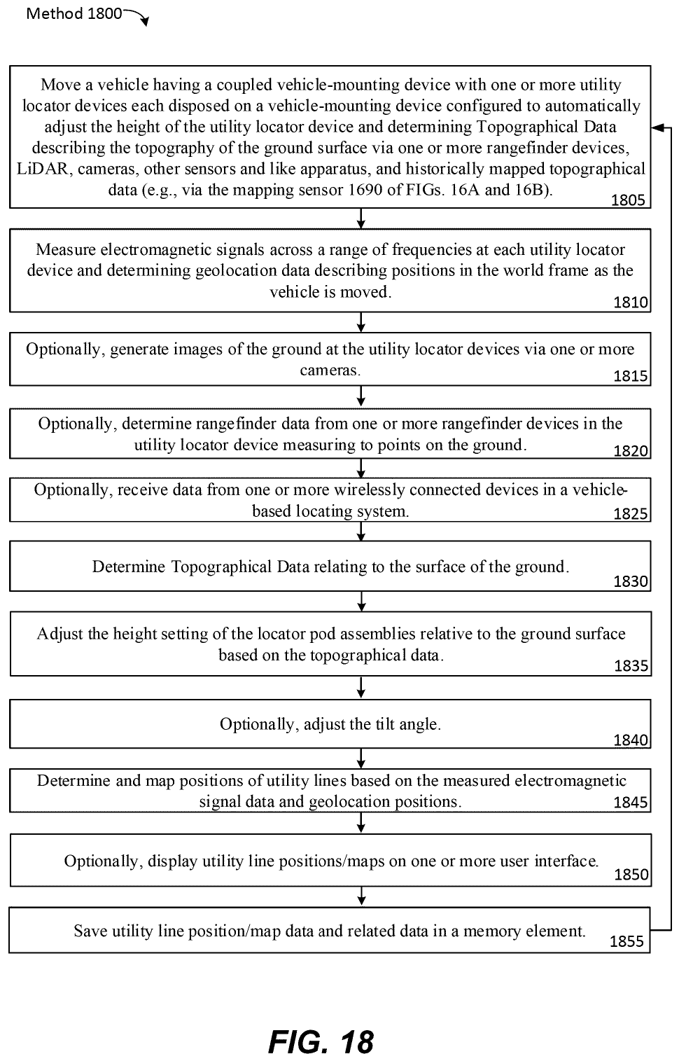

Referring again to FIGS. 12A and 12B, the vehicle-mounting device 1210 may further include a support assembly 1230 including the hitch drop plate 1232 (FIG. 12A) that may secure onto the brace plate 1322 (FIG. 13) of the mounting element 1220 (FIG. 12A). The support assembly 1230 may further include a center support 1234 (FIG. 12A) that may couple with the hitch drop plate 1232 (FIG. 12A) and position a support arm 1236 out away from the vehicle 1280. The support arm 1236 may be horizontal in orientation coupled to the center support 1234 (FIG. 12A) via one or more fasteners 1238. The support arm 1236 may have a pair of masts 1240 spaced apart along the width of the vehicle 1280. Each of the masts 1240 may have a length 1241 that is substantially vertical in orientation. It should be noted that the masts 1240, though substantially vertical in orientation, may be made to tilt at a tilt angle (e.g., the tilt angle 1614 of FIGS. 16A and 16B and the tilt angle 1714 of FIGS. 17A and 17B) defined as an angle measurement relative to an upright vertical position.

The vehicle-mounting device 1210 may further include one or more locator pod assemblies 1250 that each may hold a utility locator device 1270. The utility locator devices 1270 may be or share aspects with the devices disclosed in U.S. Pat. No. 7,332,901, issued Feb. 19, 2008, entitled LOCATOR WITH APPARENT DEPTH INDICATION; U.S. Pat. No. 8,264,226, issued Sep. 11, 2012, entitled SYSTEM AND METHOD FOR LOCATING BURIED PIPES AND CABLES WITH A MAN PORTABLE LOCATOR AND A TRANSMITTER IN A MESH NETWORK; U.S. Pat. No. 9,057,754, issued Jun. 16, 2015, entitled ECONOMICAL MAGNETIC LOCATOR APPARATUS AND METHOD; U.S. Pat. No. 9,435,907, issued Sep. 6, 2016, entitled PHASE SYNCHRONIZED BURIED OBJECT LOCATOR APPARATUS, SYSTEMS, AND METHODS; U.S. patent application Ser. No. 15/250,666, filed Mar. 27, 2018, entitled PHASE-SYNCHRONIZED BURIED OBJECT TRANSMITTER AND LOCATOR METHODS AND APPARATUS; U.S. Pat. No. 10,162,074, issued Dec. 25, 2018, entitled UTILITY LOCATORS WITH RETRACTABLE SUPPORT STRUCTURES AND APPLICATIONS THEREOF; U.S. patent application Ser. No. 16/833,426, filed Mar. 27, 2020, entitled LOW COST, HIGH PERFORMANCE SIGNAL PROCESSING IN A MAGNETIC-FIELD SENSING BURIED UTILITY LOCATOR SYSTEM; U.S. Pat. No. 10,670,766, issued Jun. 2, 2020, entitled UTILITY LOCATING SYSTEMS, DEVICES, AND METHODS USING RADIO BROADCAST SIGNALS; U.S. Pat. No. 10,690,795, issued Jun. 23, 2020, entitled LOCATING DEVICES, SYSTEMS, AND METHODS USING FREQUENCY SUITES FOR UTILITY DETECTION; and U.S. Pat. No. 10,809,408, issued Oct. 20, 2020, entitled DUAL SENSED LOCATING SYSTEMS AND METHODS; U.S. Pat. No. D922,885, issued Jun. 22, 2021, entitled BURIED OBJECT LOCATOR; and/or others disclosed in the incorporated patents and applications. The content of each of these applications is incorporated by reference herein in its entirety.

Each of the locator pod assemblies 1250 may include one or more pod mounting holes 1252 (FIG. 12B) that may key onto a pair of masts 1240 such that when a locator pod assembly 1250 contacts the ground surface during use, the locator pod assembly 1250 may slide up along the length of the associated masts 1240. A retaining element 1242 may seat and secure to the top of the masts 1240 to prevent the locator pod assemblies 1250 from sliding off the top end of the masts 1240. The retaining element 1242 may include a cap 1244 that seats about a pair of masts 1240 and may be secured thereto via a pin 1246. Likewise, a dampening pad 1248 may seat at the bottom the masts 1240 cushioning the locator pod assembly 1250 against the point of contact on the support arm 1236. For instance, the impact of the locator pod assembly 1250 may be dampened when the locator pod assembly 1250 returns to sit along the bottom of the masts 1240 via gravity after being pushed upward along the length of the masts 1240. The dampening pad 1248 may, for instance, be or include rubber, polyurethane foam, or other cushioning material.

In other embodiments, a vehicle-mounting device may include a different number of masts to accommodate a different number of locator pod assemblies and utility locator devices. In some embodiments, each locator pod assembly may key onto a single mast that may have a different shape (such as such as the pod mounting holes 452a, pod mounting holes 452b, and pod mounting holes 452c of the locator pod assemblies 450a, 450b, and 450c and the matching respective masts 440a, 440b, and 440c illustrated in FIG. 4). It should also be noted that there are various other mast configurations and designs that may be used to key a locator pod assembly onto a mast of other vehicle-mounting device embodiments.

Referring still to FIGS. 12A and 12B, each locator pod assembly 1250 may include a shell element 1254 for housing a utility locator device 1270. One or more wheels 1256 may be positioned along the bottom of the locator pod assembly 1250 such that when the locator pod assembly 1250 contacts the ground surface, the locator pod assembly 1250 may roll along the ground. The utility locator device 1270 may secure inside the shell element 1254 of the locator pod assembly 1250 via a lid 1258 that may close and be held closed via a latch 1260. An opening 1262 (partially obscured) may permit sensors to continue to operate outside the locator pod assembly 1250 (e.g., the one or more cameras 674 and/or one or more rangefinder devices 676 of FIG. 6B) when the utility locator device 1270 is installed.

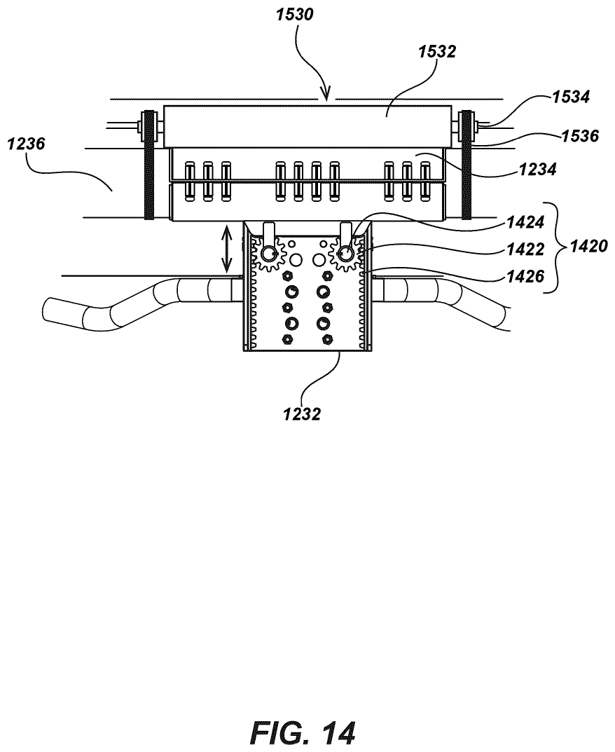

Turning to FIG. 14, the center support 1234 and attached support arm 1236 (FIGS. 12A and 12B), and ultimately the attached locator pod assemblies 1250 (FIGS. 12A and 12B) and utility locator devices 1270 (FIGS. 12A and 12B), may be raised and lowered automatically via a height adjustment mechanism 1420 or the like. For instance, the height adjustment mechanism 1420 may include a series of pinion gears 1422 driven by one or more motors 1424 attached to the center support 1234. The pinion gears 1422 may be moved up and down along the associated racks 1426 on the hitch drop plate 1232. In moving the pinion gears 1422 up and down the racks 1426, the attached center support 1234, support arm, and masts 1240 (FIGS. 12A and 12B) coupling the locator pod assemblies 1250 (FIGS. 12A and 12B) and utility locator devices 1270 (FIGS. 12A and 12B) may likewise move up and down. The motors 1424 may be powered via electrical power supplied via the vehicle 1280 (illustrated with vehicle 1280 providing power 1699 in FIG. 16B and vehicle 1280 providing power 1799 in FIG. 17B) and/or one or more batteries, including the batteries of the utility locator devices 1270 (FIGS. 12A and 12B). In other embodiments, other types of mechanisms may be included to raise and lower the locator pod assemblies and utility locator devices in vehicle-mounting devices in keeping with the present disclosure. In some embodiments, a technician may press a button, switch, or otherwise actuate the lowering and raising of the locator pod assemblies 1250 (FIGS. 12A and 12B) and utility locator devices 1270 (FIGS. 12A and 12B). In further embodiments, such as that disclosed with the FIG. 16B, the height setting may be automatic actuated by a processor wherein the topography of the ground surface (e.g., as determined via LiDAR, rangefinders, other sensors, and/or mapped Topographical Data) is used to decide height setting.

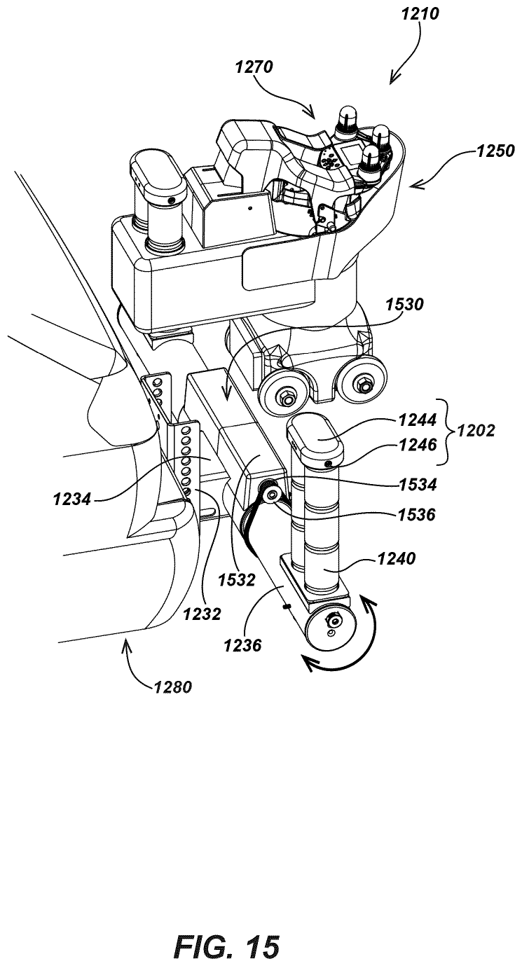

Turning to FIG. 15, the tilt angle of the locator pod assemblies 1250 and utility locator devices 1270, may automatically be changed via a motorized tilt angle mechanism 1530 or the like. For instance, the motorized tilt angle mechanism 1530 may include one or more motors 1532 and a belt 1534 securing about the support arm 1236 and a motor pulley 1536. The belt 1534 may rotate the support arm 1236 when driven by the one or more motors 1532. The motors 1532 may be powered via electrical power supplied via the vehicle 1280 (illustrated with vehicle 1280 providing power 1699 in FIG. 16B and vehicle 1280 providing power 1799 in FIG. 17B) and/or one or more batteries, including the batteries of the utility locator devices 1270. In other embodiments, other types of mechanisms may be included to adjust the tilt angle of the locator pod assemblies and utility locator devices in vehicle-mounting devices in keeping with the present disclosure. In some embodiments, a technician may press a button, switch, or otherwise actuate the adjusting of the tilt angle of the locator pod assemblies 1250 and utility locator devices 1270. In further embodiments, such as that disclosed with the method 1800 of FIG. 18, the tilt angle may be automatically determined and set by a processor based on the slope or topography of the ground surface (e.g., as determined via LiDAR, rangefinders, other sensors, and/or mapped Topographical Data).

Turning to FIGS. 16A and 16B, a vehicle-based locating system 1600 is illustrated which includes a vehicle-mounting device 1210 mounting one or more utility locator devices 1270 to the vehicle 1280. The vehicle-mounting device 1210 may have one or more mechanisms to automatically adjust the height setting and/or tilt angles of one or more locator pod assemblies 1250 and associated utility locator devices 1270 such as the height adjustment mechanism 1420 (FIG. 16B) and/or the tilt angle mechanism 1530 (FIG. 16B). The vehicle-based locating system 1600 may further include one or more mapping sensors 1690 which may be or include rangefinder devices, LiDAR, cameras, other sensors and like apparatus to determine Topographical Data describing the topography of the ground surface (e.g., changes in elevation, dips, bumps, potholes, speedbumps, and the like). The Topographical Data may include or be from a mapping system 1658 having historically mapped Topographical Data. Likewise, the Topographical Data may include data determined via the one or more utility locator devices 1270 (e.g., data from inertial navigation systems, rangefinders, cameras, or the like). It should also be noted that electrical power 1699 (FIG. 16B) may be provided to the various powered mechanisms and elements of the vehicle-mounting device 1210 (e.g., via a trailer hitch power supply or the like).

Further in FIG. 16B, the Topographical Data may be communicated to a processing element 1692 via a radio 1694 which may be disposed in the vehicle-mounting device 1210 and/or in other connected devices to determine an appropriate height setting (e.g., a height setting 1612) and/or tilt angle (e.g., a tilt angle 1614). From the Topographical Data, the processing element 1692 may determine commands to adjust the height setting 1612 and/or tilt angle 1614 (e.g., via the method 1800 of FIG. 18) of the locator pod assemblies 1250 and the utility locator devices 1270. For instance, an ideal height setting and/or tilt angle may be predetermined and the adjustments may be made to keep a consistent height setting and/or tilt angle relative to the changing topography of the ground surface as the vehicle 1280 is moved. The commands determined by the processing element 1692 may be communicated to mechanisms responsible for adjusting the height setting and tilt angle such as the height adjustment mechanism 1420 and/or a tilt angle mechanism 1530. The height adjustment mechanism 1420 is illustrated in greater detail in FIG. 14 and the tilt angle mechanism 1530 is illustrated in greater detail in FIG. 15. Further, Topographical Data and other data related to adjusting the height setting 1612 and tilt angle 1614, and/or other locate data and the like may be stored on a memory element 1696 having one or more non-transitory memories.

Turning to FIGS. 17A and 17B, a vehicle-based locating system 1700 is illustrated which includes the vehicle-mounting device 1210 mounting one or more utility locator devices 1270 to the vehicle 1280. The vehicle-mounting device 1210 may have one or more mechanisms to automatically adjust the height setting (e.g., a height setting 1712) and/or tilt angles (e.g., a tilt angle 1714) of one or more locator pod assemblies 1250 and associated utility locator devices 1270 such as the height adjustment mechanism 1420 (FIG. 17B) and/or the tilt angle mechanism 1530 (FIG. 17B). The vehicle-based locating system 1700 may further include one or more topographical mapping sensors 1790 which may be or include rangefinder devices, LiDAR, cameras, other sensors and like apparatus to determine Topographical Data describing the topography of the ground surface (e.g., changes in elevation, dips, bumps, potholes, speedbumps, and the like). The Topographical Data may include or be from a mapping system 1758 having historically mapped Topographical Data. Likewise, the Topographical Data may include data determined via the one or more utility locator devices 1270 (e.g., data from inertial navigation systems, rangefinders, cameras, or the like). It should also be noted that electrical power 1799 (FIG. 17B) may be provided to the various powered mechanisms and elements of the vehicle-mounting device 1210 (e.g., via a trailer hitch power supply or the like).

Further in FIG. 17B, the Topographical Data may be communicated to a processing element 1792 via a radio 1794 which may be disposed in the vehicle-mounting device 1210 and/or in other connected devices to determine an appropriate height setting (e.g., a height setting 1712) and/or tilt angle (e.g., a tilt angle 1714). From the Topographical Data, the processing element 1792 may determine commands to adjust the height setting 1712 and/or tilt angle 1714 (e.g., via the method 1800 of FIG. 18) of the locator pod assemblies 1250 and the utility locator devices 1270. For instance, an ideal height setting and/or tilt angle may be predetermined and the adjustments may be made to keep a consistent height and/or tilt angle relative to the changing topography of the ground surface as the vehicle 1280 is moved. The commands determined by the processing element 1722 may be communicated to mechanisms responsible for adjusting the height setting 1712 and tilt angle 1714 such as the height adjustment mechanism 1420 and/or the tilt angle mechanism 1530. Further, Topographical Data, and/or other data relating to locate data and the like may be stored on a memory element 1796 having one or more non-transitory memories.

Referring to FIGS. 17A and 17B, the vehicle-mounting device 1210 may optionally include a positioning system 1720. The positioning system 1720 may include one or more sensors and apparatus for determining position in the world frame. For instance, the positioning system 1720 may include one or more GNSS antennas 1722 (FIG. 17B) and GNSS receivers 1724 (FIG. 17B) to provide, or aid in providing, geolocation data describing geolocation positions in the world frame via signals 1735 from a plurality of a navigation satellites 1730 and, optionally, a terrestrial base stations 1740. Such GNSS sensors and antennas may be or include global positioning system (GPS), global navigation satellite system (GLONASS), BeiDou (BDS), Quasi-Zenith Satellite Systems (QZSS), and Galileo and further include precise point positioning real time kinematics (PPP-RTK), state space representation (SSR), and/or other like corrections. Likewise, determination of such geolocation data may include data determined via an INS 1726 (FIG. 17B), ground tracking apparatus, rangefinders, and the like (not illustrated). In some embodiments, geolocation positions may be determined instead or additionally via GNSS and other positions sensors disposed in attached utility locator devices 1270.

The utility locator devices 1270 mounted in the vehicle-mounting device 1210 may include one or more antennas and associated receiver circuitry to measure electromagnetic signals 1755 emitted from one or more utility lines, such as a utility line 1754, to determine locations and depths. The electromagnetic signals 1755 may include both passive and active signals measured across a range of frequencies, measurements of phase, signal strength, signal shape, current direction, changes in such measurements over time, and the like. The determined utility line location and depths, such as the utility line 1754, may be correlated with geolocations in world frame, such as those determined via positioning system 1720 and/or positioning systems in the utility locator devices 1270, to map utility lines. For instance, the utility locator devices 1270 may determine gradients from tensor derivatives of magnetic field vectors of the magnetic signals 1755 at various intervals as the vehicle 1280 moves along the path of the utility line 1754 or, in some scenarios, a plurality of utility lines. Additional details regarding methods used to determine utility line positions from electromagnetic signals may be include those methods disclosed in U.S. Pat. No. 7,332,901, issued Feb. 19, 2008, entitled LOCATOR WITH APPARENT DEPTH INDICATION; U.S. Pat. No. 8,264,226, issued Sep. 11, 2012, entitled SYSTEM AND METHOD FOR LOCATING BURIED PIPES AND CABLES WITH A MAN PORTABLE LOCATOR AND A TRANSMITTER IN A MESH NETWORK; U.S. Pat. No. 9,057,754, issued Jun. 16, 2015, entitled ECONOMICAL MAGNETIC LOCATOR APPARATUS AND METHOD; U.S. Pat. No. 9,435,907, issued Sep. 6, 2016, entitled PHASE SYNCHRONIZED BURIED OBJECT LOCATOR APPARATUS, SYSTEMS, AND METHODS; U.S. patent application Ser. No. 15/250,666, filed Mar. 27, 2018, entitled PHASE-SYNCHRONIZED BURIED OBJECT TRANSMITTER AND LOCATOR METHODS AND APPARATUS; U.S. Pat. No. 10,162,074, issued Dec. 25, 2018, entitled UTILITY LOCATORS WITH RETRACTABLE SUPPORT STRUCTURES AND APPLICATIONS THEREOF; U.S. patent application Ser. No. 16/833,426, filed Mar. 27, 2020, entitled LOW COST, HIGH PERFORMANCE SIGNAL PROCESSING IN A MAGNETIC-FIELD SENSING BURIED UTILITY LOCATOR SYSTEM; U.S. Pat. No. 10,670,766, issued Jun. 2, 2020, entitled UTILITY LOCATING SYSTEMS, DEVICES, AND METHODS USING RADIO BROADCAST SIGNALS; U.S. Pat. No. 10,690,795, issued Jun. 23, 2020, entitled LOCATING DEVICES, SYSTEMS, AND METHODS USING FREQUENCY SUITES FOR UTILITY DETECTION; and U.S. Pat. No. 10,809,408, issued Oct. 20, 2020, entitled DUAL SENSED LOCATING SYSTEMS AND METHODS; U.S. Pat. No. D922,885, issued Jun. 22, 2021, entitled BURIED OBJECT LOCATOR; and/or others disclosed in the incorporated patents and applications. The content of each of these applications is incorporated by reference herein in its entirety.

The vehicle-based locating system 1700 may further include one or more remotely connected cloud servers 1750, base stations 1740, transmitter devices 1752 for coupling signal onto utility lines 1754, hand-carried utility locators 1756, mapping systems 1758, and the like. As illustrated, the various devices of the vehicle-based locating system 1700 may be wirelessly connected for exchanging data. The transmitter devices 1752 may be or share aspect with those disclosed in U.S. Pat. No. 9,891,337, issued Feb. 13, 2018, entitled UTILITY LOCATOR TRANSMITTER DEVICES, SYSTEMS, AND METHODS WITH DOCKABLE APPARATUS; U.S. Pat. No. 9,927,546, issued Mar. 27, 2018, entitled PHASE-SYNCHRONIZED BURIED OBJECT TRANSMITTER AND LOCATOR METHODS AND APPARATUS; U.S. patent application Ser. No. 17/528,956, filed Nov. 17, 2021, entitled SIGNAL TRANSMITTER CONNECTION PORT FOR WIRELESS INSPECTION AND LOCATING SYSTEM; and/or like devices of the incorporated patents and applications.

Turning to FIG. 18, a method 1800 is disclosed for utility locating using one or more utility locator devices disposed in a vehicle-mounting device of the present disclosure. The method 1800 may include a step 1805 moving a vehicle having a coupled vehicle-mounting device with one or more utility locator devices each disposed on a vehicle-mounting device configured to automatically adjust the height setting and/or tilt angle of the utility locator devices and determining Topographical Data describing the topography of the ground surface via one or more rangefinder devices, LiDAR, cameras, other sensors and like apparatus, and historically mapped Topographical Data. In a step 1810, the method 1800 may include measuring electromagnetic signals across a range of frequencies at each utility locator device and determining geolocation data describing positions in the world frame as the vehicle is moved. In an optional step 1815, the method 1800 may include generating images of the ground at the utility locator devices via one or more cameras. In another optional step 1820, the method 1800 may include determining rangefinder data from one or more rangefinder devices in the utility locator device measuring to points on the ground. Further, the method 1800 may optionally include a step 1825 receiving data from one or more wirelessly connected devices in a vehicle-based locating system. In a step 1830, the method 1800 may include determining Topographical Data relating to the surface of the ground. For instance, the Topographical Data may include measurements of the contours, slope, changes in elevations, potholes, bumps, or like information regarding the ground surface. Such Topographical Data may be or include the data generated via the mapping sensors 1690 of FIGS. 16A and 16B and/or sensors of one or more utility locator devices such as the utility locator devices 1270 disposed in the vehicle-mounting device 1210 of FIGS. 12A and 12B (e.g., which may include the use of images from the step 1815 and/or rangefinder data of the step 1820). Likewise, Topographical Data may come from pre-existing maps of the area in a mapping system (e.g., the mapping system 1658 of FIGS. 16A and 16B). In a step 1835, the method 1800 may include adjusting the height of the locator pod assemblies relative to the ground surface based on the Topographical Data. In an optional step 1840, the tilt angle may be adjusted. In a step 1845, the method 1800 may include determining and mapping positions of utility lines based on the measured electromagnetic signal data and geolocation. For instance, gradients of tensor derivatives of magnetic field vectors of the measured magnetic signals at various intervals as the vehicle moves in the environment relative to the one or more utility lines may be calculated. Coupled with corresponding geolocation data regarding the location of the utility locator devices in the world frame with the gradients of tensor derivates and/or the tensor components thereof may be used to map utility line positions. Calculations and methods used to determine utility line positions from electromagnetic data may be or include those methods disclosed in U.S. Pat. No. 7,332,901, issued Feb. 19, 2008, entitled LOCATOR WITH APPARENT DEPTH INDICATION; U.S. Pat. No. 8,264,226, issued Sep. 11, 2012, entitled SYSTEM AND METHOD FOR LOCATING BURIED PIPES AND CABLES WITH A MAN PORTABLE LOCATOR AND A TRANSMITTER IN A MESH NETWORK; U.S. Pat. No. 9,057,754, issued Jun. 16, 2015, entitled ECONOMICAL MAGNETIC LOCATOR APPARATUS AND METHOD; U.S. Pat. No. 9,435,907, issued Sep. 6, 2016, entitled PHASE SYNCHRONIZED BURIED OBJECT LOCATOR APPARATUS, SYSTEMS, AND METHODS; U.S. patent application Ser. No. 15/250,666, filed Mar. 27, 2018, entitled PHASE-SYNCHRONIZED BURIED OBJECT TRANSMITTER AND LOCATOR METHODS AND APPARATUS; U.S. Pat. No. 10,162,074, issued Dec. 25, 2018, entitled UTILITY LOCATORS WITH RETRACTABLE SUPPORT STRUCTURES AND APPLICATIONS THEREOF; U.S. patent application Ser. No. 16/833,426, filed Mar. 27, 2020, entitled LOW COST, HIGH PERFORMANCE SIGNAL PROCESSING IN A MAGNETIC-FIELD SENSING BURIED UTILITY LOCATOR SYSTEM; U.S. Pat. No. 10,670,766, issued Jun. 2, 2020, entitled UTILITY LOCATING SYSTEMS, DEVICES, AND METHODS USING RADIO BROADCAST SIGNALS; U.S. Pat. No. 10,690,795, issued Jun. 23, 2020, entitled LOCATING DEVICES, SYSTEMS, AND METHODS USING FREQUENCY SUITES FOR UTILITY DETECTION; and U.S. Pat. No. 10,809,408, issued Oct. 20, 2020, entitled DUAL SENSED LOCATING SYSTEMS AND METHODS; U.S. Pat. No. D922,885, issued Jun. 22, 2021, entitled BURIED OBJECT LOCATOR; and/or others disclosed in the incorporated patents and applications.

In a step 1850, the method 1800 may include displaying utility line positions/maps and related data to one or more user interfaces. For instance, utility maps, system and device settings, controls for devices, and the like may be communicated to a user interface display on a vehicle (e.g., the vehicle 1280 of FIGS. 12A and 12B), one or more laptops, smartphones, and other computing devices, and the like. In a step 1855, the method 1800 may include storing utility line positions/maps and related data to a memory element having one or more non-transitory memories. Such a memory element may be disposed in the utility locator devices (e.g., the user interface device 1270 of FIGS. 12A and 12B) and/or one or more wirelessly connected devices (e.g., the cloud server 1750 of FIGS. 17A and 17B, the mapping system 1758 of FIGS. 17A and 17B, the base station 1740 of FIGS. 17A and 17B, the hand-carried utility locator device 1756 or transmitter 1752 of FIGS. 1A and 17B, and the like). Likewise, such a memory element may be disposed in one or more wirelessly connected laptops, smartphones, and other computing devices, and the like.

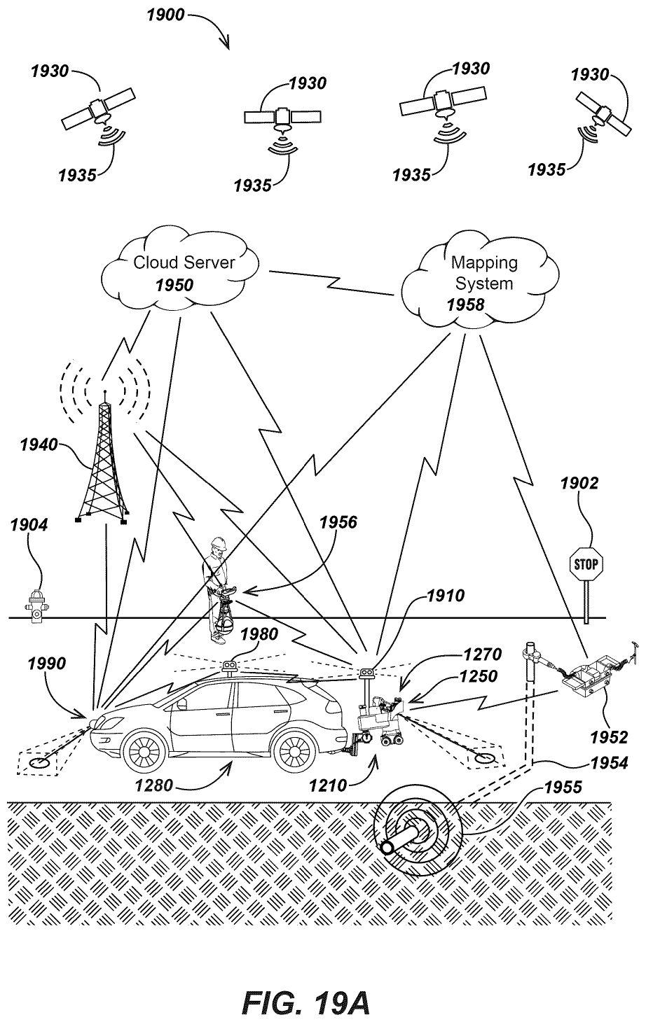

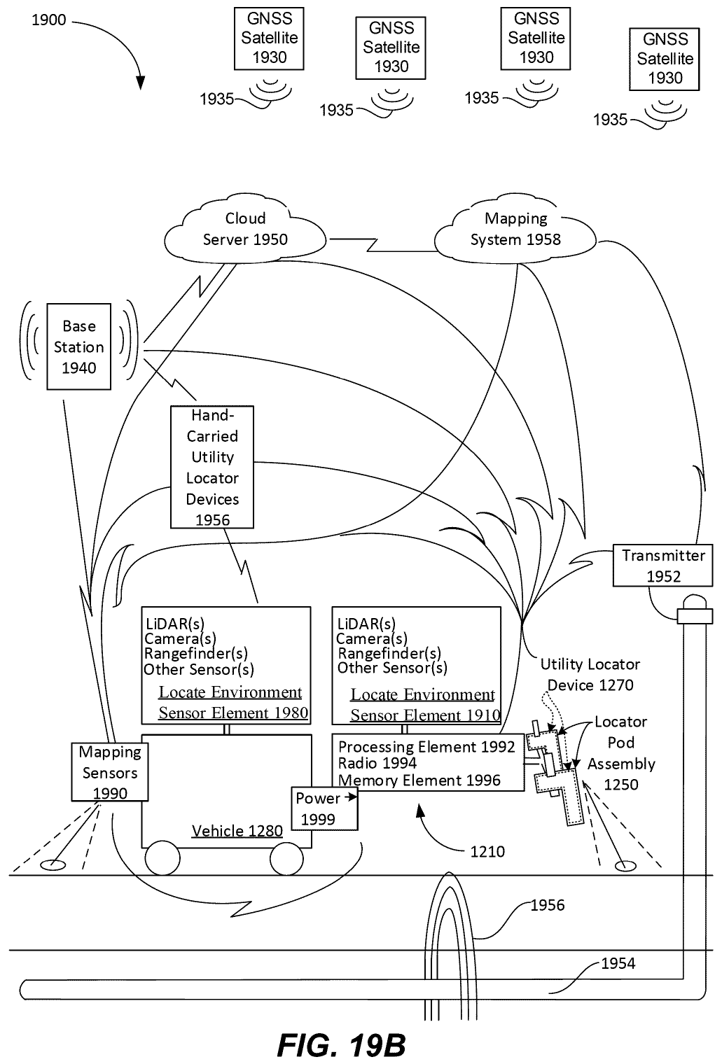

Some vehicle-mounting devices and vehicle-based locating system in keeping with the present disclosure may further include one or more locate environment sensor elements having one or more LiDARs, cameras, rangefinders, and other sensors and apparatus for generating Locate Environment Data relating to images, positions, and identities of objects and attributes in the environment of the locate operation. Turning to FIGS. 19A and 19B, a vehicle-based locating system 1900 is illustrated which includes the vehicle-mounting device 1210 mounting one or more utility locator devices 1270 to the vehicle 1280. As illustrated, the vehicle-mounting device 1210 may include a locate environment sensor element 1910 that may, for instance, be or include one or more LiDARs, cameras, rangefinders, and other sensors and apparatus for generating Locate Environment Data relating to images, positions, and identities of objects and attributes in the environment of the locate operation. It should be noted, a locate environment sensor element, in some embodiments, may include other systems and sensors related to generating images, positions, and identities of objects and attributes in the environment of the locate operation. Such a sensor element may instead or additionally be included in a vehicle-based locating system that is external to the vehicle-mounting device. For instance, in the vehicle-based locating system 1900, a locate environment sensor element 1980 may be on the vehicle 1280 and/or other device or system external to the vehicle-mounting device 1210. Likewise, the locate environment sensor element 1980 that may, for instance, be or include one or more LiDARs, cameras, rangefinders, and other sensors and apparatus for generating Locate Environment Data relating to images, positions, and identities of objects and attributes in the environment of the locate operation. The locate environment sensor element 1910 and/or the locate environment sensor element 1980 may generate images (including three-dimensional representations) and/or measure distances to objects in the environment that may not necessarily be along the ground surface (e.g., a stop sign 1902, a fire hydrant 1904, and other objects and attributes that may be present). The distance to the stop sign 1902, the fire hydrant 1904, and other objects and attributes in the locate environment may be combined with geolocations produced at the utility locator devices 1270 and/or other external positioning systems (e.g., the positioning system 920 of FIG. 9 and the positioning system 1720 of FIG. 17) for purposes of mapping such objects. Further, image recognition and like algorithms may be used to identify the stop sign 1902, the fire hydrant 1904, and other objects and attributes in the locate environment.

The vehicle-based locating system 1900 may further include one or more topographical mapping sensors 1990 which may be or include rangefinder devices, LiDAR, cameras, other sensors and like apparatus to determine Topographical Data describing the topography of the ground surface (e.g., changes in elevation, dips, bumps, potholes, speedbumps, and the like). The Topographical Data may include or be from a mapping system 1958 having historically mapped Topographical Data. Likewise, the Topographical Data may include data determined via the one or more utility locator devices 1270 (e.g., data from inertial navigation systems, rangefinders, cameras, or the like). It should also be noted that electrical power 1999 (FIG. 19B) may be provided to the various powered mechanisms and elements of the vehicle-mounting device 1210 (e.g., via a trailer hitch power supply or the like).

Further in FIG. 19B, the Topographical Data as well as the Locate Environment Data may be communicated to a processing element 1992 via a radio 1994 which may be disposed in the vehicle-mounting device 1210 and/or in other connected devices to determine maps of the locate environment that includes both scans of the topography of the ground surface and/or objects present in the environment. Further, Topographical Data, Locate Environment Data, maps generated from the Topographical Data and/or Locate Environment Data and/or other data relating to locate data and the like may be stored on a memory element 1996 having one or more non-transitory memories.

The utility locator devices 1270 mounted in the vehicle-mounting device 1210 may include one or more antennas and associated receiver circuitry to measure electromagnetic signals 1955 emitted from one or more utility lines, such as a utility line 1954, to determine locations and depths. The electromagnetic signals 1955 may include both passive and active signals measured across a range of frequencies, measurements of phase, signal strength, signal shape, current direction, changes in such measurements over time, and the like. The determined utility line location and depths, such as the utility line 1954, may be correlated with geolocations in world frame, such as the positioning systems in the utility locator devices 1270, to map utility lines. For instance, the utility locator devices 1270 may determine gradients from tensor derivatives of magnetic field vectors of the magnetic signals 1955 at various intervals as the vehicle 1280 moves along the path of the utility line 1954 or, in some scenarios, a plurality of utility lines. Additional details regarding methods used to determine utility line positions from electromagnetic signals may be include those methods disclosed in U.S. Pat. No. 7,332,901, issued Feb. 19, 2008, entitled LOCATOR WITH APPARENT DEPTH INDICATION; U.S. Pat. No. 8,264,226, issued Sep. 11, 2012, entitled SYSTEM AND METHOD FOR LOCATING BURIED PIPES AND CABLES WITH A MAN PORTABLE LOCATOR AND A TRANSMITTER IN A MESH NETWORK; U.S. Pat. No. 9,057,754, issued Jun. 16, 2015, entitled ECONOMICAL MAGNETIC LOCATOR APPARATUS AND METHOD; U.S. Pat. No. 9,435,907, issued Sep. 6, 2016, entitled PHASE SYNCHRONIZED BURIED OBJECT LOCATOR APPARATUS, SYSTEMS, AND METHODS; U.S. patent application Ser. No. 15/250,666, filed Mar. 27, 2018, entitled PHASE-SYNCHRONIZED BURIED OBJECT TRANSMITTER AND LOCATOR METHODS AND APPARATUS; U.S. Pat. No. 10,162,074, issued Dec. 25, 2018, entitled UTILITY LOCATORS WITH RETRACTABLE SUPPORT STRUCTURES AND APPLICATIONS THEREOF; U.S. patent application Ser. No. 16/833,426, filed Mar. 27, 2020, entitled LOW COST, HIGH PERFORMANCE SIGNAL PROCESSING IN A MAGNETIC-FIELD SENSING BURIED UTILITY LOCATOR SYSTEM; U.S. Pat. No. 10,670,766, issued Jun. 2, 2020, entitled UTILITY LOCATING SYSTEMS, DEVICES, AND METHODS USING RADIO BROADCAST SIGNALS; U.S. Pat. No. 10,690,795, issued Jun. 23, 2020, entitled LOCATING DEVICES, SYSTEMS, AND METHODS USING FREQUENCY SUITES FOR UTILITY DETECTION; and U.S. Pat. No. 10,809,408, issued Oct. 20, 2020, entitled DUAL SENSED LOCATING SYSTEMS AND METHODS; U.S. Pat. No. D922,885, issued Jun. 22, 2021, entitled BURIED OBJECT LOCATOR; and/or others disclosed in the incorporated patents and applications. The content of each of these applications is incorporated by reference herein in its entirety. The maps of utility lines may further be combined with maps generated from Topographical Data and/or Locate Environment Data.

It should be noted that vehicle-mounting device 1210 may optionally include a positioning system (e.g., the positioning system 1720 of FIGS. 17A and 17B) having one more GNSS antennas and receivers, inertial navigation sensors (INS), ground tracking apparatus, or like systems and devices to determine position, orientation, and pose in the world frame which may be referred to herein as “Geospatial Data”. For instance, such a positioning system may receive signals 1935 from a plurality of a navigation satellites 1930 and, optionally, a terrestrial base stations 1940 at one or more GNSS antennas and receivers and used to determine geolocation and, optionally, orientation. Such GNSS sensors and antennas may be or include global positioning system (GPS), global navigation satellite system (GLONASS), BeiDou (BDS), Quasi-Zenith Satellite Systems (QZSS), and Galileo and further include precise point positioning real time kinematics (PPP-RTK), state space representation (SSR), and/or other like corrections. Further combined with other positional sensor data (e.g., such as that from the INS or the like) may be further used in determining a pose or orientation in three dimensions at the determined geolocation. Such positioning systems may be in the vehicle 1280, the utility locator devices 1270, the vehicle-mounting device 1210, and/or other connected devices and systems such as those disclosed with the vehicle-based locating system 1900.

The vehicle-based locating system 1900 may further include one or more remotely connected cloud servers 1950, base stations 1940, transmitter devices 1952 for coupling signal 1955 onto the utility lines 1954, hand-carried utility locators 1956, mapping systems 1958, and the like. As illustrated, the various devices of the vehicle-based locating system 1900 may be wirelessly connected for exchanging data. The transmitter devices 1952 may be or share aspect with those disclosed in U.S. Pat. No. 9,891,337, issued Feb. 13, 2018, entitled UTILITY LOCATOR TRANSMITTER DEVICES, SYSTEMS, AND METHODS WITH DOCKABLE APPARATUS; U.S. Pat. No. 9,927,546, issued Mar. 27, 2018, entitled PHASE-SYNCHRONIZED BURIED OBJECT TRANSMITTER AND LOCATOR METHODS AND APPARATUS; U.S. patent application Ser. No. 17/528,956, filed Nov. 17, 2021, entitled SIGNAL TRANSMITTER CONNECTION PORT FOR WIRELESS INSPECTION AND LOCATING SYSTEM; and/or like devices of the incorporated patents and applications.

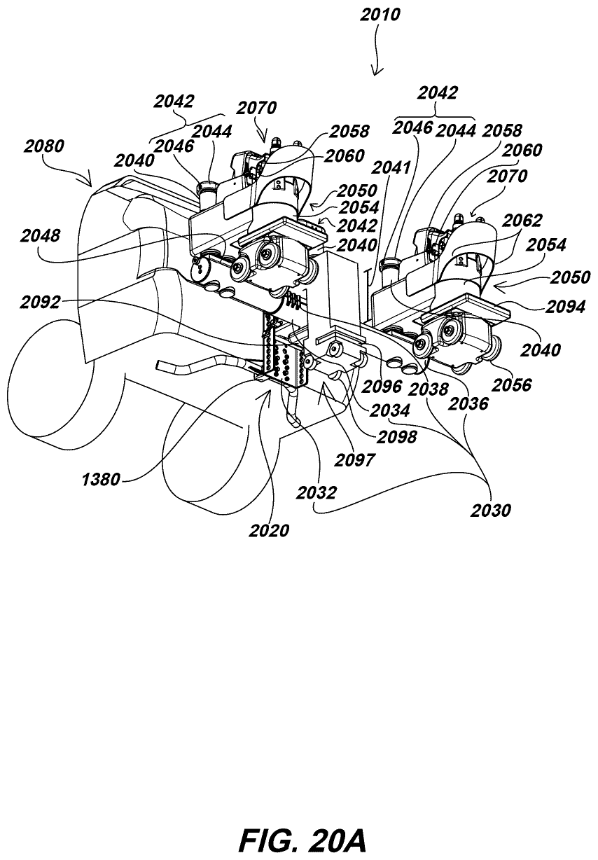

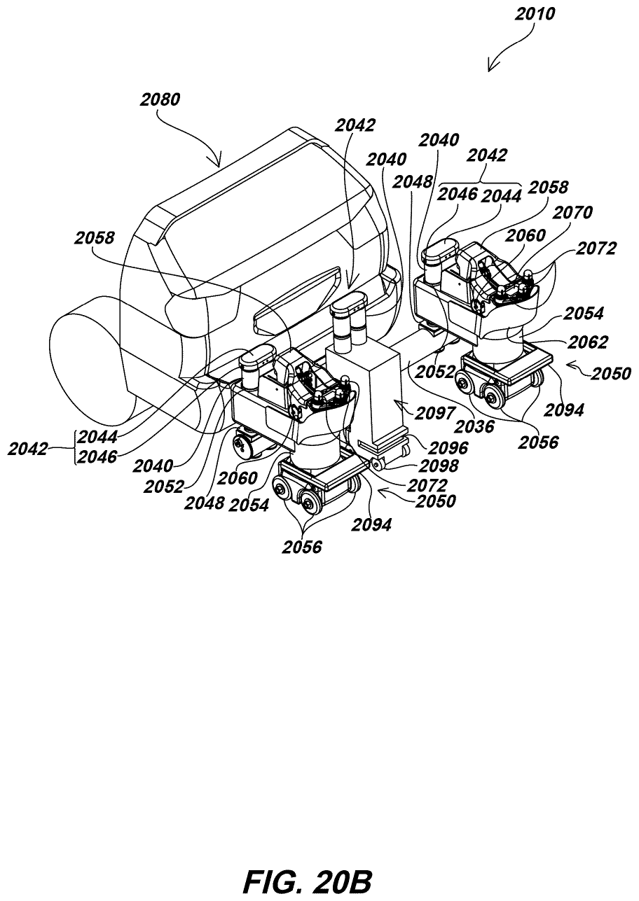

Turning to FIGS. 20A and 20B, a vehicle-mounting device 2010 for mounting one or more utility locator devices 2070 to a vehicle 2080 is illustrated which may include one or more ground penetrating radars (GPR) (e.g., a GPR 2092 of FIG. 20A and a GPR 2094 of FIGS. 20A and 20B). The vehicle-mounting device 2010 may include a mounting element 2020 (FIG. 20A) which may be or share aspects with the mounting element 220 of FIGS. 2A-2C, and 3A-3C or the mounting element 1220 of FIGS. 12A, 12B, and 13 for mounting the vehicle-mounting device 2010 to a standard, commercially available hitch receiver 2081 on the vehicle 2080.

The vehicle-mounting device 2010 may further include a support assembly 2030 including the hitch drop plate 2032 (FIG. 20A) that may secure to the mounting element 2020 (FIG. 20A). The support assembly 2030 may further include a center support 2034 (FIG. 20A) that may couple with the hitch drop plate 2032 (FIG. 20A) and position a support arm 2036 out away from the vehicle 2080. The support arm 2036 may be horizontal in orientation coupled to the center support 2034 (FIG. 20A) via one or more fasteners 2038. The support arm 2036 may have a pair of masts 2040 spaced apart along the width of the vehicle 2080. Each of the masts 2040 may have a length 2041 (FIG. 20A) that is substantially vertical in orientation. It should be noted that the masts 2040, though substantially vertical in orientation, may be made to tilt at a tilt angle (e.g., the tilt angle 1614 of FIGS. 16A and 16B and the tilt angle 1714 of FIGS. 17A and 17B) defined as an angle measurement relative to an upright vertical position.

The vehicle-mounting device 2010 may further include one or more locator pod assemblies 2050 that each may hold a utility locator device 2070. The utility locator devices 2070 may be or share aspects with the devices disclosed in U.S. Pat. No. 7,332,901, issued Feb. 19, 2008, entitled LOCATOR WITH APPARENT DEPTH INDICATION; U.S. Pat. No. 8,264,226, issued Sep. 11, 2012, entitled SYSTEM AND METHOD FOR LOCATING BURIED PIPES AND CABLES WITH A MAN PORTABLE LOCATOR AND A TRANSMITTER IN A MESH NETWORK; U.S. Pat. No. 9,057,754, issued Jun. 16, 2015, entitled ECONOMICAL MAGNETIC LOCATOR APPARATUS AND METHOD; U.S. Pat. No. 9,435,907, issued Sep. 6, 2016, entitled PHASE SYNCHRONIZED BURIED OBJECT LOCATOR APPARATUS, SYSTEMS, AND METHODS; U.S. patent application Ser. No. 15/250,666, filed Mar. 27, 2018, entitled PHASE-SYNCHRONIZED BURIED OBJECT TRANSMITTER AND LOCATOR METHODS AND APPARATUS; U.S. Pat. No. 10,162,074, issued Dec. 25, 2018, entitled UTILITY LOCATORS WITH RETRACTABLE SUPPORT STRUCTURES AND APPLICATIONS THEREOF; U.S. patent application Ser. No. 16/833,426, filed Mar. 27, 2020, entitled LOW COST, HIGH PERFORMANCE SIGNAL PROCESSING IN A MAGNETIC-FIELD SENSING BURIED UTILITY LOCATOR SYSTEM; U.S. Pat. No. 10,670,766, issued Jun. 2, 2020, entitled UTILITY LOCATING SYSTEMS, DEVICES, AND METHODS USING RADIO BROADCAST SIGNALS; U.S. Pat. No. 10,690,795, issued Jun. 23, 2020, entitled LOCATING DEVICES, SYSTEMS, AND METHODS USING FREQUENCY SUITES FOR UTILITY DETECTION; and U.S. Pat. No. 10,809,408, issued Oct. 20, 2020, entitled DUAL SENSED LOCATING SYSTEMS AND METHODS; U.S. Pat. No. D922,885, issued Jun. 22, 2021, entitled BURIED OBJECT LOCATOR; and/or others disclosed in the incorporated patents and applications. The content of each of these applications is incorporated by reference herein in its entirety.

Each of the locator pod assemblies 2050 may include one or more pod mounting holes 2052 (FIG. 20B) that may key onto a pair of masts 2040 such that when a locator pod assembly 2050 contacts the ground surface during use, the locator pod assembly 2050 may slide up along the length 2041 (FIG. 20A) of the associated masts 2040. A retaining element 2042 may seat and secure to the top of the masts 2040 to prevent the locator pod assemblies 2050 from sliding off the top end of the masts 2040. The retaining element 2042 may include a cap 2044 that seats about a pair of masts 2040 and may be secured thereto via a pin 2046. Likewise, a dampening pad 2048 and/or other shock isolation element (e.g., shock absorbers, springs, and/or other materials or other shock isolation element such as the shock isolation elements 282, 284, 286, and 288 of FIG. 2D) may seat at the bottom the masts 2040 cushioning the locator pod assembly 2050 against the point of contact on the support arm 2036. For instance, the impact of the locator pod assembly 2050 may be dampened when the locator pod assembly 2050 returns to sit along the bottom of the masts 2040 via gravity after being pushed upward along the length of the masts 2040. The dampening pad 2048 may, for instance, be or include rubber, polyurethane foam, or other cushioning or shock isolating materials and mechanisms.

Referring still to FIGS. 20A and 20B, each locator pod assembly 2050 may include a shell element 2054 for housing a utility locator device 2070. One or more wheels 2056 may be positioned along the bottom of the locator pod assembly 2050 such that when the locator pod assembly 2050 contacts the ground surface, the locator pod assembly 2050 may roll along the ground. The utility locator device 2070 may secure inside the shell element 2054 of the locator pod assembly 2050 via a lid 2058 that may close and be held closed via a latch 2060. An opening 2062 (partially obscured) may permit sensors to continue to operate outside the locator pod assembly 2050 (e.g., the one or more cameras 674 and/or one or more rangefinder devices 676 of FIG. 6B) when the utility locator device 2070 is installed.

In the vehicle-mounting device 2010, a GPR 2092 (FIG. 20A) may be secured to the vehicle-mounting device 2010 below the center support 2034 allowing the GPR 2092 (FIG. 20A) to be raised and lowered when the support assembly is raised and lowered. Likewise, A GPR 2094 may instead or additionally be included in one or multiple of the locator pod assemblies 2050. The GPR 2094, as illustrated positioned near the wheels 2056, may optionally extend outward from the bottom of the locator pod assembly 2050 away from the positioning of the utility locator devices 2070 so that GPRs 2094 and the utility locator devices 2070 may not interfere with one another. Even further a GPR 2096 may be secured to a GPR pod assembly 2097, similar to the locator pod assemblies 2050, that may seat about one or more of the masts 2040 such that when the GPR pod assembly 2097 that houses or otherwise includes a GPR 2096 may contact the ground surface during use, the GPR pod assembly 2097 may slide up along a length of the masts 2040. The GPR pod assembly 2097 may further include one or more wheels 2098 such that the GPR pod assembly 2097 may roll along the ground surface when making contact. The GPRs 2092 (FIG. 20A), 2094, and 2096 may use radar pulses to scan the sub-surface as the vehicle moves about the locate environment and generate images of the sub-surface.

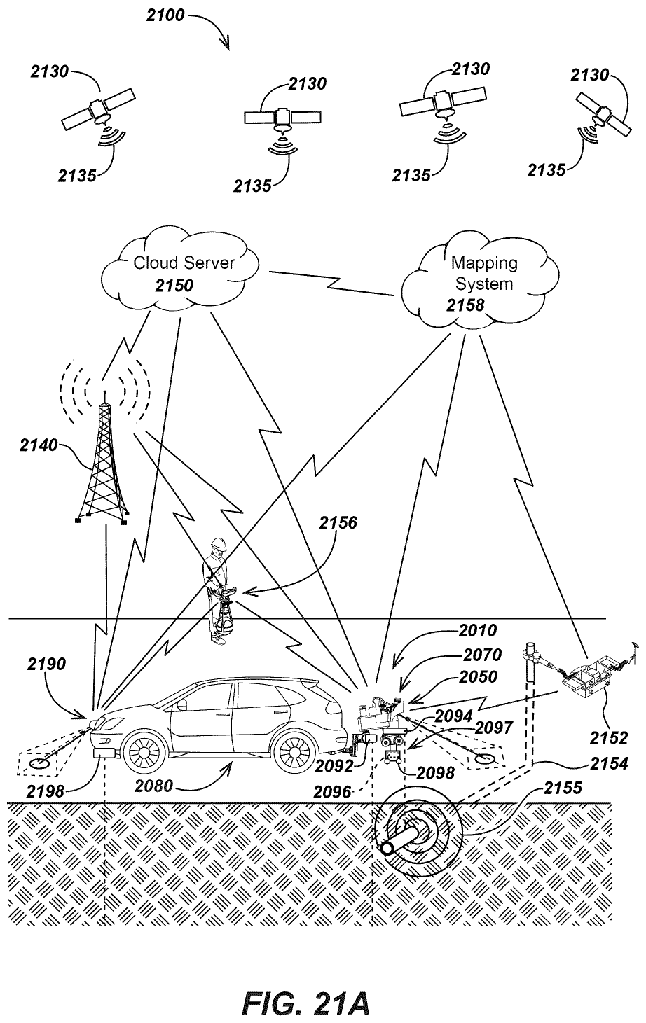

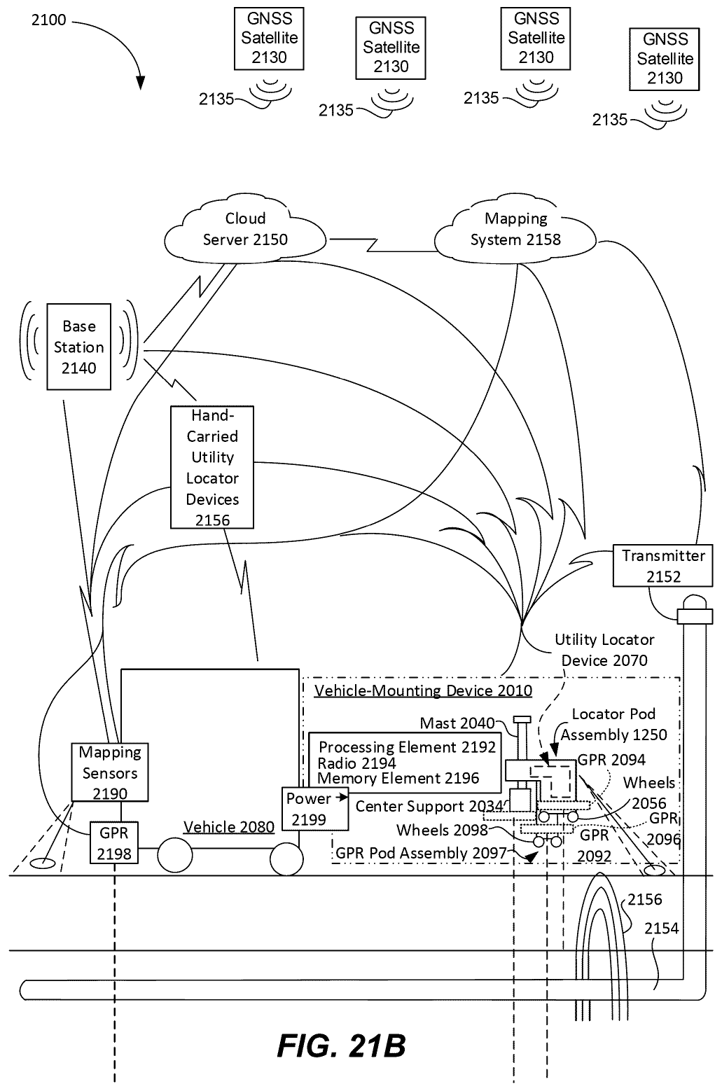

Turning to FIGS. 21A and 21B, a vehicle-based locating system 2100 in keeping with the present disclosure may further include one or more ground penetrating radars (GPRs) that may be included in a vehicle-mounting device, such as the vehicle-mounting device 2010, as well as one or more external GPRs such as a GPR 2198 coupled to the front of the vehicle 2080. The GPR 2198, as well as the GPRs 2092, 2094, and 2096, may generate GPR Data regarding the scanned sub-surface and objects therein that may be communicated with one or more system devices (e.g., via a radio or other wireless technology and/or hardwired connection).

The vehicle-based locating system 2100 may further include one or more topographical mapping sensors 2190 which may be or include rangefinder devices, LiDAR, cameras, other sensors and like apparatus to determine Topographical Data describing the topography of the ground surface (e.g., changes in elevation, dips, bumps, potholes, speedbumps, and the like). The Topographical Data may include or be from a mapping system 2158 having historically mapped Topographical Data. Likewise, the Topographical Data may include data determined via the one or more utility locator devices 2070 (e.g., data from inertial navigation systems, rangefinders, cameras, or the like). It should also be noted that electrical power 2199 (FIG. 21B) may be provided to the various powered mechanisms and elements of the vehicle-mounting device 2010 (e.g., via a trailer hitch power supply or the like).

Further in FIG. 21B, the Topographical Data as well as the GPR Data may be communicated to a processing element 2192 via a radio 2194 which may be disposed in the vehicle-mounting device 2010 and/or in other connected devices to determine maps of the locate environment that includes both scans of the topography of the ground surface and/or sub-surface images below the same ground surface. Further, Topographical Data, GPR Data, maps generated from the Topographical Data and/or GPR Data and/or other data relating to locate data and the like may be stored on a memory element 2196 having one or more non-transitory memories.

The utility locator devices 2070 mounted in the vehicle-mounting device 2010 may include one or more antennas and associated receiver circuitry to measure electromagnetic signals 2155 emitted from one or more utility lines, such as a utility line 2154, to determine locations and depths. The electromagnetic signals 2155 may include both passive and active signals measured across a range of frequencies, measurements of phase, signal strength, signal shape, current direction, changes in such measurements over time, and the like. The determined utility line location and depths, such as the utility line 2154, may be correlated with geolocations in world frame, such as the positioning systems in the utility locator devices 2070, to map utility lines. For instance, the utility locator devices 2070 may determine gradients from tensor derivatives of magnetic field vectors of the magnetic signals 2155 at various intervals as the vehicle 2080 moves along the path of the utility line 2154 or, in some scenarios, a plurality of utility lines. Additional details regarding methods used to determine utility line positions from electromagnetic signals may be include those methods disclosed in U.S. Pat. No. 7,332,901, issued Feb. 19, 2008, entitled LOCATOR WITH APPARENT DEPTH INDICATION; U.S. Pat. No. 8,264,226, issued Sep. 11, 2012, entitled SYSTEM AND METHOD FOR LOCATING BURIED PIPES AND CABLES WITH A MAN PORTABLE LOCATOR AND A TRANSMITTER IN A MESH NETWORK; U.S. Pat. No. 9,057,754, issued Jun. 16, 2015, entitled ECONOMICAL MAGNETIC LOCATOR APPARATUS AND METHOD; U.S. Pat. No. 9,435,907, issued Sep. 6, 2016, entitled PHASE SYNCHRONIZED BURIED OBJECT LOCATOR APPARATUS, SYSTEMS, AND METHODS; U.S. patent application Ser. No. 15/250,666, filed Mar. 27, 2018, entitled PHASE-SYNCHRONIZED BURIED OBJECT TRANSMITTER AND LOCATOR METHODS AND APPARATUS; U.S. Pat. No. 10,162,074, issued Dec. 25, 2018, entitled UTILITY LOCATORS WITH RETRACTABLE SUPPORT STRUCTURES AND APPLICATIONS THEREOF; U.S. patent application Ser. No. 16/833,426, filed Mar. 27, 2020, entitled LOW COST, HIGH PERFORMANCE SIGNAL PROCESSING IN A MAGNETIC-FIELD SENSING BURIED UTILITY LOCATOR SYSTEM; U.S. Pat. No. 10,670,766, issued Jun. 2, 2020, entitled UTILITY LOCATING SYSTEMS, DEVICES, AND METHODS USING RADIO BROADCAST SIGNALS; U.S. Pat. No. 10,690,795, issued Jun. 23, 2020, entitled LOCATING DEVICES, SYSTEMS, AND METHODS USING FREQUENCY SUITES FOR UTILITY DETECTION; and U.S. Pat. No. 10,809,408, issued Oct. 20, 2020, entitled DUAL SENSED LOCATING SYSTEMS AND METHODS; U.S. Pat. No. D922,885, issued Jun. 22, 2021, entitled BURIED OBJECT LOCATOR; and/or others disclosed in the incorporated patents and applications. The content of each of these applications is incorporated by reference herein in its entirety. The maps of utility lines may further be combined with maps generated from Topographical Data and/or Locate Environment Data.

It should be noted that vehicle-mounting device 2010 may optionally include a positioning system (e.g., the positioning system 1720 of FIGS. 17A and 17B) having one more GNSS antennas and receivers, inertial navigation sensors (INS), ground tracking apparatus, or like systems and devices to determine position, orientation, and pose in the world frame which may be referred to herein as “Geospatial Data”. For instance, such a positioning system may receive signals 2135 from a plurality of a navigation satellites 2130 and, optionally, a terrestrial base stations 2140 at one or more GNSS antennas and receivers and used to determine geolocation and, optionally, orientation. Such GNSS sensors and antennas may be or include global positioning system (GPS), global navigation satellite system (GLONASS), BeiDou (BDS), Quasi-Zenith Satellite Systems (QZSS), and Galileo and further include precise point positioning real time kinematics (PPP-RTK), state space representation (SSR), and/or other like corrections. Further combined with other positional sensor data (e.g., such as that from the INS or the like) may be further used in determining a pose or orientation in three dimensions at the determined geolocation. Such positioning systems may be in the vehicle 2080, the utility locator devices 2070, the vehicle-mounting device 2010, and/or other connected devices and systems such as those disclosed with the vehicle-based locating system 2100.

The vehicle-based locating system 2100 may further include one or more remotely connected cloud servers 2150, base stations 2140, transmitter devices 2152 for coupling signal onto utility lines 2154, hand-carried utility locators 2156, mapping systems 2158, and the like. As illustrated, the various devices of the vehicle-based locating system 2100 may be wirelessly connected for exchanging data. The transmitter devices 2152 may be or share aspect with those disclosed in U.S. Pat. No. 9,891,337, issued Feb. 13, 2018, entitled UTILITY LOCATOR TRANSMITTER DEVICES, SYSTEMS, AND METHODS WITH DOCKABLE APPARATUS; U.S. Pat. No. 9,927,546, issued Mar. 27, 2018, entitled PHASE-SYNCHRONIZED BURIED OBJECT TRANSMITTER AND LOCATOR METHODS AND APPARATUS; U.S. patent application Ser. No. 17/528,956, filed Nov. 17, 2021, entitled SIGNAL TRANSMITTER CONNECTION PORT FOR WIRELESS INSPECTION AND LOCATING SYSTEM; and/or like devices of the incorporated patents and applications.

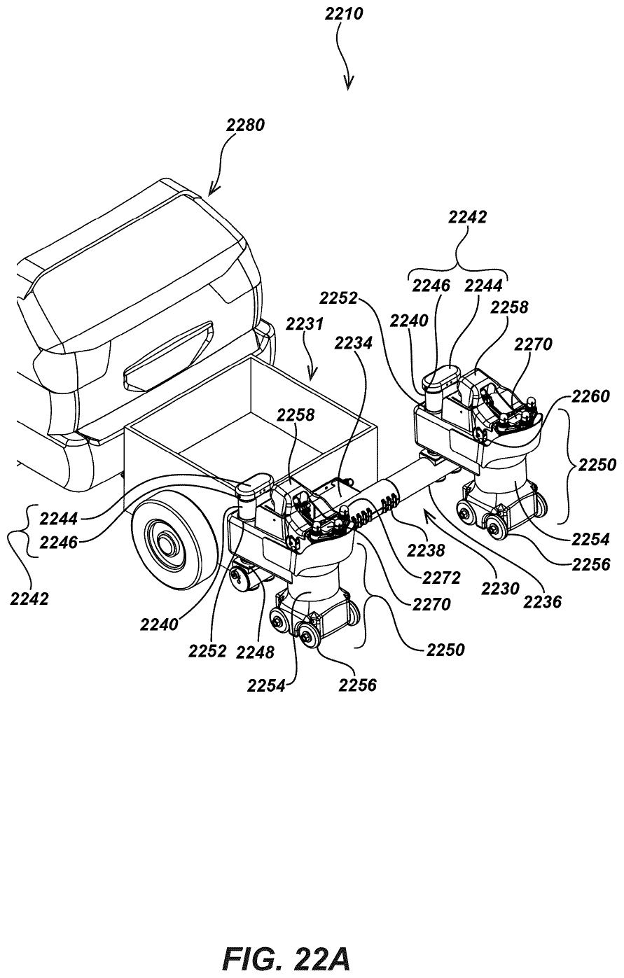

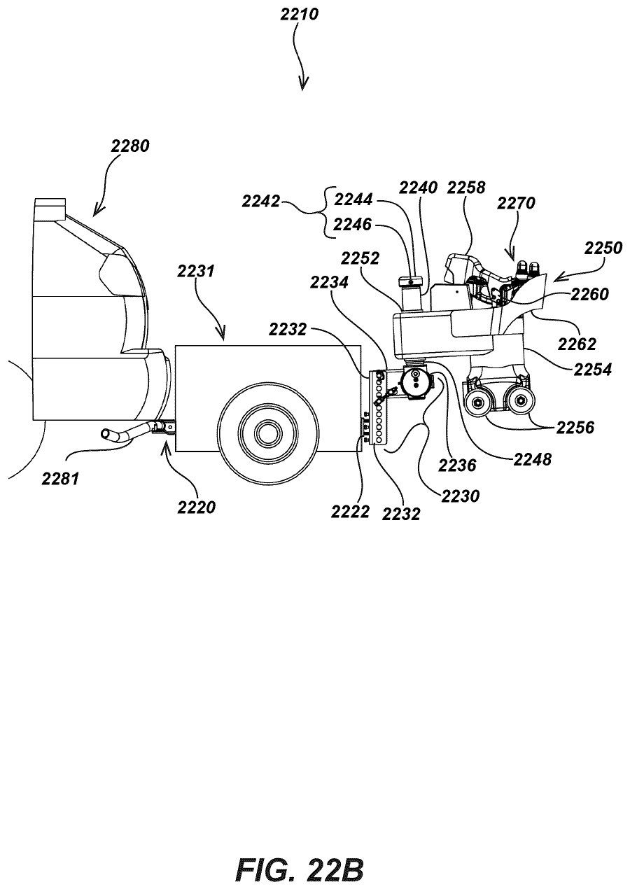

Turning to FIGS. 22A and 22B, a vehicle-mounting device 2210 for mounting one or more utility locator devices 2270 to a vehicle 2280 is illustrated which may include a wheeled trailer 2231. The wheeled trailer 2231 may couple to the vehicle-mounting device 2210 via a mounting element 2220. The mounting element 2220 may be or share aspects with the mounting element 220 illustrated in FIGS. 3A, 3B, and 3C with the exception that the mounting element 2220 may couple the vehicle 2280 to the wheeled trailer 2231 rather than a hitch drop plate such as a hitch drop plate 2232 (FIG. 22B). For instance, the wheeled trailer 2231 may mount to a standard, commercially available hitch receiver 2281 (FIG. 22B) on the vehicle 2280 on the front end and the hitch drop plate 2232 (FIG. 22B) on the rear end of the wheeled trailer 2231.

Still referring to FIGS. 22A and 22B, the vehicle-mounting device 2210 may further include a support assembly 2230 including the hitch drop plate 2232 (FIG. 22B) that may couple to the wheeled trailer 2231. The support assembly 2230 may further include a center support 2234 that may couple with the hitch drop plate 2232 (FIG. 22B) and position a support arm 2236 out away from the vehicle 2280. The support arm 2236 may be horizontal in orientation coupled to the center support 2234 via one or more fasteners 2238 (FIG. 22A). The support arm 2236 may have a pair of masts 2240 spaced apart along the width of the vehicle 2280. Each of the masts 2240 may have a length (e.g., the length 1241 of FIG. 12A) that is substantially vertical in orientation. It should be noted that the masts 2240, though substantially vertical in orientation, may be made to tilt at a tilt angle (e.g., the tilt angle 1614 of FIGS. 16A and 16B and the tilt angle 1714 of FIGS. 17A and 17B) defined as an angle measurement relative to an upright vertical position.

The vehicle-mounting device 2210 may further include one or more locator pod assemblies 2250 that each may hold a utility locator device 2270. The utility locator devices 2270 may be or share aspects with the devices disclosed in U.S. Pat. No. 7,332,901, issued Feb. 19, 2008, entitled LOCATOR WITH APPARENT DEPTH INDICATION; U.S. Pat. No. 8,264,226, issued Sep. 11, 2012, entitled SYSTEM AND METHOD FOR LOCATING BURIED PIPES AND CABLES WITH A MAN PORTABLE LOCATOR AND A TRANSMITTER IN A MESH NETWORK; U.S. Pat. No. 9,057,754, issued Jun. 16, 2015, entitled ECONOMICAL MAGNETIC LOCATOR APPARATUS AND METHOD; U.S. Pat. No. 9,435,907, issued Sep. 6, 2016, entitled PHASE SYNCHRONIZED BURIED OBJECT LOCATOR APPARATUS, SYSTEMS, AND METHODS; U.S. patent application Ser. No. 15/250,666, filed Mar. 27, 2018, entitled PHASE-SYNCHRONIZED BURIED OBJECT TRANSMITTER AND LOCATOR METHODS AND APPARATUS; U.S. Pat. No. 10,162,074, issued Dec. 25, 2018, entitled UTILITY LOCATORS WITH RETRACTABLE SUPPORT STRUCTURES AND APPLICATIONS THEREOF; U.S. patent application Ser. No. 16/833,426, filed Mar. 27, 2020, entitled LOW COST, HIGH PERFORMANCE SIGNAL PROCESSING IN A MAGNETIC-FIELD SENSING BURIED UTILITY LOCATOR SYSTEM; U.S. Pat. No. 10,670,766, issued Jun. 2, 2020, entitled UTILITY LOCATING SYSTEMS, DEVICES, AND METHODS USING RADIO BROADCAST SIGNALS; U.S. Pat. No. 10,690,795, issued Jun. 23, 2020, entitled LOCATING DEVICES, SYSTEMS, AND METHODS USING FREQUENCY SUITES FOR UTILITY DETECTION; and U.S. Pat. No. 10,809,408, issued Oct. 20, 2020, entitled DUAL SENSED LOCATING SYSTEMS AND METHODS; U.S. Pat. No. D922,885, issued Jun. 22, 2021, entitled BURIED OBJECT LOCATOR; and/or others disclosed in the incorporated patents and applications. The content of each of these applications is incorporated by reference herein in its entirety.

Each of the locator pod assemblies 2250 may include one or more pod mounting holes 2252 that may key onto a pair of masts 2240 such that when a locator pod assembly 2250 contacts the ground surface during use, the locator pod assembly 2250 may slide up along the length of the associated masts 2240. A retaining element 2242 may seat and secure to the top of the masts 2240 to prevent the locator pod assemblies 2250 from sliding off the top end of the masts 2240. The retaining element 2242 may include a cap 2244 that seats about a pair of masts 2240 and may be secured thereto via a pin 2246. Likewise, a dampening pad 2248, and/or other shock isolation element, may seat at the bottom the masts 2240 cushioning the locator pod assembly 2250 against the point of contact on the support arm 2236. For instance, the impact of the locator pod assembly 2250 may be dampened when the locator pod assembly 2250 returns to sit along the bottom of the masts 2240 via gravity after being pushed upward along the length of the masts 2240. The dampening pad 2248 may, for instance, be or include rubber, polyurethane foam, or other cushioning material. Likewise, such dampening pads and/or like shock isolation elements may be positioned throughout the vehicle-mounting device 2210.

Referring still to FIGS. 22A and 22B, each locator pod assembly 2250 may include a shell element 2254 for housing a utility locator device 2270. One or more wheels 2256 may be positioned along the bottom of the locator pod assembly 2250 such that when the locator pod assembly 2250 contacts the ground surface, the locator pod assembly 2250 may roll along the ground. The utility locator device 2270 may secure inside the shell element 2254 of the locator pod assembly 2250 via a lid 2258 that may close and be held closed via a latch 2260. An opening 2262 (best illustrated FIG. 22B) may permit sensors to continue to operate outside the locator pod assembly 2250 (e.g., the one or more cameras 674 and/or one or more rangefinder devices 676 of FIG. 6B) when the utility locator device 2270 is installed.

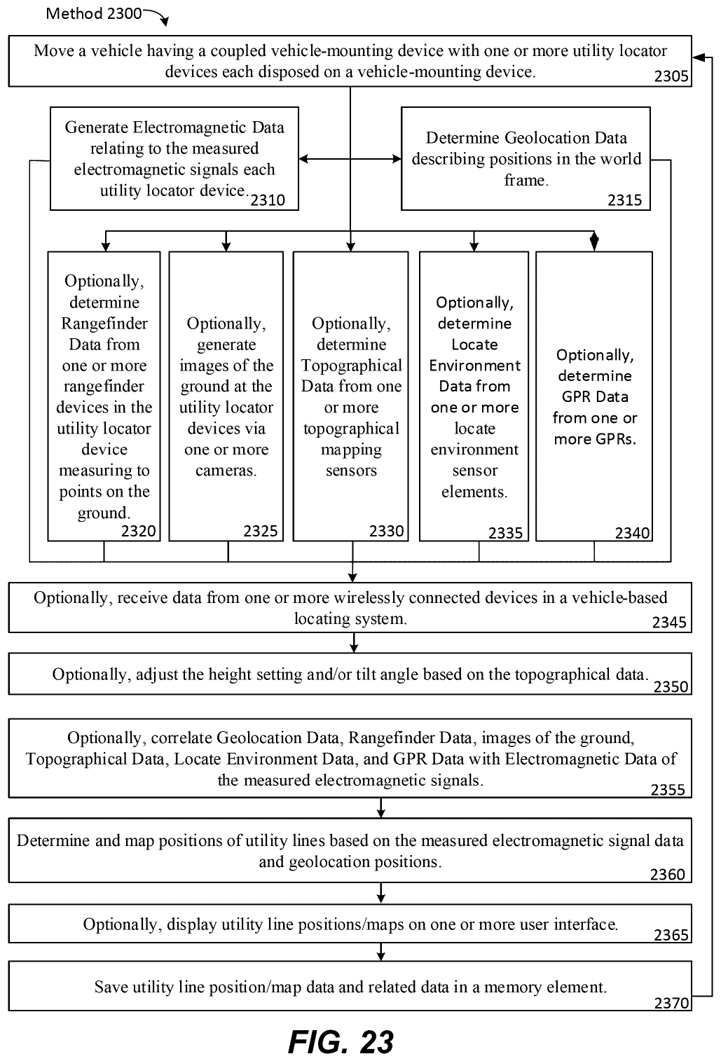

Turning to FIG. 23, a method 2300 is disclosed for mapping utility lines via a vehicle-based locating system that includes one or more vehicle-mounting devices disclosed herein. For instance, the method 2300 may be used in mapping utility lines via the vehicle-based locating system 1000 of FIGS. 10A and 10B, the vehicle-based locating system 1600 of FIGS. 16A and 16B, the vehicle-based locating system 1700 of FIGS. 17A and 17B, the vehicle-based locating system 1900 of FIGS. 19A and 19, and other vehicle-based locating systems or combinations of systems of the present disclosure that includes one or more of the vehicle-mounting devices 210 of FIGS. 2A-8B, the vehicle-mounting device 910 of FIG. 9, the vehicle-mounting device 1210 of FIGS. 12A-15, the vehicle-mounting device 2010 of FIGS. 20A-20B, the vehicle-mounting device 2210 of FIGS. 22A-22B, and other vehicle-mounting devices.

The method 2300 may include a step 2305 moving a vehicle having a coupled vehicle-mounting device with one or more utility locator devices disposed therein. A series of parallel steps 2310 and 2315 as well as a series on optional parallel steps 2320, 2325, 2330, 2335, and 2340. In the parallel step 2310, the method 2300 includes generating Electromagnetic Data relating to the measured electromagnetic signals at each utility locator device. For instance, the utility locator devices (e.g., the utility locator devices 270 of FIGS. 2A-10B, the utility locator devices 1270 of FIGS. 12A-15, the utility locator devices 2070 of FIGS. 20A-20B, the utility locator devices 2270 of FIGS. 22A-22B, and other utility locator devices of the incorporated applications and patents) may determine gradients from tensor derivatives of magnetic field vectors of the magnetic signals at various intervals as the vehicle moves along the path of the utility line or, in some scenarios, a plurality of utility lines. Additional details regarding methods used to determine utility line positions from electromagnetic signals may be include those methods disclosed in U.S. Pat. No. 7,332,901, issued Feb. 19, 2008, entitled LOCATOR WITH APPARENT DEPTH INDICATION; U.S. Pat. No. 8,264,226, issued Sep. 11, 2012, entitled SYSTEM AND METHOD FOR LOCATING BURIED PIPES AND CABLES WITH A MAN PORTABLE LOCATOR AND A TRANSMITTER IN A MESH NETWORK; U.S. Pat. No. 9,057,754, issued Jun. 16, 2015, entitled ECONOMICAL MAGNETIC LOCATOR APPARATUS AND METHOD; U.S. Pat. No. 9,435,907, issued Sep. 6, 2016, entitled PHASE SYNCHRONIZED BURIED OBJECT LOCATOR APPARATUS, SYSTEMS, AND METHODS; U.S. patent application Ser. No. 15/250,666, filed Mar. 27, 2018, entitled PHASE-SYNCHRONIZED BURIED OBJECT TRANSMITTER AND LOCATOR METHODS AND APPARATUS; U.S. Pat. No. 10,162,074, issued Dec. 25, 2018, entitled UTILITY LOCATORS WITH RETRACTABLE SUPPORT STRUCTURES AND APPLICATIONS THEREOF; U.S. patent application Ser. No. 16/833,426, filed Mar. 27, 2020, entitled LOW COST, HIGH PERFORMANCE SIGNAL PROCESSING IN A MAGNETIC-FIELD SENSING BURIED UTILITY LOCATOR SYSTEM; U.S. Pat. No. 10,670,766, issued Jun. 2, 2020, entitled UTILITY LOCATING SYSTEMS, DEVICES, AND METHODS USING RADIO BROADCAST SIGNALS; U.S. Pat. No. 10,690,795, issued Jun. 23, 2020, entitled LOCATING DEVICES, SYSTEMS, AND METHODS USING FREQUENCY SUITES FOR UTILITY DETECTION; and U.S. Pat. No. 10,809,408, issued Oct. 20, 2020, entitled DUAL SENSED LOCATING SYSTEMS AND METHODS; U.S. Pat. No. D922,885, issued Jun. 22, 2021, entitled BURIED OBJECT LOCATOR; and/or others disclosed in the incorporated patents and applications.

In another parallel step 2315, the method 2300 may include determining geolocation data describing positions in the world frame. In an optional parallel step 2320, the method 2300 may include determining rangefinder data from one or more rangefinder devices in the utility locator device measuring to points on the ground. In another optional parallel step 2325, the method 2300 may include generating images of the ground via one or more cameras in the utility locator devices. In another optional parallel step 2330, the method 2300 may include generating Topographical Data from one or more topographical mapping sensors. In another optional parallel step 2335, the method 2300 may include determining Locate Environment Data from one or more locate environment sensor elements. In another optional parallel step 2340, the method 2300 may include determining GPR Data from one or more GPRs.

In an optional step 2345 subsequent to the parallel steps 2310, 2315, 2320, 2325, 2330, 2335, and 2340, the method 2300 may include receiving data from one or more wirelessly connected devices in a vehicle-based locating system. In another optional step 2350, the method 2300 may include adjusting the height setting and/or tilt angle based on the topographical data. In an optional step 2355, the method 2300 may include correlating Geolocation Data, Rangefinder Data, images of the ground, Topographical Data, Locate Environment Data, and GPR Data with Electromagnetic Data of the measured electromagnetic signals. In a step 2360, the method 2300 may include determining and mapping positions of utility lines based on the measured electromagnetic signal data and geolocation positions. In an optional step 2365, the method 2300 may include displaying utility line positions/maps on one or more user interface (e.g., a graphical user interface in a vehicle, on a utility locator device, a smartphone or other computer device, and the like). In a step 2370, the method 2300 may include saving utility line position/map data and related data in a memory element.

The vehicle-mounting devices of the present invention may facilitate moving one or more utility locator devices at great distances in brief amounts of time and thus gather great amounts of data referred to subsequently herein as “Vehicle-Based Locating Data.” The Vehicle-Based Locating Data may be provided as Training Data to a Neural Network to use Deep Learning/artificial intelligence to recognize patterns and make predictions related to utility lines.

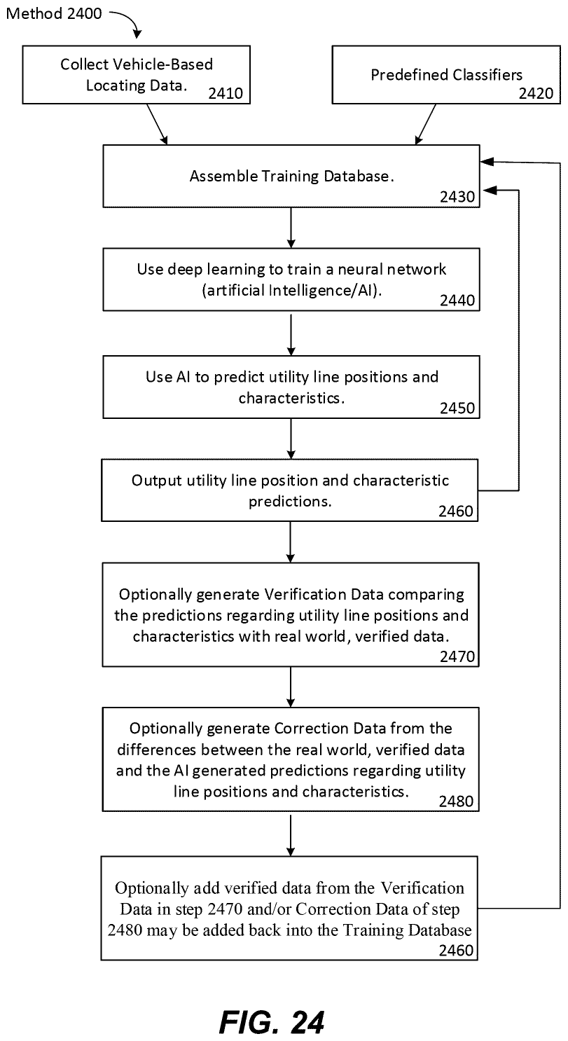

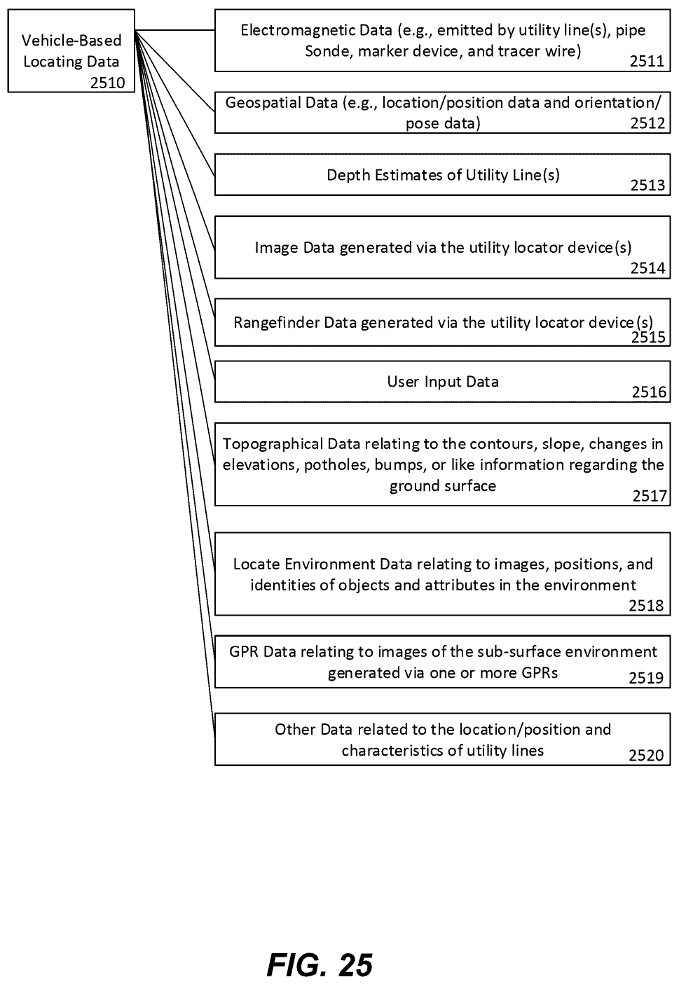

Turning to FIG. 24, a method 2400 is illustrated for providing Training Data to a Neural Network to use Deep Learning/artificial intelligence (AI) to recognize patterns and make predictions related to utility lines. In a step 2410, the method 2400 may collect Vehicle-Based Locating Data. The Vehicle-Based Locating Data 2410 may be or include, but is not limited to, various sources illustrated with the Vehicle-Based Locating Data 2510 of FIG. 25. Such Vehicle-Based Locating Data may utilize one or more utility locator devices disposed in a vehicle-mounting device of the present disclosure that may further be part of a vehicle-based locating systems as disclosed herein (e.g., the vehicle-based locating system 1000 of FIGS. 10A and 10B, the vehicle-based locating system 1600 of FIGS. 16A and 16B, the vehicle-based locating system 1700 of FIGS. 17A and 17B, the vehicle-based locating system 1900 of FIGS. 19A and 19, and other vehicle-based locating systems or combinations of systems of the present disclosure). In an optional step 2420 the method 2400 may include inputting one or more Predefined Classifiers (e.g., user input data or data from a pre-existing database relating to utility line positions, utility line types, depths in the ground, associated electromagnetic data, images of utility lines and surrounding environment, and the like). In a step 2430, the Vehicle-Based Locating Data 2410 and the Predefined Classifier(s) 2420 may be used in the assembly of the Training Data in a Training Database. In a step 2440, deep learning may utilize the Training Data of Training Database from the step 2430 to train a Neural Network (Artificial Intelligence/AI). In a step 2450, AI may be used to predict utility line positions and characteristics. For instance, AI may be used to predict utility line positions and map utility lines as well as predict materials, types of utility lines, utility line depths in the ground, defects or problems in utility lines, and other characteristics. In a step 2460, the method 2400 may output utility line position and characteristic predictions. For instance, the predictions may be saved on one or more non-transitory memories, used to further locate utility lines, or the like. The predictions of step 2460 may optionally be used in a recursive process and be added back into the Training Database of step 2430. In an optional step 2470, Verification Data may be generated comparing the predictions regarding utility line positions and characteristics with real world, verified data. For instance, the real-world, verified data that may be used for comparing against the predictions regarding utility line positions and characteristics of the Verification Data may come from a technician verifying the positions, depths, and/or other characteristics of utility lines and the associated environment through potholing or other excavation procedures, comparing against pre-existing maps of utility line position and other characteristics, and/or like data by which the predictions may be verified. In another optional step 2480, Correction Data may be generated from differences between the real world, verified data and the AI generated predictions regarding utility line positions and characteristics. In another optional step 2490, verified data from the Verification Data in step 2470 and/or Correction Data of step 2480 may be added back into the Training Database of step 2430.

Turning to FIG. 25, Vehicle-Based Locating Data 2510, which may be the same or share aspects with the Vehicle-Based Locating Data 2410 of FIG. 24, is illustrated showing a plurality of example sources of data that may be used to train Neural Networks. As illustrated, the Vehicle-Based Locating Data 2510 may include, but should not be limited to, electromagnetic data (e.g., emitted by utility line(s), pipe Sonde, marker device, and tracer wire) 2511, Geospatial Data (e.g., location/position data and orientation/pose data) 2512, depth estimates of utility line(s) 2513 (e.g., depth of utility lines determined via the measured electromagnetic signals), Image Data generated via the utility locator device(s) 2514; Rangefinder Data generated via the utility locator device(s) 2515; User Input Data 2516; Topographical Data relating to the contours, slope, changes in elevations, potholes, bumps, or like information regarding the ground surface 2517, Locate Environment Data relating to images, positions, and identities of objects and attributes in the locate environment 2518; GPR Data relating to images of the sub-surface environment generated via one or more GPRs 2519; and/or other data related to the location/position and characteristics of utility lines 2520.

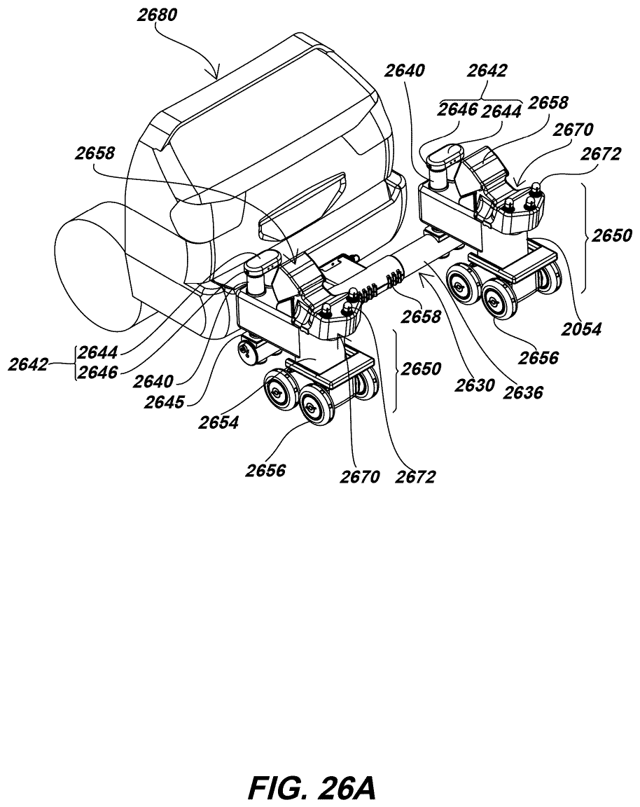

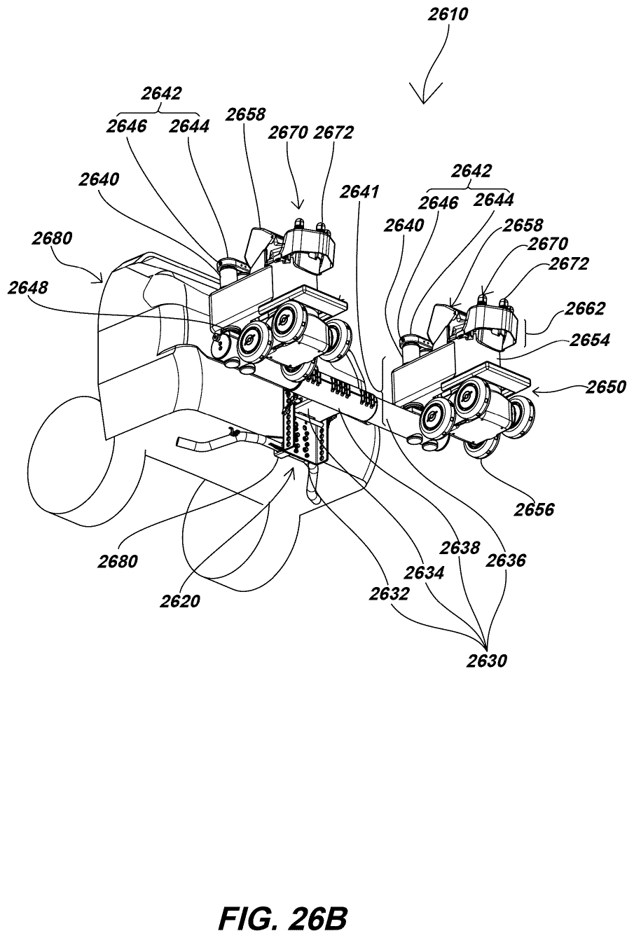

Turning to FIGS. 26A and 26B, a vehicle-mounting device 2610 is illustrated which may share aspects with the vehicle-mounting device 210 of FIGS. 2A, 2B, and 2C, the vehicle-mounting devices 410a and 410b and 410c of FIG. 4, the vehicle-mounting device 910 of FIG. 9, the vehicle-mounting device 1210 of FIGS. 12A and 12B, the vehicle-mounting device 2010 of FIGS. 20A and 20B, and/or vehicle-mounting device 2210 of FIGS. 22A and 22B. The vehicle-mounting device 2610 is illustrated mounting one or more utility locator devices 2670 to a vehicle 2680. The vehicle-mounting device 2610 may include a mounting element 2620 (FIG. 20A) which may be or share aspects with the mounting element 220 of FIGS. 2A-2C, and 3A-3C or the mounting element 1220 of FIGS. 12A, 12B, and 13 for mounting the vehicle-mounting device 2610 to a standard, commercially available hitch receiver 2681 on the vehicle 2680.

The vehicle-mounting device 2610 may further include a support assembly 2630 including the hitch drop plate 2632 (FIG. 26A) that may secure to the mounting element 2620 (FIG. 26A). The support assembly 2630 may further include a center support 2634 (FIG. 26A) that may couple with the hitch drop plate 2632 (FIG. 26A) and position a support arm 2636 out away from the vehicle 2680. The support arm 2636 may be horizontal in orientation coupled to the center support 2634 (FIG. 26A) via one or more fasteners 2638. The support arm 2636 may have a pair of masts 2640 spaced apart along the width of the vehicle 2680. Each of the masts 2640 may have a length 2641 (FIG. 26A) that is substantially vertical in orientation. It should be noted that the masts 2640, though substantially vertical in orientation, may be made to tilt at a tilt angle (e.g., the tilt angle 1614 of FIGS. 16A and 16B and the tilt angle 1714 of FIGS. 17A and 17B) defined as an angle measurement relative to an upright vertical position.

The vehicle-mounting device 2610 may further include one or more locator pod assemblies 2650 that each may hold a utility locator device 2670. The utility locator devices 2670 may be or share aspects with the devices disclosed in U.S. Pat. No. 7,332,901, issued Feb. 19, 2008, entitled LOCATOR WITH APPARENT DEPTH INDICATION; U.S. Pat. No. 8,264,226, issued Sep. 11, 2012, entitled SYSTEM AND METHOD FOR LOCATING BURIED PIPES AND CABLES WITH A MAN PORTABLE LOCATOR AND A TRANSMITTER IN A MESH NETWORK; U.S. Pat. No. 9,057,754, issued Jun. 16, 2015, entitled ECONOMICAL MAGNETIC LOCATOR APPARATUS AND METHOD; U.S. Pat. No. 9,435,907, issued Sep. 6, 2016, entitled PHASE SYNCHRONIZED BURIED OBJECT LOCATOR APPARATUS, SYSTEMS, AND METHODS; U.S. patent application Ser. No. 15/250,666, filed Mar. 27, 2018, entitled PHASE-SYNCHRONIZED BURIED OBJECT TRANSMITTER AND LOCATOR METHODS AND APPARATUS; U.S. Pat. No. 10,162,074, issued Dec. 25, 2018, entitled UTILITY LOCATORS WITH RETRACTABLE SUPPORT STRUCTURES AND APPLICATIONS THEREOF; U.S. patent application Ser. No. 16/833,426, filed Mar. 27, 2020, entitled LOW COST, HIGH PERFORMANCE SIGNAL PROCESSING IN A MAGNETIC-FIELD SENSING BURIED UTILITY LOCATOR SYSTEM; U.S. Pat. No. 10,670,766, issued Jun. 2, 2020, entitled UTILITY LOCATING SYSTEMS, DEVICES, AND METHODS USING RADIO BROADCAST SIGNALS; U.S. Pat. No. 10,690,795, issued Jun. 23, 2020, entitled LOCATING DEVICES, SYSTEMS, AND METHODS USING FREQUENCY SUITES FOR UTILITY DETECTION; and U.S. Pat. No. 10,809,408, issued Oct. 20, 2020, entitled DUAL SENSED LOCATING SYSTEMS AND METHODS; U.S. Pat. No. D922,885, issued Jun. 22, 2021, entitled BURIED OBJECT LOCATOR; and/or others disclosed in the incorporated patents and applications. The content of each of these applications is incorporated by reference herein in its entirety.

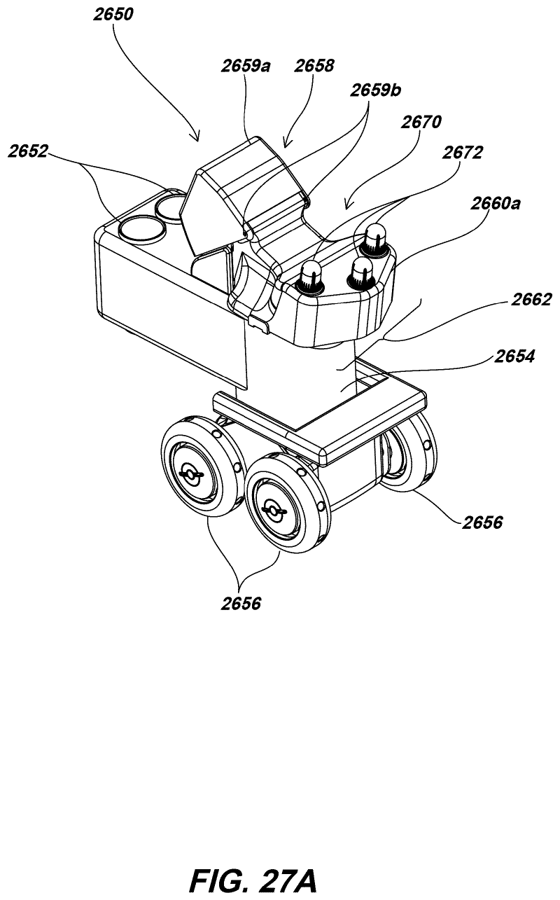

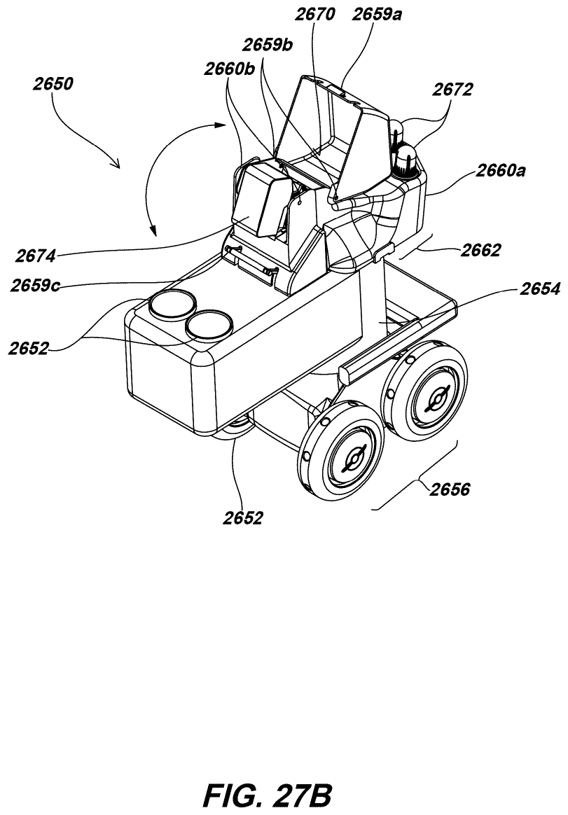

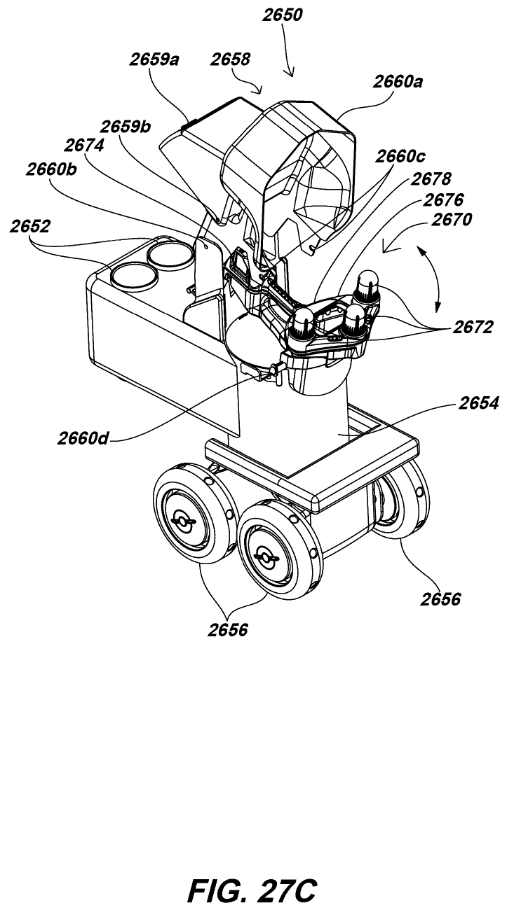

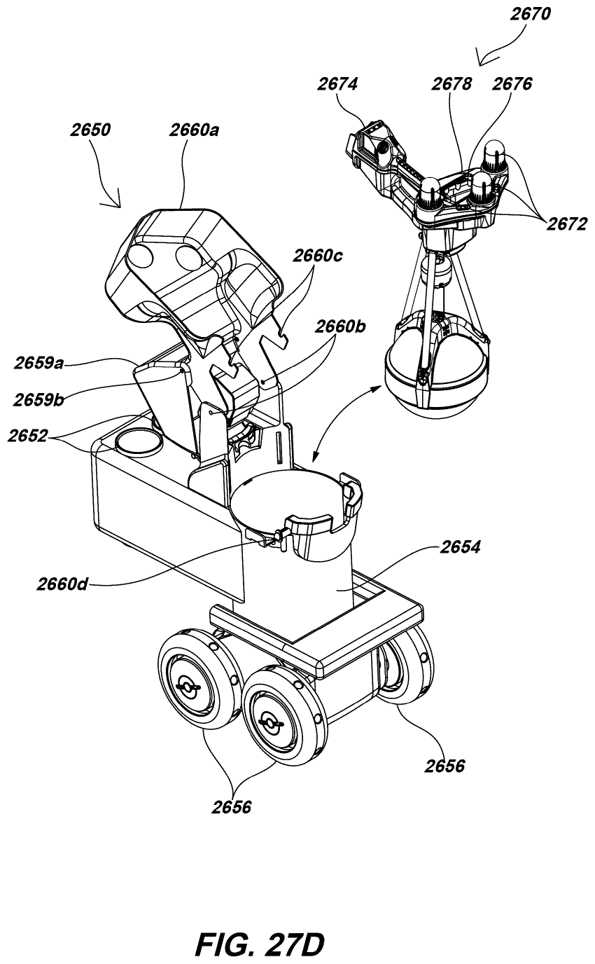

Each of the locator pod assemblies 2650 may include one or more pod mounting holes 2652 (best illustrated in FIGS. 27A-27D) that may key onto a pair of masts 2640 such that when a locator pod assembly 2650 contacts the ground surface during use, the locator pod assembly 2650 may slide up along the length 2641 (FIG. 26A) of the associated masts 2640. A retaining element 2642 may seat and secure to the top of the masts 2640 to prevent the locator pod assemblies 2650 from sliding off the top end of the masts 2640. The retaining element 2642 may include a cap 2644 that seats about a pair of masts 2640 and may be secured thereto via a pin 2646. Likewise, a dampening pad 2648 and/or other shock isolation element (e.g., shock absorbers, springs, and/or other materials or other shock isolation element such as the shock isolation elements 282, 284, 286, and 288 of FIG. 2D) may seat at the bottom the masts 2640 cushioning the locator pod assembly 2650 against the point of contact on the support arm 2636. For instance, the impact of the locator pod assembly 2650 may be dampened when the locator pod assembly 2650 returns to sit along the bottom of the masts 2640 via gravity after being pushed upward along the length of the masts 2640. The dampening pad 2648 may, for instance, be or include rubber, polyurethane foam, or other cushioning or shock isolating materials and mechanisms.

Referring still to FIGS. 26A and 26B, each locator pod assembly 2650 may include a shell element 2654 for housing a utility locator device 2670. The locator pod assembly 2650 may include additional protection to the battery (e.g., the battery 2674 of FIG. 27B), the display (e.g., the display 2676 of FIG. 27C), and/or the user input controls (e.g., the user input controls 2678 of FIG. 27C) of the utility locator devices 2670. One or more wheels 2656 may be positioned along the bottom of the locator pod assembly 2650 such that when the locator pod assembly 2650 contacts the ground surface, the locator pod assembly 2650 may roll along the ground. The utility locator device 2670 may secure inside the shell element 2654 of the locator pod assembly 2650 via a pivot lid assembly 2658. As further shown in FIGS. 27A through 27D, the pivot lid assembly 2658 may provide further protection to the utility locator device 2670 over previous embodiments. For instance, the pivot lid assembly 2658 may lock and secure the utility locator device 2670 in place inside the locator pod assembly 2650 with the pivot lid assembly 2658 also covering and protecting the battery (e.g., the battery 2674 of FIG. 27B), the display (e.g., the display 2676 of FIG. 27C), and/or the user input controls (e.g., the user input controls 2678 of FIG. 27C) of the utility locator device 2670.

Still referring to FIGS. 26A and 26B, an opening 2662 (partially obscured in FIG. 26A) may permit sensors to continue to operate outside the locator pod assembly 2650 (e.g., the one or more cameras 674 and/or one or more rangefinder devices 676 of FIG. 6B) when the utility locator device 2670 is installed.

Turning to FIGS. 27A-27D, the locator pod assembly 2650 is shown to illustrated details regarding the detailing pivot lid assembly 2658.

Turning to FIG. 27A, a detailed view of the locator pod assembly 2650 showing the pivot lid assembly 2658 is illustrated. The pivot lid assembly 2658 may include a battery lid element 2659a and a display and input control lid element 2660a that when closed may cover and protect a battery 2674 (FIG. 27B), a display 2676 (FIG. 27B), and a series of user input controls 2678 (FIG. 27B) on a utility locator device 2670. It should be noted that that the pivot lid assembly 2658 when closed does not obstruct GNSS antennas 2672 on the utility locator device 2670.

Turning to FIG. 27B, the locator pod assembly 2650 showing the battery lid element 2659a of the pivot lid assembly 2658 partially opened revealing the battery 2674 of the utility locator device 2670. The battery lid element 2659a may pivot along an axis formed through the pivot points 2659b when released from a latch element 2659c on the locator pod assembly 2650.

Turning to FIG. 27C, the locator pod assembly 2650 showing both the battery lid element 2659a and the display and input control lid element 2660a of the pivot lid assembly 2658 fully opened further revealing the display 2676 and the user input controls 2678. The display and input control lid element 2660a may pivot along an axis formed through the pivot points 2660b when releasing the grooves 2660c from posts 2660d.

Turning to FIG. 27D, when both the battery lid element 2659a and the display and input control lid element 2660a are fully opened, the positioning of the pivot points 2659b and the pivot points 2660b may allow the pivot lid assembly 2658 to open wide enough for the utility locator device 2670 to readily be removed and installed in the locator pod assembly 2650.

In some configurations, the apparatus or systems described herein may include means for implementing features or providing functions described herein. In one aspect, the aforementioned means may be a module including a processor or processors, associated memory and/or other electronics in which embodiments of the invention reside, such as to implement image and/or video signal processing, switching, transmission, or other functions to process and/or condition camera outputs, control lighting elements, control camera selection, or provide other electronic or optical functions described herein. These may be, for example, modules or apparatus residing in camera assemblies, camera and lighting assemblies, or other assemblies disposed on or within a push-cable or similar apparatus.

Those of skill in the art would understand that information and signals, such as video and/or audio signals or data, control signals, or other signals or data may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein may be implemented as electronic hardware, computer software, electro-mechanical components, or combinations thereof. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative functions and circuits described in connection with the embodiments disclosed herein with respect to tools, instruments, and other described devices may be implemented or performed in one or more processing elements using elements such as a general or special purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Processing elements may include hardware and/or software/firmware to implement the functions described herein in various combinations.

The previous description of the disclosed embodiments is provided to enable any person skilled in the art to make or use various embodiments. Various modifications to these embodiments will be readily apparent to those skilled in the art, and the generic principles defined herein may be applied to other embodiments without departing from the spirit or scope of the disclosure.

Accordingly, the presently claimed invention is not intended to be limited to the aspects shown herein, but is to be accorded the full scope consistent with the specification and drawings, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c.

The previous description of the disclosed aspects is provided to enable any person skilled in the art to make or use the present disclosure. Various modifications to these aspects will be readily apparent to those skilled in the art, and the generic principles defined herein may be applied to other aspects without departing from the spirit or scope of the disclosure. Thus, the scope of the present disclosure is not intended to be limited to only the specific aspects shown herein but should be accorded the widest scope consistent with the embodiments herein and their equivalents.

We claim:

1. A vehicle-mounting device for use with utility locator devices, comprising:
a vehicle mounting element for coupling a support assembly to a vehicle;
a support assembly having a support arm supporting one or more masts coupled onto the support arm each mast having a length that is substantially vertical in orientation;
one or more locator pod assemblies, each further including:
a shell element for housing a utility locator device; and
one or more pod mounting holes dimensioned to secure a utility locator device onto one or more masts on the support assembly such that, when a locator pod assembly contacts the ground surface, the locator pod assembly slides up along the length of the masts.

2. The vehicle-mounting device of claim 1, wherein the mounting element rigidly couples to the vehicle preventing unwanted movements of the vehicle-mounting device and disposed utility locator devices.

3. The vehicle-mounting device of claim 1, further including one or more shock isolation elements to dampen unwanted vibrations and other movements.

4. The vehicle-mounting device of claim 1, further including one or more wheels along the bottom of the locator pod assembly.

5. The vehicle-mounting device of claim 1, wherein the support assembly includes a wheeled trailer.

6. The vehicle-mounting device of claim 1, wherein the locator mounting element on each locator pod assembly is made to key onto one or more masts.

7. The vehicle-mounting device of claim 1, further including one or more global navigation satellite system (GNSS) receivers and antennas.

8. The vehicle-mounting device of claim 1, further including one or more ground penetrating radars (GPR).

9. The vehicle-mounting device of claim 1, wherein the tilt angle of the locator pod assemblies on the vehicle-mounting device are manually adjustable.

10. The vehicle-mounting device of claim 1, wherein the tilt angle of the locator pod assemblies on the vehicle-mounting device are adjusted automatically based on the known or determined topography of the ground surface.

11. The vehicle-mounting device of claim 1, wherein the height of the one or more masts on the support assembly are manually adjustable relative to the ground surface.

12. The vehicle-mounting device of claim 1, wherein the height of the one or more masts on the support assembly are adjusted automatically relative to the ground surface based on the known or determined topography of the ground surface.

13. The vehicle-mounting device of claim 1, including two locator pod assemblies and two utility locator devices spaced apart along the width of the vehicle on the support assembly.

14. The vehicle-mounting device of claim 1, further including a retaining element to prevent the locator pod assemblies from sliding off the top end of an associated one or more masts.

15. The vehicle-mounting device of claim 1, wherein the shell assembly includes one or more openings permitting the sensors and other apparatus of the enclosed utility locator device to determine measurement and other functions outside the locator pod assembly.

16. The vehicle-mounting device of claim 1, further including one or more sensors or apparatus for determining the topography of the ground surface.

17. The vehicle-mounting device of claim 16, wherein determining of the topography of the ground surface includes the use of one or more distance sensors.

18. The vehicle-mounting device of claim 16, wherein determining of the topography of the ground surface includes the use of one or more light detection and ranging (LiDAR) sensors.

19. The vehicle-mounting device of claim 16, wherein determining of the topography of the ground surface includes the use of one or more cameras.

20. The vehicle-mounting device of claim 1, included in a vehicle-based utility locating system that further includes a vehicle and one or more utility locator devices.

21. The vehicle-based utility locating system of claim 20, further including one or more LiDAR, cameras, rangefinders, and other sensors and apparatus for determining Topographic Data relating to the topography of the ground surface.

22. The vehicle-based utility locating system of claim 20, further including one or more LiDAR, cameras, rangefinders, and other sensors and apparatus for generating Locate Environment Data relating to images, positions, and identities of objects and attributes in the environment of the locate operation.

23. The vehicle-mounting device of claim 20, included one or more ground penetrating radars (GPRs).

24. A method for utility locating using one or more utility locator devices disposed in a vehicle-mounting device, comprising:
moving a vehicle having a coupled vehicle-mounting device with one or more utility locator devices each disposed in a locator pod assembly that are further installed on the masts of the vehicle-mounting device such that each locator pod assembly is permitted to move up along the length of the associated mast(s) based on force from the locator pod assembly contacting the ground surface;
measuring electromagnetic signals across a range of frequencies at each utility locator device;
determining geolocation data describing positions in the world frame as the vehicle is moved; and
determining and mapping positions of utility lines based on the measured electromagnetic signal data and geolocation data.

25. The method of claim 24, further including a step generating Image Data referring to images of the ground surface.

26. The method of claim 24, further including a step generating Rangefinder Data describing a distance to one or more locations on the ground surface from one or more rangefinders.

27. The method of claim 24, further including GPR Data from one or more ground penetrating radars (GPRs) that includes representations of the sub-surface of the locate environment.

28. The method of claim 24, further including Locate Environment Data relating to images, positions, and identities of objects and attributes in the environment of the locate operation generated via one or more locate environment sensor elements.

29. A method for utility locating using one or more utility locator devices disposed in a vehicle-mounting device, comprising:
moving a vehicle having a coupled vehicle-mounting device with one or more utility locator devices each disposed on a vehicle-mounting device configured to automatically adjust the height of the utility locator device;
determining Topographical Data describing the topography of the ground surface via one or more rangefinder devices, LiDAR, cameras, other sensors and like apparatus, and historically mapped Topographical Data;
adjusting the height of the locator pod assemblies relative to the ground surface based on the Topographical Data;
measuring electromagnetic signals across a range of frequencies at each utility locator device;
determining geolocation data describing positions in the world frame as the vehicle is moved; and
determining and mapping positions of utility lines based on the measured electromagnetic signal data and geolocation data.

30. The method of claim 29, wherein the tilt angle of the locator pod assemblies are adjusted based on Topographical Data.

31. The method of claim 29, further including a step generating images of the ground surface.

32. The method of claim 29, further including a step generating Rangefinder Data describing a distance to one or more locations on the ground surface from one or more rangefinders.

33. The method of claim 29, further including GPR Data from one or more ground penetrating radars (GPRs) that includes representations of the sub-surface of the locate environment.

34. The method of claim 29, further including Locate Environment Data relating to images, positions, and identities of objects and attributes in the environment of the locate operation generated via one or more locate environment sensor elements.

35. A computer implemented method for utility line positions and characteristics using Artificial Intelligence (AI) comprising:
collecting Vehicle-Based Locating Data describing the positions and depths of utility lines in the ground from electromagnetic signals via one or more utility locator device disposed in a vehicle-mounting device;
collecting Predetermined Classifier Data;
assembling a Training Database that includes Vehicle-Based Locating Data and Predetermined Classifier Data;
using deep learning to train a Neural Network (Artificial Intelligence/AI) via the Training Database Data;
using AI to generate predictions regarding the positions of utility lines and utility line characteristics; and
outputting predictions regarding the positions of utility lines and utility line characteristics.

36. The method of claim 35, wherein Electromagnetic Data emitted by utility line(s), pipe Sonde, marker device, and tracer wire is included in the Training Database.

37. The method of claim 35, wherein measurements of the depth of the utility line(s) are included in the Training Database.

38. The method of claim 35, wherein geospatial data regarding the location/positions and orientations/pose relating to utility locator devices and utility line is included in the Training Database.

39. The method of claim 35, wherein Rangefinder Data from one or more rangefinders is included in the Training Database.

40. The method of claim 35, wherein user input data is included in the Training Database.

41. The method of claim 35, wherein other data is included in the Training Database.

42. The method of claim 35, wherein Image Data of utility line(s) and associated environment is included in the Training Database.

43. The method of claim 35, wherein Topographical Data relating to the contours, slope, changes in elevations, potholes, bumps, and like information regarding the ground surface is included in the Training Database.

44. The method of claim 35, wherein Locate Environment Data relating to images, positions, and identities of objects and attributes in the environment of the locate operation is included in the Training Database.

45. The method of claim 35, wherein GPR Data that includes representations of the sub-surface of the locate environment from one or more ground penetrating radars (GPRs) is included in the Training Database.

46. The method of claim 35, further including a step generating Verification Data comparing the predictions regarding utility line positions and characteristics with real world, verified data.

47. The method of claim 46, further including a step adding verified data from the Verification Data back into the Training Database.

48. The method of claim 35, further including a step generating Correction Data from the differences between the real world, verified data and the AI generated predictions regarding utility line positions and characteristics.

49. The method of claim 48, further including a step adding verified data from the Verification Data back into the Training Database.
